(19) United States
(12) Patent Application Publication
(10) Pub. No.: US 2003/0001926 A1
(43) Pub. Date: Jan. 2, 2003

(54) Toner-passage controller, method for producing the same, and image forming device

(76) Inventors: Taichi Itoh, Osaka (JP); Katsutoshi Ogawa, Osaka (JP); Takuya Kitahara, Osaka (JP); Akira Kumon, Osaka (JP); Yoshitaka Kitaoka, Osaka (JP); Yasutaka Tamai, Nara (JP); Ken Morishima, Osaka (JP); Kotaro Takada, Tokyo (JP); Koichi Baba, Osaka (JP)

Correspondence Address: HARNESS, DICKEY & PIERCE, P.L.C., P.O. BOX 828, BLOOMFIELD HILLS, MI, 48303, US

(21) Appl. No.: 10/181,333

(22) PCT Filed: Jan. 26, 2001
(86) PCT No.: PCT/JP01/00559

(30) Foreign Application Priority Data
Jan. 28, 2000 (JP) 2000-19636
Jan. 31, 2000 (JP) 2000-22051
Mar. 30, 2000 (JP) 2000-92743
Mar. 30, 2000 (JP) 2000-92747
Mar. 31, 2000 (JP) 2000-96384
Mar. 31, 2000 (JP) 2000-98833

(51) Int. Cl. B41J 2/06

(52) U.S. Cl. 347/55

(57) ABSTRACT

An image forming device including a toner holder 10 and a toner passage control device 4 including a plurality of toner passage holes 14 for controlling the passage of a toner 3, wherein a spacer member 22 arranged between the toner holder 10 and the toner passage control device 4 for maintaining the distance therebetween to be substantially constant has a predetermined surface roughness and a predetermined hardness while having a rigidity such that irregularities on the surface of the toner passage control device 4 are not transferred onto a toner layer 3a, so as to prevent the toner layer 3a on the toner holder 10 from being scratched and to form a high-quality image both in an initial stage of a recording operation and in a long-term use.

### TECHNICAL FIELD

The present invention relates to a toner passage control device, a method for manufacturing the same, and an image forming device, and particularly to a technical field in which an image is formed by controlling the flight of a toner from a toner holder toward a counter electrode with a toner passage control device having a toner passage hole so that the toner attaches to an image receiving member located between the toner passage control device and the counter electrode. Note that in the present invention, “toner passage control device” is referred to also as “toner passage control means”.

### BACKGROUND ART

In recent years, along with the improvement in the performance of personal computers and the advancement in the network technology, there is a strong demand for a printer and a copier having a high processing capacity that can handle a large amount of documents (or that can also handle color documents). However, image forming devices that are capable of outputting black-and-white and color documents with a satisfactory quality and that have a high processing speed have still been under development and waited for.

As one such device, there is known an image forming technique based on a so-called “Toner Jet (registered trademark)” method, in which the action of an electric field is used to allow a toner to fly onto an image receiving member such as recording paper or image holding belt, thereby forming an image.

Known image forming devices of this type include those disclosed in, for example, Japanese Patent Publication for Opposition No. 44-26333, U.S. Pat. No. 3,689,935 (Japanese Patent Publication for Opposition No. 60-20747), Japanese National Phase PCT Laid-Open Publication No. 9-500842, etc.

As illustrated in FIG. 36, for example, the device includes a grounded toner holder 31 for holding a negatively charged toner and rotating about the central axis thereof so as to carry the toner, a limiting blade 32 for controlling the toner on the toner holder 31 in one to three layers and charging the toner, and a supply roller 33 for supplying the toner to the toner holder 31 and charging the toner. A counter electrode 38 to which a voltage for forming a transfer electrostatic field that sucks the toner is applied is arranged at a position facing the position on the toner holder 31 to which the toner is carried, and a counter electrode power source 39 for applying a positive voltage that forms the transfer electrostatic field is connected to the counter electrode 38. A toner passage control device 34 is provided between the toner holder 31 and the counter electrode 38, and the toner passage control device 34 includes a plurality of toner passage holes 35 arranged in a row in a direction perpendicular to the toner carrying direction of the toner holder 31 (i.e., a direction perpendicular to the sheet of the drawing), and a control electrode 36 arranged around each of the toner passage holes 35. A voltage is applied to the control electrode 36 according to an image signal from a control power source 37, such as an IC chip. Note that in FIG. 36, reference numeral 40 is an image receiving member such as recording paper that is transferred between the counter electrode 38 and the toner passage control device 34.

With such a configuration, the supply roller 33 and the toner holder 31 are rotated, whereby a uniform toner layer is formed on the toner holder 31 by the limiting blade 32, and the toner layer is carried to a portion opposing the toner passage hole 35 of the toner passage control device 34. Then, a voltage is applied to the counter electrode 38 by the counter electrode power source 39, and the image receiving member 40 is moved while a voltage according to an image signal is applied to the control electrode 36 by the control power source 37 in synchronism with the movement, whereby the toner on the toner holder 31 flies and attaches to the image receiving member 40 through the toner passage hole 35 according to the image signal, thus forming an intended image on the image receiving member 40.

In the image forming device, in order to form a high-definition image of 600 dpi (a density of 600 dots per inch (24.4 mm)), for example, across the entire surface of the image receiving member 40, it is necessary to arrange the toner passage holes 35 in the toner passage control device 34 at such a pitch. Since it is difficult to make such an arrangement in a row, the toner passage holes 35 and the control electrodes 36 are arranged in a large number of rows (eight rows in the illustrated example) as illustrated in FIG. 38. The toner passage holes 35 and the control electrodes 36 each have a generally circular shape, and each control electrode 36 has a wire portion 36a extending in a direction perpendicular to the rows of toner passage holes 35. In order to avoid interference therebetween, the wire portions 36a are arranged so that the wire portion 36a of each control electrode 36 of a row in the right half of FIG. 38 extends rightward while the wire portion 36a of each control electrode 36 of a row in the left half of FIG. 38 extends leftward, and the wire portions 36a are provided in the opposite end portions of the toner passage control device 34 interposing the rows of toner passage holes 35 therebetween and are connected to an IC chip, or the like, for outputting a control voltage.

FIG. 36 illustrates an example where the image receiving member 40 is recording paper, or the like, and an image is formed directly thereon. In such a case, the recording paper, or the like, is likely to be subject to variations in thickness, changes in quality due to humidity, deformation while being moved, etc., and in a case of a color printer, it is difficult to synchronize the image formation timings for different colors due to variations in the transfer of the recording paper, and the image quality is likely to lower.

Therefore, it is in some cases preferred to use an image holding belt as the image receiving member 40 so that an image formed on the image holding belt is transferred onto the recording paper, or the like, at once.

Such a configuration will be described with reference to FIG. 37. Reference numeral 43 is an endless image holding belt used as the image receiving member 40, which is made of a film obtained by dispersing a conductive filler in a resin and having a resistance of about 10¹⁰ Ω·cm, and is wound around a pair of rollers 44a and 44b.

Reference numeral 45 is a pickup roller for feeding recording paper 46 sheet by sheet from a paper input tray 50, reference numeral 47 is a timing roller for synchronization between the recording paper 46 being fed and the image position, and reference numeral 48 is a transfer roller for transferring a toner image that has been formed on the image holding belt 42 onto the recording paper 46. The transfer roller 48 is pressed against the roller 44a with the image holding belt 43 being interposed therebetween, and a transfer voltage is applied to the transfer roller 48. Reference numeral 49 is a fixing device for fixing the toner image on the recording paper 46 by heating/pressurizing the recording paper 46 onto which the toner image has been transferred.

In an image forming device having such a configuration, the amount of toner passing through a toner passage hole is significantly influenced by the interval between the toner holder and the toner passage control device, i.e., the interval between the toner holder and the control electrode. In order to address this, a scraper blade (hereinafter referred to also as “spacer member”) may be arranged between the toner holder and the toner passage control device so as to maintain the interval therebetween to be substantially constant, as shown in Japanese Laid-Open Patent Publication No. 9-500842, for example. Specifically, the toner layer and the toner passage control device are contacted with each other via such a spacer member at a position that is in the vicinity of the toner passage holes and is on the upstream side in the toner holder moving direction with respect to the toner passage holes, thereby maintaining the head interval between the toner layer and the toner passage control device to be substantially the same as the thickness of the spacer member. Such a configuration is desirable in maintaining the interval at an early stage of a recording operation because the toner passage control device moves along the surface of the toner holder even if the toner holder has outer shape variations, a cylindricity nonuniformity, a radial runout, etc.

However, when a recording operation is performed continuously over a long period of time with a configuration using the spacer member, toner particles accumulate accidentally and gradually on a surface of the spacer member that is in contact with the toner layer. Then, in an area of the surface of the spacer member that is in contact with the toner layer where a toner has been fused, a protrusion is formed, whereby a streak-like scratch is formed in the toner layer formed by the limiting blade in an area where it opposes the spacer member. Therefore, a streak that is extending in the secondary scanning direction (the toner holder moving direction) is transferred onto the image formed on the image receiving member. Moreover, the head interval increases as the toner fused on the spacer member surface gradually accumulates, whereby the recording characteristics change with time. Furthermore, if there occur variations in the amount of toner accumulated in the row direction of the toner passage holes (the primary scanning direction), variations occur in the head interval in the primary scanning direction, and the recording characteristics are varied by such variations, whereby a streak or a density nonuniformity in the primary scanning direction occurs in the recorded image.

Moreover, in a case where the spacer member provided on the toner passage control device is contacted with the toner layer on the toner holder, the spacer member normally contacts the toner layer at an edge portion (end) of the spacer member that is on the downstream side in the toner holder moving direction. Therefore, if there are minute irregularities on the surface in the edge portion, the irregularities are transferred onto the toner layer, thereby scratching the toner layer and causing an image non-uniformnity.

Therefore, in order to form a uniform image with no streak or density nonuniformity with an image forming device that forms an image by causing the toner to selectively fly onto the image receiving member using an electric field, it is necessary to prevent the toner layer from being scratched and to maintain the surface condition of the toner layer formed on the toner holder to be substantially constant entirely across the rows of toner passage holes.

Moreover, the head interval is a factor that significantly influences the variations in the recording characteristics. Therefore, in order to form a uniform image without non-uniformity, it is necessary to maintain the head interval to be substantially constant entirely across the rows of toner passage holes.

On the other hand, in order to allow a sufficient amount of toner for obtaining a required recording density to fly under conditions where a constant voltage is applied to the counter electrode and the control electrode, it is necessary to set the head interval to be very small (on the order of 10 μm or so). In such a case, even a slight dimensional error in the head interval leads to increased variations, whereby it is difficult to maintain the head interval to be constant entirely across the rows of toner passage holes. Moreover, there are irregularities on the surface of the toner passage control device due to the electrode pattern, etc., and such irregularities on the surface of the toner passage control device that contacts with the spacer member may possibly influence the surface precision of the spacer member. In such a case, the irregularities are transferred onto the toner layer with which the spacer member contacts, thereby causing an image non-uniformity.

Moreover, even at an early stage of a recording operation, the toner layer that is moved by the toner holder contacts the spacer member before being supplied to the rows of toner passage holes (at a position on the upstream side in the toner holder moving direction with respect to the toner passage holes). Therefore, if there are minute irregularities or protrusions on the surface of the spacer member that is in contact with the toner layer, the toner layer contacting the spacer member is scratched, and the scratch is transferred onto the image, thereby causing a minute streak in the recorded image.

In view of this, the contact pressure between the spacer member and the toner layer may be reduced so as to prevent the toner layer from being scratched. In such a case, however, it is not possible to ensure a uniform contact between the toner layer and the spacer member in the direction parallel to the rows of toner passage holes (the primary scanning direction), and a gap occurs partially. Therefore, the head interval varies in the primary scanning direction, and the recording characteristics are varied by such variations, whereby a streak or a density non-uniformity in the primary scanning direction occurs in the recorded image.

This imposes very stringent requirements in the surface roughness or flatness on the spacer member. Therefore, the component cost increases, and the assembly operation of attaching the spacer member to the toner passage control device requires very carefull handling of the spacer member, increases the number of assembly steps in mass production, and increases the occurrence of a misoperation.

Furthermore, in a configuration in which a scraper blade is arranged between the toner holder and the toner passage control means (toner passage control device) so as to maintain the interval between the toner layer and the control electrode on the toner passage control means, as shown in Japanese Laid-Open Patent Publication No. 9-500842, the toner passage control means is substantially planar while the toner holder is cylindrical. Therefore, even if the head interval between the toner layer and the toner passage control means is limited to the thickness of the scraper blade by employing such a configuration in which the toner passage control means contacts the toner layer on the toner holder via the scraper blade arranged on the toner passage control means, the head interval changes and the recording characteristics vary when the relative positional relationship between the toner passage holes and the toner holder in the toner holder moving direction. In a configuration in which a plurality of toner passage control means are provided and toners of different colors, e.g., yellow, magenta, cyan and black, are used for the plurality of toner passage control means so as to form a color image, such variations in the recording characteristics among the toner passage control means lead to variations in the hue and density, thereby creating problems in the image quality. Moreover, where the toner passage control means includes a plurality of rows of toner passage holes arranged in the toner holder moving direction in order to improve the recording resolution, the head interval varies among the rows of toner passage holes, whereby the recording characteristics vary among the toner passage holes and it is difficult to provide a control under the same condition.

Moreover, since the toner passage control means is substantially planar while the toner holder is cylindrical in such a configuration, when the toner passage control means contacts the toner layer on the toner holder via the scraper blade arranged on the toner passage control means, the scraper blade will abut on the toner layer at its edge on the downstream side in the toner holder moving direction, and the stress on the toner layer is localized at the abutting position, whereby the thickness of the toner layer may decrease and a sufficient image density may not be obtained.

Moreover, in order to allow a sufficient amount of toner for ensuring a required recording density to fly under a constant voltage application condition, it is necessary to set the head interval corresponding to the thickness of the scraper blade to be very small. In such a case, however, if the toner passage control means is substantially planar as described above, the toner passage control means once abuts on the toner layer at the position of the scraper blade, after which the toner passage control means and the toner layer may contact each other again at a position that is on the downstream side in the toner holder moving direction with respect to the abutting position. In such a case, the contact between the scraper blade and the toner layer becomes unstable, and it is difficult to stably control the head interval to be the thickness of the scraper blade, whereby the recording characteristics vary.

Moreover, when the scraper blade is attached by bonding onto the toner passage control means, the interval between the toner holder and the toner passage control means is influenced by the thickness of the bond layer, whereby it is difficult to maintain the head interval to be constant.

Moreover, Japanese Laid-Open Patent Publication No. 9-500842 discloses a method, as an alternative method, in which the scraper blade is attached to a casing member so that it contacts the toner passage control means. However, problems as those described above occur since the toner passage control means is substantially planar while the toner holder is cylindrical. Moreover, since the toner passage control means is attached so as to be movable with respect to the casing member, the positional relationship between the toner passage holes formed in the toner passage control means and the scraper blade is unstable, and the positional relationship varies due to the outer shape variations or a runout of the toner holder. These factors cause an image non-uniformity in the primary scanning direction, thereby lowering the image quality.

In a configuration where the toner passage holes abut on the toner layer on the toner holder via the scraper blade, or the like, in order to maintain the head interval, even if the toner holder has outer shape variations, a cylindricity non-uniformity, or a radial runout, they can be absorbed. However, since the toner passage control means and the toner holder are arranged so that they can be displaced with respect to each other, if the toner holder has outer shape variations, a cylindricity non-uniformity, or a radial runout, the positional relationship between the toner passage holes formed in the toner passage control means and the toner holder in the toner holder moving direction changes. Even in such a case, it is necessary to maintain the head interval to be constant so that the head interval does not vary as in the conventional example described above.

Moreover, similarly to the above, in order to allow a sufficient amount of toner for ensuring a required recording density to fly under a constant voltage application condition, it is necessary to form, on the toner holder, a toner layer of a constant thickness that corresponds to the thickness of a number of toner particle layers.

Moreover, in order to form a uniform image with no streak or density nonuniformity, it is necessary to prevent the toner layer from being scratched and to maintain the surface condition of the toner layer formed on the toner holder to be constant entirely across the rows of toner passage holes.

Moreover, as described above, it is necessary to maintain the positional precision of the spacer means with respect to the toner passage holes to be constant. However, precisely attaching the spacer means having a thickness on the order of 10 μm or so to the toner passage control means requires a careful assembly operation and increases the number of steps in mass production.

As described above, in the configuration above, the toner layer held on the toner holder contacts the spacer means at a position on the upstream side, i.e., before it is supplied to the rows of toner passage holes, whereby if there are minute irregularities or protrusions on the spacer surface that is in contact with the toner layer, the toner layer contacting the spacer is scratched, and the scratch is transferred onto the image, thereby causing a minute streak in the recorded image.

One possible way to address this problem is to reduce the contact pressure between the spacer means and the toner layer so as to prevent the toner layer from being scratched. In such a case, however, it is not possible to ensure a uniform contact between the toner layer and the spacer means in the direction parallel to the rows of toner passage holes (the primary scanning direction), and it is not possible to avoid a gap occurring partially. Therefore, the head interval increases in the gap, causing variations in the head interval in the primary scanning direction, and the recording characteristics are varied by such variations, whereby a streak or a density non-uniformity in the primary scanning direction occurs in the recorded image.

This imposes very stringent requirements in the surface roughness or flatness on the spacer means, thereby increasing the component cost. Moreover, the assembly operation of attaching the spacer means having a thickness on the order of 10 μm or so, as described above, to the toner passage control means requires very careful handling of the spacer means, increases the number of assembly steps in mass production, and increases the occurrence of a misoperation, thereby increasing the cost.

The present invention has been made in view of such problems in the art, and a first object of the present invention is to provide an image forming device capable of preventing a scratch or disturbance from occurring in a toner layer on a toner holder both at an early stage of a recording operation and in a long-term use, and maintaining the interval between the toner layer and a toner passage control device to be minute and uniform entirely across rows of toner passage holes, thereby forming a high-quality image with no non-uniformity or streak across the entire printing area while ensuring a required recording density under a constant voltage application condition.

Moreover, a second object of the present invention is to provide an image forming device capable of forming, on a toner holder, a toner layer having an appropriate thickness and a uniform surface condition, and maintaining the interval between the toner layer and toner passage control means to be minute and uniform entirely across all rows of toner passage holes, thereby stably forming a high-quality image with no non-uniformity or streak across the entire printing area while ensuring a required recording density under a constant voltage application condition without causing the image quality to lower.

Furthermore, a third object of the present invention is to provide an image forming device in which the method of attaching spacer means to toner passage control means is improved so as to improve the precision and reduce the cost for the spacer means, and which is capable of maintaining the interval between the toner layer and the toner passage control means to be minute and uniform entirely across rows of toner passage holes, thereby forming a high-quality image with no non-uniformity or streak across the entire printing area while ensuring a required recording density under a constant voltage application condition.

### DISCLOSURE OF THE INVENTION

In order to achieve the objects, the present invention provides an image forming device, including: a toner holder for holding a charged toner and moving while forming a toner layer; a counter electrode which is arranged at a position opposing a toner carrying position of the toner holder and to which a voltage for forming a transfer electrostatic field for sucking the toner of the toner layer formed on the toner holder is applied; a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal; an image receiving member which is arranged between the toner passage control device and the counter electrode and to which the toner having passed through the toner passage holes attaches; and a spacer member having one of its surfaces in a thickness direction in contact with a surface of the toner layer being moved by the toner holder for maintaining a distance between the toner layer surface and a toner holder side opening of the toner passage hole in the toner passage control device to be substantially constant, wherein the spacer member is configured so that irregularities on a spacer member contacting surface of a contact member that contacts the other one of the surfaces of the spacer member in the thickness direction are not transferred onto the surface of the toner layer.

Moreover, it is preferred that the spacer member is configured so that the irregularities on the spacer member contacting surface of the contact member do not influence a smoothness of the toner layer contacting surface of the spacer member.

With these inventions, the spacer member does not undergo a bending deformation along the irregularities on the spacer member contacting surface of the contact member, and has a sufficient flexural rigidity so as not to transfer the irregularities onto the toner layer contacting surface, whereby the smoothness of the toner layer contacting surface of the spacer member is not influenced by the irregularities on the contact member surface, and the irregularities are prevented from being transferred onto the toner layer with which the spacer member contacts to cause an image non-uniformity.

Moreover, it is preferred that the contact member is the toner passage control device. In this way, even if the spacer member is contacted with the toner passage control device, irregularities due to the electrode pattern, etc., formed on the spacer member contacting surface of the toner passage control device do not influence the smoothness of the toner layer contacting surface of the spacer member, and the irregularities are prevented from being transferred onto the toner layer.

The present invention provides an image forming device, including: a toner holder for holding a charged toner and moving while forming a toner layer; a counter electrode which is arranged at a position opposing a toner carrying position of the toner holder and to which a voltage for forming a transfer electrostatic field for sucking the toner of the toner layer formed on the toner holder is applied; a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal; an image receiving member which is arranged between the toner passage control device and the counter electrode and to which the toner having passed through the toner passage holes attaches; and a spacer member in contact with a surface of the toner layer being moved by the toner holder for maintaining a distance between the toner layer surface and a toner holder side opening of the toner passage hole in the toner passage control device to be substantially constant, wherein the spacer member is configured so that a smoothness of the toner layer surface does not change after the spacer member contacts the toner layer surface.

With such a configuration, even if the toner layer is moved by the toner holder to contact the spacer member, the smoothness of the toner layer surface does not change, whereby an image non-uniformity does not occur.

Moreover, the present invention provides an image forming device, including a toner holder for holding a charged toner and moving while forming a toner layer; a counter electrode which is arranged at a position opposing a toner carrying position of the toner holder and to which a voltage for forming a transfer electrostatic field for sucking the toner of the toner layer formed on the toner holder is applied; a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal; an image receiving member which is arranged between the toner passage control device and the counter electrode and to which the toner having passed through the toner passage holes attaches; and a spacer member in contact with a surface of the toner layer being moved by the toner holder for maintaining a distance between the toner layer surface and a toner holder side opening of the toner passage hole in the toner passage control device to be substantially constant, wherein a surface roughness of a toner layer contacting surface of the spacer member is set to be smaller than a surface roughness of the toner layer surface before being contacted by the spacer member.

In this way, the toner layer with which the spacer member contacts is prevented from being scratched by the minute irregularities or protrusions on the surface of the spacer member, thereby preventing such a scratch from being transferred onto an image to cause a minute streak in the recorded image. Moreover, the holding force of the toner particles fused on the spacer member surface is reduced, and the fused toner particles are removed by the sliding movement against the toner layer, thereby preventing the toner from gradually accumulating with the fused toner particle being a nucleus. Therefore, even in a long-term use, the toner is prevented from accumulating on the spacer member, and it is possible to prevent a streak from occurring on the recorded image due to a scratch in the toner layer.

The present invention provides an image forming device, including: a toner holder for holding a charged toner and moving while forming a toner layer; a counter electrode which is arranged at a position opposing a toner carrying position of the toner holder and to which a voltage for forming a transfer electrostatic field for sucking the toner of the toner layer formed on the toner holder is applied; a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal; an image receiving member which is arranged between the toner passage control device and the counter electrode and to which the toner having passed through the toner passage holes attaches; and a spacer member in contact with a surface of the toner layer being moved by the toner holder for maintaining a distance between the toner layer surface and a toner holder side opening of the toner passage hole in the toner passage control device to be substantially constant, wherein a surface roughness Rz of a toner layer contacting surface of the spacer member is set to be smaller than an average particle diameter of the toner. In this way, functions/effects as those of the invention described above can be obtained.

The present invention provides an image forming device, including: a toner holder for holding a charged toner and moving while forming a toner layer; a counter electrode which is arranged at a position opposing a toner carrying position of the toner holder and to which a voltage for forming a transfer electrostatic field for sucking the toner of the toner layer formed on the toner holder is applied; a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal; an image receiving member which is arranged between the toner passage control device and the counter electrode and to which the toner having passed through the toner passage holes attaches; and a spacer member in contact with a surface of the toner layer being moved by the toner holder for maintaining a distance between the toner layer surface and a toner holder side opening of the toner passage hole in the toner passage control device to be substantially constant, wherein a surface roughness Rz of a toner layer contacting surface of the spacer member is set to be 2 to 8 μm. In this way, functions/effects as those of the invention described above can be obtained.

It is preferred that a surface roughness Rz of a portion of a toner layer contacting surface of the spacer member where the spacer member contacts the toner layer is set to be 2 to 4 μm. Moreover, it is preferred that the spacer member is provided on an upstream side in a toner holder moving direction with respect to the toner passage hole, and the spacer member is configured so as to contact the toner layer in an area of the toner layer contacting surface of the spacer member that is 5 mm in length from one end thereof on a downstream side in the toner holder moving direction toward an upstream side. With these inventions, it is possible to obtain an image of an even higher quality both in an initial stage of a recording operation and in a long-term use.

It is preferred that: the spacer member is provided on an upstream side in a toner holder moving direction with respect to the toner passage hole; and a corner portion of the spacer member between a toner layer contacting surface thereof and an end surface thereof on a downstream side in the toner holder moving direction is chamfered by a size that is equal to or greater than ½ of a thickness of the spacer member.

In this way, an edge portion (end) of the spacer member on the downstream side in the direction in which the toner holder moves does not directly contact the toner layer, whereby even if there are minute irregularities on the surface of the edge portion, the stress applied on the toner layer is not localized in the edge portion. As a result, the irregularities in the edge portion are prevented from being transferred onto the toner layer, thereby preventing a scratch in the toner layer and an image non-uniformity from occurring. Moreover, this eliminates the problem that a sufficient image density cannot be obtained due to a reduced thickness of the toner layer.

It is preferred that: the spacer member is provided on an upstream side in a toner holder moving direction with respect to the toner passage hole; and a protrusion height with respect to a surface roughness average line is set to be 4 μm or less in an area of the toner layer contacting surface of the spacer member that is 1 mm in length from one end thereof on a downstream side in the toner holder moving direction toward an upstream side. In this way, functions/effects as those of the invention described above can be obtained.

The present invention provides an image forming device, including: a toner holder for holding a charged toner and moving while forming a toner layer; a counter electrode which is arranged at a position opposing a toner carrying position of the toner holder and to which a voltage for forming a transfer electrostatic field for sucking the toner of the toner layer formed on the toner holder is applied; a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal; an image receiving member which is arranged between the toner passage control device and the counter electrode and to which the toner having passed through the toner passage holes attaches; and a spacer member in contact with a surface of the toner layer being moved by the toner holder for maintaining a distance between the toner layer surface and a toner holder side opening of the toner passage hole in the toner passage control device to be substantially constant, wherein the spacer member is made of a steel strip.

With such a configuration, the spacer member does not undergo a bending deformation along the irregularities on the surface of the toner passage control device, and has a sufficient flexural rigidity so as not to transfer the irregularities onto the surface. Therefore, the irregularities are prevented from being transferred onto the toner layer with which the spacer contacts to cause an image non-uniformity. Thus, the head interval can be set to be very small, a sufficient amount of toner can be allowed to fly under a constant voltage application condition, and it is possible to ensure a required recording density. Moreover, even when a thin spacer member having a thickness of about 10 μm is bonded on the toner passage control device, the spacer member is prevented from being plastically deformed to lower its smoothness. As a result, it is possible to prevent problems such as a scratch in the toner layer or an image non-uniformity. Moreover, the work efficiency of the assembly operation can be significantly improved. Furthermore, it is possible to prevent the spacer member from wearing off by the sliding movement between the toner layer and the toner passage control device.

Furthermore, the present invention provides an image forming device, including: a toner holder for holding a charged toner and moving while forming a toner layer; a counter electrode which is arranged at a position opposing a toner carrying position of the toner holder and to which a voltage for forming a transfer electrostatic field for sucking the toner of the toner layer formed on the toner holder is applied; a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal; an image receiving member which is arranged between the toner passage control device and the counter electrode and to which the toner having passed through the toner passage holes attaches; and a spacer member in contact with a surface of the toner layer being moved by the toner holder for maintaining a distance between the toner layer surface and a toner holder side opening of the toner passage hole in the toner passage control device to be substantially constant, wherein a hardness Hv of a surface of the spacer member is set to be 400 to 600. In this way, functions/effects as those of the invention described above can be obtained.

It is preferred that the spacer member is made of a stainless steel for springs or a carbon tool steel. In this way, it is possible to easily obtain a specific material of the spacer member.

Moreover, the present invention provides an image forming device, including: a toner holder for holding a charged toner and moving while forming a toner layer; a counter electrode which is arranged at a position opposing a toner carrying position of the toner holder and to which a voltage for forming a transfer electrostatic field for sucking the toner of the toner layer formed on the toner holder is applied; a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal; an image receiving member which is arranged between the toner passage control device and the counter electrode and to which the toner having passed through the toner passage holes attaches; and a spacer member in contact with a surface of the toner layer being moved by the toner holder for maintaining a distance between the toner layer surface and a toner holder side opening of the toner passage hole in the toner passage control device to be substantially constant, wherein the spacer member is made of a sheet obtained by subjecting a resin material to a surface treatment using an antistatic material.

In this way, the spacer member can be provided by using a resin, thus reducing the cost. Moreover, even when a resin is used, it is possible to prevent the toner from being newly charged by the sliding movement between the spacer member and the toner layer, and thus preventing the toner from electrostatically attaching to the spacer member surface. Furthermore, it is possible to prevent the spacer member from wearing off by the sliding movement between the toner layer and the toner passage control device.

It is preferred that a surface resistance of the antistatic material is set to be 10¹⁰ Ω or less. Moreover, the antistatic material is made of a boron-based polymer. With these inventions, it is possible to effectively prevent the toner from being newly charged by the sliding movement between the spacer member and the toner layer.

It is preferred that a surface of the spacer member is electrically grounded. In this way, it is possible to even more effectively prevent the toner from electrostatically attaching to the spacer member surface.

Furthermore, the present invention provides an image forming device, including: a toner holder for holding a charged toner and moving while forming a toner layer; a counter electrode which is arranged at a position opposing a toner carrying position of the toner holder and to which a voltage for forming a transfer electrostatic field for sucking the toner of the toner layer formed on the toner holder is applied; a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal; an image receiving member which is arranged between the toner passage control device and the counter electrode and to which the toner having passed through the toner passage holes attaches; and a spacer member in contact with a surface of the toner layer being moved by the toner holder for maintaining a distance between the toner layer surface and a toner holder side opening of the toner passage hole in the toner passage control device to be substantially constant. The spacer member is configured so as to contact the toner layer surface on a downstream side in the toner holder moving direction with respect to the toner passage hole.

Moreover, it is preferred that the spacer member is configured so as not to contact the toner layer surface on an upstream side in the toner holder moving direction with respect to the toner passage hole.

With these inventions, even if there are minute irregularities or protrusions on the toner layer contacting surface of the spacer member, thereby scratching the toner layer contacting the spacer member, the scratched toner layer has already supplied the toner to the toner passage hole, whereby a disturbance in the toner layer due to such a scratch is prevented from being transferred onto the recorded image to cause a minute streak in the recorded image. Therefore, very stringent requirements in the surface roughness or flatness are not imposed on the spacer member, thereby reducing the component cost. Moreover, the manufacturing step of forming the spacer member does not require a very carefull operation for the formation and handling of the spacer member, thereby reducing the number of assembly steps in mass production, and reducing the frequency of occurrence of a misoperation or a defective. Furthermore, when a recording operation is performed continuously over a long period of time, toner particles may accidentally attach to the toner layer contacting surface of the spacer member, and the toner particles may gradually accumulate with an attached toner particle being a nucleus, thereby forming a protrusion in an area of the toner layer contacting surface of the spacer member where the toner has been fused. Even in such a case, the disturbance in the toner layer due to the protrusion is prevented from being transferred onto the recorded image to cause a minute streak in the recorded image, as described above. Thus, it is possible to prevent the reliability from lowering.

It is preferred that an end portion of the toner layer contacting surface of the spacer member that is on an upstream side in the toner holder moving direction is inclined away from the toner layer in a direction toward the upstream side.

Specifically, when the toner layer enters the area where the spacer member is located, the toner layer is easily scratched off by a corner portion of the spacer member between the toner layer contacting surface thereof and the end surface on the upstream side in the direction in which the toner holder moves, in which case the toner, which has been scratched off, accumulates in the space between the toner passage control device and the toner holder, and the accumulated toner is ejected from the toner passage hole during a non-image forming period, thereby causing a so-called “fogging phenomenon”. With this invention, however, the end portion of the toner layer contacting surface of the spacer member that is on the upstream side in the toner holder moving direction is inclined away from the toner layer in a direction toward the upstream side, whereby the toner layer is not scratched off, and the toner layer smoothly enters the area where the spacer member is located, thereby suppressing the occurrence of the “fogging phenomenon”.

The spacer member is formed by covering a spacer film formed on the insulative member of the toner passage control device with a protection layer. Moreover, it is preferred that the spacer film is formed by a vapor deposition step.

With these inventions, the spacer member, which is as thin as about 10 μm, can be easily and stably formed, as compared to a method in which a spacer member of a metal sheet, or the like, which has been cut to a predetermined size is attached to the surface of the toner passage control device. Moreover, in a method in which the spacer member having a thickness of about 10 μm to which flatness, etc., is required is attached to the toner passage control device, the spacer member is easily deformed in the assembly operation. However, there is no such problem, and it is possible to further reduce the number of assembly steps in mass production and to further reduce the frequency of occurrence of a misoperation or a defective.

It is preferred that the spacer film is made of an insulative material. In this way, it is possible to form the spacer film directly on the insulative member, on which the control electrode has been formed.

Moreover, it is preferred that a surface of the protection layer is subjected to a surface treatment using an antistatic material.

In this way, it is possible to prevent the toner from being excessively charged by the sliding movement between the spacer member and the toner layer, and to prevent the toner from electrostatically attaching to the spacer member surface. Moreover, even if excessive charging occurs, what is newly charged by the sliding movement against the spacer member is the toner, which has already supplied the toner to the toner passage hole, and it will not influence the flight characteristics of the toner through the toner passage hole to cause the image density, the pixel forming position, etc., to vary. Therefore, the level of antistatic performance required for the spacer member may be low as long as it is possible to prevent the toner from electrostatically attaching to the spacer member surface, and may be lower than that in a case where the spacer member is contacted with the toner layer on the upstream side in the direction in which the toner holder moves with respect to the toner passage hole.

It is preferred that a surface resistance of the antistatic material is set to be 10¹⁰ Ω or less. Moreover, it is preferred that the antistatic material is made of a boron-based polymer. With these inventions, it is possible to effectively prevent the toner from being newly charged by the sliding movement between the spacer member and the toner layer.

It is preferred that the surface of the protection layer is electrically grounded. In this way, it is possible to even more effectively prevent the toner from electrostatically attaching to the spacer member surface.

Moreover, the present invention provides a toner passage control device arranged so as to oppose a toner holder for holding a charged toner and moving while forming a toner layer, the toner passage control device including an insulative member and a control electrode, the insulative member including a toner passage hole row formed therein, the toner passage hole row including a plurality of toner passage holes for passing the toner therethrough arranged in a direction perpendicular to a toner holder moving direction, and the control electrode being provided on the insulative member along at least a portion of a periphery of each of the toner passage holes, wherein the toner passage control device controls passage of the toner through the toner passage holes by a voltage applied to the control electrode according to an image signal.

In the invention: a spacer member is provided so as to be in contact with a toner layer surface being moved by the toner holder for maintaining a distance between the toner layer surface and a toner holder side opening of the toner passage hole in the toner passage control device to be substantially constant; and the spacer member is configured so as to contact the toner layer surface at least on a downstream side in the toner holder moving direction with respect to the toner passage hole. Thus, functions/effects as those of the invention described above can be obtained by using the toner passage control device in an image forming device.

The spacer member is configured so as not to contact the toner layer surface on an upstream side in the toner holder moving direction with respect to the toner passage hole. In this way, functions/effects as those of the invention described above can be obtained.

It is preferred that an end portion of the toner layer contacting surface of the spacer member that is on an upstream side in the toner holder moving direction is inclined away from the toner layer in a direction toward the upstream side. In this way, functions/effects as those of the invention described above can be obtained.

It is preferred that the spacer member is formed by covering a spacer film formed on the insulative member with a protection layer. In this way, functions/effects as those of the invention described above can be obtained.

It is preferred that the spacer film is formed by a vapor deposition step. In this way, functions/effects as those of the invention described above can be obtained.

It is preferred that the spacer film is made of an insulative material. In this way, functions/effects as those of the invention described above can be obtained.

It is preferred that a surface of the protection layer is subjected to a surface treatment using an antistatic material. In this way, functions/effects as those of the invention described above can be obtained.

It is preferred that a surface resistance of the antistatic material is set to be 10¹⁰ Ω or less. In this way, functions/effects as those of the invention described above can be obtained.

It is preferred that the antistatic material is made of a boron-based polymer. In this way, functions/effects as those of the invention described above can be obtained.

It is preferred that the surface of the protection layer is electrically grounded. In this way, functions/effects as those of the invention described above can be obtained.

The present invention provides an image forming device, including: a toner holder for holding a charged toner and moving while forming a toner layer; a back electrode which is arranged at a position opposing a toner carrying position of the toner holder and to which a voltage for forming a transfer electrostatic field for sucking the toner of the holder is applied; toner passage control means arranged between the toner holder and the back electrode for controlling passage of the toner through toner passage holes by applying a voltage to a control electrode according to an image signal, the control electrode being provided on an insulative member along at least a portion of a periphery of each of the toner passage holes, the insulative member including a toner passage hole row including a plurality of toner passage holes for passing the toner therethrough; and image receiving means which is arranged between the toner passage control means and the back electrode and to which the toner having passed through the toner passage holes attaches, the image forming device employing a configuration wherein: the toner passage control means is provided with spacer means in contact with the toner layer held on the toner holder for limiting a distance between the toner layer and an opening of the toner passage hole; and the toner passage control means includes a portion, which has a curvature and is arranged while being spaced apart from the toner layer, in an area other than an area where the spacer means contacts the toner layer held on the toner holder.

With such a configuration, even if the position of the toner passage hole row in the toner holder moving direction varies due to factors such as an error in the attachment of the toner passage control means via the fixing means, the head interval at the position of the row of toner passage holes is maintained to be equal to the thickness of the spacer means, thereby preventing the recording characteristics from varying.

Moreover, it is possible to prevent the problem that after the spacer means once abuts on the toner layer at a position in the contact area where the toner layer is contacted, the toner passage control means and the toner layer may contact each other again at a position on the downstream side in the toner holder moving direction with respect to the abutting position. As a result, it is possible to prevent the problem that the contact between the spacer means and the toner layer may become unstable in the intended contact area, thereby varying the head interval and thus varying the recording characteristics.

Furthermore, the present invention provides an image forming device, including: a toner holder for holding a charged toner and moving while forming a toner layer; a back electrode which is arranged at a position opposing a toner carrying position of the toner holder and to which a voltage for forming a transfer electrostatic field for sucking the toner of the holder is applied; toner passage control means arranged between the toner holder and the back electrode for controlling passage of the toner through toner passage holes by applying a voltage to a control electrode according to an image signal, the control electrode being provided on an insulative member along at least a portion of a periphery of each of the toner passage holes, the insulative member including a toner passage hole row including a plurality of toner passage holes for passing the toner therethrough; and image receiving means which is arranged between the toner passage control means and the back electrode and to which the toner having passed through the toner passage holes attaches, the image forming device employing a configuration wherein the toner passage control means includes a portion, which has a curvature and is arranged while being spaced apart from the toner layer, in an area other than an area where the toner passage control means contacts the toner layer held on the toner holder.

With such a configuration, the toner passage control means abuts directly on the toner layer without the spacer means therebetween, whereby it is possible to reduce the interval between the toner layer and the toner passage control means, thereby reducing the applied voltage to the control electrode that is required for the toner flight for obtaining a sufficient recording density, in addition to the effects of claim 1.

It is preferred that in an area which is other than the area where the toner passage control means or the spacer means contacts the toner layer and in which the toner passage control means is arranged while being spaced apart from the toner layer, the curvature of the toner passage control means gradually decreases in a direction away from the contact area.

With such a configuration, the head interval between the toner layer on the toner holder and the toner passage control means gradually increases in the direction away from the lower end portion of the contact area, and the toner passage control means has a curvature approximate to that of the toner holder in the vicinity of the lower end portion of the contact area. Therefore, in the area between the vicinity of the lower end portion of the contact area and the vicinity of the position at which the toner holder and the image receiving means come closest to each other, the amount of increase in the head interval is very small, and the head interval is maintained to be equal to the thickness of the spacer means in this area. Thus, even if the position of the toner passage hole row in the toner holder moving direction varies, the variations in the head interval at the position of the row of toner passage holes can be reduced, thereby preventing the recording characteristics from varying.

It is preferred that in an area which is other than the area where the toner passage control means or the spacer means contacts the toner layer and in which the toner passage control means is arranged while being spaced apart from the toner layer, the curvature of the toner passage control means is constant.

With such a configuration, the curvature of the toner passage control means in an area where it is spaced apart from the toner layer can be made substantially equal to the curvature thereof in the contact area and substantially constant in the spaced-apart area. In this way, as compared to the invention described above where the curvature continuously changes in the spaced-apart area, it is possible to reduce the amount of increase in the head interval on the downstream side in the toner holder moving direction, and to reduce the variations in the recording characteristics due to the variations in the head interval caused by the change in the position of the row of toner passage holes.

It is preferred that the curvature of the toner passage control means in the vicinity of the toner passage hole is substantially the same as the curvature of the toner passage control means in the contact area.

With such a configuration, the interval between the toner layer and the toner passage control means in the vicinity of the toner passage hole can be limited to the thickness of the spacer means, and it is possible to stabilize the toner flight and reduce the applied voltage to the control electrode that is required for the toner flight for obtaining a sufficient recording density.

It is preferred that a bent member contacting the toner passage control means for limiting the curvature of the toner passage control means is provided in an area other than the area where the toner passage control means or the spacer means contacts the toner layer.

With such a configuration, the curvature of the toner passage control means can be substantially equal to the curvature of the toner holder at one end, and can be substantially equal to the curvature of the bent portion at the other end, and the curvature of the toner passage control means in the area therebetween, where the toner passage control means is spaced apart from the toner layer, can be set to a curvature that continuously changes between the two different curvatures. Thus, the configuration of the invention described above can be embodied.

It is preferred that the area where the toner passage control means or the spacer means contacts the toner layer is in a positional relationship such that it does not cross a straight line that extends between a center of the toner holder and a position at which the toner holder and the image receiving means come closest to each other.

With such a configuration, it is possible to prevent the head interval from varying due to the change in the position of the row of toner passage holes and to arrange the row of toner passage holes at the position at which the toner holder and the image receiving means come closest to each other, whereby it is possible to minimize the head interval and the distance between the toner passage control means and the image receiving means, thereby stabilizing the toner flight, and to reduce the applied voltage to the control electrode that is required for the toner flight.

It is preferred that the spacer means is substantially parallel to a peripheral portion of the toner holder in the area where the spacer means contacts the toner layer, and an end portion of the spacer means on the toner passage hole side is a terminal portion of the contact area on the toner passage hole side.

With such a configuration, the toner layer smoothly enters the contact area, and the spacer means contacts the toner layer over a large area while the edge of the spacer means on the downstream side in the toner holder moving direction will not be brought into a linear contact with the toner layer. Thus, it is possible to prevent the stress applied on the toner layer from being localized at the abutting position, thereby reducing the thickness of the toner layer and failing to obtain a sufficient image density.

Moreover, even if there are minute irregularities on the surface of the edge portion, the edge portion will not abut directly on the toner layer, and the irregularities are prevented from being transferred onto the toner layer, thereby preventing a scratch in the toner layer and an image non-uniformity from occurring.

It is preferred that an end portion of the spacer means on the toner passage hole side is subjected to a chamfer process or an R process. With such a configuration, further effects can be obtained in addition to those of the invention described above.

It is preferred that the toner passage control means and the toner holder come closest to each other in the vicinity of the toner passage hole.

With such a configuration, it is possible to minimize the interval between the toner passage control means and the toner layer and the distance between the toner passage control means and the image receiving means, so as to stabilize the toner flight and reduce the applied voltage to the control electrode that is required for the toner flight.

It is preferred that the toner passage control means is provided with a plurality of toner passage hole rows, and the plurality of toner passage hole rows are arranged on both sides with respect to a straight line that extends between a center of the toner holder and a position at which the toner holder and the image receiving means come closest to each other.

With such a configuration, even where the toner passage control means includes a plurality of rows of toner passage holes arranged in the toner holder moving direction in order to improve the recording resolution, the recording characteristics will not vary among the toner passage hole rows due to variations in the head interval among the toner passage hole rows, thereby enabling a control for the plurality of toner passage hole rows under the same condition and simplifying the device.

It is preferred that one of end portions of the toner passage control means in a toner holder moving direction is fixed while the other one of the end portions is held via an elastic member.

With such a configuration, even if the toner holder has outer diameter variations, a cylindricity non-uniformity, or a radial runout, the toner passage control means is moved along the peripheral surface of the toner holder, whereby such variations can be absorbed, and even if the positional relationship between the toner passage hole formed in the toner passage control means and the toner holder in the toner holder moving direction varies due to the outer diameter variations, or the like, the head interval at the position of the toner passage hole does not vary and can be maintained to be constant.

Furthermore, the present invention provides an image forming device, including: a toner holder for holding a charged toner and moving while forming a toner layer; a back electrode which is arranged at a position opposing a toner carrying position of the toner holder and to which a voltage for forming a transfer electrostatic field for sucking the toner on the holder is applied; toner passage control means arranged between the toner holder and the back electrode, the toner passage control means including an insulative member including a toner passage hole row including a plurality of toner passage holes for passing the toner therethrough, and a control electrode provided on the insulative member along at least a portion of a periphery of each of the toner passage holes, wherein a voltage according to an image signal is applied to the control electrode so as to successively control passage of the toner through the toner passage holes; and image receiving means which is arranged between the toner passage control means and the back electrode and to which the toner having passed through the toner passage holes attaches, wherein: the toner passage control means is provided with distance limiting means in contact with the toner layer held on the toner holder for limiting a distance between the toner layer and an opening of the toner passage hole; and the distance limiting means is fixed to the toner passage control means by fixing means which is located in an area other than an area where the distance limiting means contacts the toner layer on the toner holder.

Moreover, it is preferred that the fixing means is located in an area other than the area where the distance limiting means contacts the toner layer on the toner holder in a toner holder moving direction.

With these configurations, even if the thickness of the fixing means for fixing the distance limiting means and the toner passage control means to each other has individual variations or variations in the toner passage hole row direction, the spatial distance (head interval) between the surface of the toner layer formed on the toner holder and the surface of the toner passage control means will not be influenced and caused to change, whereby it is possible to constantly maintain the interval to be equal to the thickness of the distance limitation itself entirely across the row of toner passage holes, and to form a uniform image without non-uniformity.

Moreover, in order to allow a sufficient amount of toner for ensuring a required recording density to fly under a constant voltage application condition, it is necessary to set the head interval to be very small. In such a case, however, even a slight head interval variation results in a relatively increased degree of variation, whereby it is typically very difficult to obtain a constant recording density entirely across the row of toner passage holes without non-uniformity. However, with the configuration of the present invention, the head interval is maintained by the thickness of the distance limiting means itself irrespective of the variations in the thickness of the adhesive layer. Therefore, it is possible to easily ensure a minute head interval, and to form a uniform image without nonuniformity entirely across the row of toner passage holes.

Moreover, it is preferred that the fixing means is located in an area which is other than the area where the distance limiting means contacts the toner layer on the toner holder in a toner holder moving direction and which is located on an upstream side in the toner holder moving direction with respect to the contact area.

With such a configuration, the frictional force applied from the toner holder to the distance limiting means in the contact area where the toner layer and the distance limiting means contact each other equals the tensile force that acts on the distance limiting means. Therefore, even when the distance limiting means is made of a very thin member, the distance limiting means will not be buckled or bent, and the flatness of the distance limiting means is desirably ensured.

It is preferred that the fixing means is arranged at a position where the fixing means does not contact the toner layer on the toner holder. With such a configuration, it is possible to prevent an image non-uniformity due to the toner layer being disturbed on the upstream side with respect to the contact area where the toner layer and the distance limiting means contact each other.

It is preferred that the fixing means is an adhesive layer formed at an interface between the distance limiting means and the toner passage control means.

With such a configuration, even if the thickness of the fixing means for fixing the distance limiting means and the toner passage control means to each other has individual variations or variations in the toner passage hole row direction, the head interval will not be influenced and caused to change, whereby it is possible to constantly maintain the interval to be equal to the thickness of the distance limiting means itself entirely across the row of toner passage holes, and to form a uniform image without non-uniformity.

It is preferred that: the fixing means is adhesive means; and the distance limiting means is arranged on a side such as to seal an end portion in a toner holder moving direction.

With such a configuration, the distance limiting means and the toner passage control means can be in close contact with each other across the entire area of the distance limiting means in the toner holder moving direction. Therefore, the distance limiting means is not bent, and the flatness of the distance limiting means can be improved, whereby the corrugation of the distance limiting means in the contact area where the toner layer and the distance limiting means contact each other in the direction parallel to the row of toner passage holes can be reduced.

It is preferred that: the fixing means is an adhesive tape; and the fixing means is attached over the toner passage control means and the distance limiting means so that the distance limiting means covers an end portion in a toner holder moving direction.

With such a configuration, as compared to a case where a sealing material is used as the fixing means for fixing the distance limiting means and the toner passage control means to each other, the adhesive application step, the curing step and the drying step can be omitted, thereby significantly improving the assembly efficiency in fixing the distance limiting means to the toner passage control means.

Moreover, the thickness of the fixing means itself is reduced and the thickness has a reduced variation, whereby it is possible to reduce the distance of the space between the toner layer and the fixing means that is provided for preventing the fixing means and the toner layer from contacting each other. In this way, the fixing means can be arranged at a position close to the toner holder, and the length of the distance limiting means in the toner holder moving direction can be reduced, thereby reducing the size of the device.

It is preferred that the fixing means is arranged in a direction parallel to the toner passage hole row and over a larger area than the toner passage hole row. With such a configuration, the head interval can be precisely maintained to be constant across the entire length of the row of toner passage holes.

It is preferred that the fixing means is arranged while being divided into a plurality of portions in a direction parallel to the toner passage hole row. With such a configuration, in the step of bonding and fixing the distance limiting means to the toner passage control means, it is possible to prevent the corrugation of the distance limiting means occurring in the direction parallel to the row of toner passage holes during the bonding operation, and it is possible to reduce the amount of material used in the fixing means for fixing the distance limiting means and the toner passage control means to each other, thereby reducing the cost.

It is preferred that the distance limiting means is in contact with the toner passage control means with a gap therebetween having a size less than or equal to a toner particle diameter, and the toner is prevented from intruding into the gap. With such a configuration, the adherence between the distance limiting means and the toner passage control means is improved, the intrusion of the toner into the interface therebetween is reduced, and the head interval can be stably and constantly maintained to be equal to the thickness of the distance limiting means itself for a long period of time.

It is preferred that: a thickness of the adhesive layer is less than or equal to a toner particle diameter; and the toner is prevented from intruding into an interface between the distance limiting means and the toner passage control means. With such a configuration, it is possible to prevent the toner from intruding into a portion other than the adhesion area along the interface between the distance limiting means and the toner passage control means to increase the head interval by the thickness of the intruding toner, thereby constantly maintaining the thickness of the distance limiting means itself to be equal to the interval.

A toner passage control device of the present invention is a toner passage control device arranged so as to oppose a toner carrying position of a toner holder for holding a charged toner and moving while forming a toner layer, wherein: the toner passage control device includes, on an insulative member, a toner passage hole row including a plurality of toner passage holes for passing the toner therethrough arranged in a row in a direction perpendicular to a toner holder moving direction, and a control electrode provided along at least a portion of a periphery of each of the toner passage holes, wherein a voltage according to an image signal is applied to the control electrode so as to control passage of the toner through the toner passage holes; and spacer means which is in contact with the toner layer held on the toner holder for limiting a distance between the toner layer and an opening of the toner passage hole is provided integrally with the toner passage control device.

Moreover, an image forming device of the present invention is an image forming device including the toner passage control device as described above, and a method for manufacturing a toner passage control device of the present invention is a method for manufacturing the toner passage control device as described above.

With such a configuration, the positional precision of the spacer means with respect to the toner passage hole can be improved, and it is possible to prevent variations in the flight characteristics of the toner which are caused by the variations in the head interval when the distance between the spacer means and the toner passage hole varies.

Moreover, this eliminates the assembly operation of precisely attaching the spacer means having a thickness on the order of 10 μm or so to the toner passage control means so that the spacer means is not deformed. Thus, it is possible to eliminate the problem in the prior art that a very careful handling of the spacer means, which is a separate piece, is required, thereby increasing the number of assembly steps in mass production and increasing the cost due to frequent misoperation.

It is preferred that the spacer means is formed by applying, and then curing, a thick film paste on the toner passage control means. Moreover, an image forming device of the present invention is an image forming device including the toner passage control device as described above, and a method for manufacturing a toner passage control device of the present invention is a method for manufacturing the toner passage control device as described above.

With such a configuration, it is possible to easily form the spacer means having a thickness of about 10 μm on the toner passage control means. Moreover, the thickness can be further reduced, and it is then possible to reduce the head interval and to reduce the applied voltage to the control electrode that is required for allowing the toner to fly.

Furthermore, it is preferred that the thick film paste is cured at a temperature of 220° C. or less. Moreover, an image forming device of the present invention is an image forming device including the toner passage control device as described above, and a method for manufacturing a toner passage control device of the present invention is a method for manufacturing the toner passage control device as described above.

With this invention, it is possible to reduce the occurrence of a crease and corrugation in the toner passage control device due to heat contraction.

Moreover, it is preferred that the thick film paste is conductive. Moreover, an image forming device of the present invention is an image forming device including the toner passage control device as described above, and a method for manufacturing a toner passage control device of the present invention is a method for manufacturing the toner passage control device as described above.

With this invention, it is possible to prevent the toner from being excessively charged by the sliding movement between the surface of the spacer means and the toner layer, whereby it is possible to prevent the toner from electrostatically attaching to the spacer surface and to prevent such excessive charging from influencing the flight characteristics of the toner through the toner passage hole to cause the image density, the pixel forming position, etc., to vary.

It is preferred that the thick film paste is applied on the toner passage control means through a screen printing process. Moreover, an image forming device of the present invention is an image forming device including the toner passage control device as described above.

With such a configuration, it is possible to easily form the spacer means having a thickness of about 10 μm on the toner passage control means, and the thickness can be further reduced. Moreover, it is then possible to reduce the head interval and to reduce the applied voltage to the control electrode that is required for allowing the toner to fly.

Furthermore, the positional precision of the spacer means with respect to the toner passage hole can be improved, and it is possible to prevent variations in the flight characteristics of the toner which are caused by the variations in the head interval when the distance between the spacer means and the toner passage hole varies.

Furthermore, in the case where the spacer means is formed only in a portion of the toner passage control means having a large surface area, as in the image forming device of the present invention, the material can be screen-printed only in portions where it is required, thus providing the effect of reducing the material cost and the depreciation cost of facilities, as compared to the case of using a thin film process in which the material is vapor-deposited across the entire area of the toner passage control means including portions that are masked.

It is preferred that a surface of the spacer means is leveled during and after the screen printing process. Moreover, an image forming device of the present invention is an image forming device including the toner passage control device as described above, and a method for manufacturing a toner passage control device of the present invention is a method for manufacturing the toner passage control device as described above.

With this invention, depressions of the irregularities on the surface of the insulative film that have a height corresponding to the thickness of the control electrode are filled with a silver paste and are leveled, thereby making the surface of the spacer means flat. Thus, it is possible to prevent the irregularities on the surface of the insulative film from being expressed as irregularities on the surface of the spacer means, thereby causing irregularities on the toner layer that contacts the spacer means which are transferred onto the image to cause a minute density non-uniformity in the recorded image.

It is preferred that a surface of the spacer means is coated with a metal film. Moreover, an image forming device of the present invention is an image forming device including the toner passage control device as described above.

With such a configuration, the spacer means has a good abrasion resistance.

It is preferred that a surface roughness Rz of a portion of the spacer means that abuts on the toner layer on the toner holder is set to be 2 μm to 4 μm. Moreover, an image forming device of the present invention is an image forming device including the toner passage control device as described above.

In this way, the adhesion force of the toner particle fused on the spacer surface is reduced so that the toner particle is easily removed by the sliding movement against the toner layer, thereby preventing the toner from gradually accumulating with the fused toner particle being a nucleus, and it is possible to prevent a streak or a density non-uniformity from occurring on the recorded image due to variations in the head interval in a long-term use of the image forming device.

It is preferred that the toner passage control means is covered with an insulative film of silicon oxide or silicon nitride having a thickness of 3 μm or less that is deposited through chemical vapor deposition. Moreover, an image forming device of the present invention is an image forming device including the toner passage control device as described above.

In this way, a sufficient degree of insulation and moisture resistance can be obtained with the insulative film having a thickness of about 2 μm, while the head interval can be reduced as compared to the thickness of 5 to 20 μm that is required in other methods, and the applied voltage to the control electrode that is required for allowing the toner to fly can be reduced.

Moreover, the present invention provides, in an image forming device including a toner holder for holding a supplied toner and moving while forming a toner layer, and a back electrode arranged so as to oppose the toner holder for forming a transfer electric field for sucking the toner on the toner holder, a toner passage control device, including a plurality of toner passage holes arranged in a row in a direction that crosses a direction in which the toner holder moves, and a control electrode provided along a periphery of an opening of each of the toner passage holes, wherein the toner passage control device is arranged between the toner holder and the back electrode so as to control flight of the toner on the toner holder toward the back electrode. A spacer portion is provided on an upstream side and a downstream side in the toner holder moving direction with respect to the toner passage hole row, the spacer portion contacting the toner layer on the toner holder for forming and ensuring a constant gap between the toner layer and a toner entering side of each toner passage hole.

With such a configuration, the spacer portions, which are arranged on the upstream side and the downstream side in the toner holder moving direction with respect to the row of toner passage holes of the toner passage control device, contact the toner layer on the toner holder, whereby the head interval, which is the spatial distance between the toner passage control device and the toner holder, can be maintained to be constant along the row of toner passage holes that is located between the two contact areas corresponding respectively to the spacer portion on the upstream side and the spacer portion on the downstream side. In this way, the head interval can be stably maintained even if the flexural rigidity of the toner passage control device changes due to the temperature, etc., and it is possible to prevent a decrease in the image quality.

It is preferred that a ridge portion, on a toner passage hole row side, of the spacer portion that is on the downstream side in the toner holder moving direction is formed to have an inclined cross section or a curved cross section that gradually approaches the toner layer on the toner holder in a direction toward the downstream side in the toner holder moving direction.

In this way, when the toner layer on the toner holder enters the contact area where the downstream side spacer portion is contacted, the toner is prevented from being scratched off by the ridge portion of the spacer portion on the toner passage hole side. Therefore, it is possible to eliminate the problem of a so-called “fogging phenomenon” in which the toner, which has been scratched off the toner holder and has accumulated in the space between the toner passage control device and the toner holder, is ejected from the toner passage hole during a non-image forming period.

It is preferred that where the control electrode is arranged on a toner holder side surface, the spacer portion is formed by applying a thick film paste on a toner passage control device main body and curing the applied thick film paste.

Moreover, it is preferred that the thick film paste is applied through a screen printing process.

With such a configuration, depressions of the irregularities on the surface of the toner passage control device on the toner holder side that have a height corresponding to the thickness of the control electrode are filled with a thick film paste and are leveled, whereby the surface of the spacer portion can be made flat despite the presence of the control electrode. In this way, it is possible to prevent a minute density non-uniformity in the recorded image from occurring due to the surface of the spacer portion becoming irregular to cause irregularities in the toner layer.

Moreover, a thick film paste is typically dried and cured at a relatively low temperature after a screen printing process, whereby it is possible to reduce a crease or corrugation that occurs in the toner passage control device due to heat contraction when the spacer portions are provided.

Moreover, in devices such as the present image forming device in which the spacer portions are formed only in portions of the toner passage control device, which has a large area, the material can be screen-printed only in portions where it is required, thus reducing the material cost and the depreciation cost of facilities.

Moreover, even if the spacer portion has a very small thickness of about 10 μm, it can be easily formed on the toner passage control device. Moreover, the thickness can be further reduced, and it is then possible to further reduce the head interval and to reduce the applied voltage to the control electrode that is required for allowing the toner to fly.

Moreover, the positional precision of the spacer portions with respect to the toner passage hole can be easily improved, and thus it is possible to prevent variations in the flight characteristics of the toner which are caused by the variations in the head interval due to variations in the distance between the toner passage hole and the spacer portions.

Moreover, while it is necessary to precisely attach the spacer portions to the toner passage control device without deforming the spacer portions if the spacer portions are separate pieces as in the prior art, the spacer portions are formed integrally, thereby eliminating such an assembly operation and thus reducing the number of assembly steps in mass production and the occurrence of misoperation.

It is preferred that the spacer portion on an upstream side in the toner holder moving direction and the spacer portion on a downstream side are provided so as to be continuous with each other on an outer side of each end, in a row direction, of the toner passage hole row, i.e., in a non-recording area of the toner passage control device.

In this way, the toner passage control device can be continuously contacted to the toner layer even in a non-recording area of the toner passage control device, whereby it is possible to stably hold the toner passage control device.

It is preferred that the spacer portion on an upstream side in the toner holder moving direction and the spacer portion on a downstream side have thicknesses different from each other.

Such a configuration is advantageous in a case where a plurality of rows of toner passage holes are provided. Specifically, in the area between a contact area where the upstream spacer portion contacts the toner layer and a contact area where the downstream spacer portion contacts the toner layer, the head interval varies in the range equal to the difference between the thicknesses of the two spacer portions. Therefore, a head interval appropriate for each of the upstream and downstream rows of toner passage holes can be set by independently setting the thicknesses of the two spacer portions. For example, the amount of toner to be supplied typically decreases for a row of toner passage holes on the downstream side with respect to another row of toner passage holes on the upstream side, whereby it is possible to compensate for the decrease in the toner supply to obtain flight characteristics as those on the upstream side by setting the head interval for a row of toner passage holes on the downstream side to be smaller than that for another row of toner passage holes on the upstream side.

It is preferred that: a depressed portion is provided on a toner holder side surface; and the toner passage holes are arranged in the depressed portion.

In this way, the toner passage control device can be contacted to the toner layer on the toner holder both on the upstream side and the downstream side in the toner holder moving direction with respect to the row of toner passage holes. For example, if the depressed portion has its bottom surface at a constant depth position, the head interval can be maintained to be equal to the depth dimension of the depressed portion. Thus, as in the invention described above, it is possible to prevent the problem that the head interval varies when the flexural rigidity of the toner passage control device changes due to the temperature, etc., and to prevent the toner flight characteristics from varying due to variations in the head interval.

It is preferred that the depressed portion is formed by heat-pressing the toner holder side surface.

In this way, the wall surface of the depressed portion on the downstream side can be formed in an optimal step shape by the shape of the die used for heat-pressing the toner passage control device in the formation of the depressed portion. Specifically, it is preferably a slope shape having a rounded ridge portion.

Moreover, even a step having a wall surface whose height is about 10 μm can be easily formed on the toner passage control device. The precision of such a step shape is determined by the precision of the die, whereby the variations in the head interval can be further reduced as compared to a case where the head interval is limited by the spacer portion formed through a screen printing process. Moreover, the thickness can be further reduced, and it is then possible to reduce the head interval and to reduce the applied voltage to the control electrode that is required for allowing the toner to fly.

It is preferred that where the toner passage control device includes an insulative base member and the control electrode is arranged on a toner holder side surface of the insulative base member, the toner passage control device includes an adhesive layer which is provided on the same surface of the insulative base member as the control electrode and which can be deformed by being heat-pressed while the depressed portion is formed with heat, and a cover layer provided on the control electrode and the adhesive layer.

Moreover, it is preferred that a surface of the cover layer is formed to be flush. Moreover, it is preferred that a thickness of the adhesive layer is smaller than a thickness of the control electrode.

With these arrangements, the depressions between the control electrodes on the insulative base member are absorbed as the depressions are filled with the softened adhesive layer during the heat pressing process, whereby the irregularities are prevented from being expressed on the surface of the toner passage control device. Thus, it is possible to prevent the problem that the irregularities formed by the control electrodes are expressed as irregularities on the surface of the cover layer, and irregularities are formed in the toner layer that contacts the irregular portions, which are then transferred onto the image, thereby causing a minute density non-uniformity in the recorded image.

It is preferred that a ridge portion of the depressed portion that is on a downstream side in the toner holder moving direction is formed to have an inclined cross section or a curved cross section.

Moreover, it is preferred that a wall surface of the depressed portion that is on a downstream side in the toner holder moving direction is formed to have an inclined cross section that gradually approaches the toner layer on the toner holder in a direction toward the downstream side in the toner holder moving direction.

With these arrangements, when the toner layer enters the contact area of the toner passage control device on the downstream side, the toner is prevented from being scratched off by the wall surface of the depressed portion on the downstream side or the ridge portion caused by the wall surface step. Therefore, it is possible to eliminate the problem of a so-called “fogging phenomenon” in which the toner, which has been scratched off the toner holder and has accumulated in the space between the toner passage control device and the toner holder, is ejected from the toner passage hole during a nonimage forming period.

Furthermore, the present invention provides a method for manufacturing the toner passage control device as described above, and with such a configuration, a toner passage control device according to the invention described above can be realized.

Particularly, it is preferred that when heat-pressing the toner passage control device main body, not only an area of the toner passage control device main body in which the depressed portion is to be formed is heat-pressed, but also a surrounding area is heat pressed simultaneously.

If only the area of the depressed portion is heat-pressed when heat-pressing the toner passage control device main body, a crease or corrugation is likely to occur in the surrounding area (e.g., the insulative base member or the cover layer), whereas if the heat pressing process is performed over an area including the surrounding area, it is possible not only to prevent such a crease or corrugation but also to improve the flatness of the surface of the surrounding area as compared to that before the heat pressing process.

### BRIEF DESCRIPTION OF THE DRAWINGS

FIG. 1 is a cross-sectional view schematically illustrating an image forming device of Example 1 of the present invention with a toner supply unit having been set in a casing member.

FIG. 2 is a cross-sectional view illustrating a toner supply unit being set in a casing member.

FIG. 3 is an enlarged plan view illustrating a portion of a toner passage control device around toner passage holes.

FIG. 4 is a cross-sectional view taken along line IV-IV of FIG. 3.

FIG. 5 is a view as viewed from a direction of arrow V of FIG. 4.

FIG. 6 is a diagram illustrating the operation showing how a toner flies.

FIG. 7 is a cross-sectional view schematically illustrating a toner passage control device and an image forming device according to Example 2 of the present invention.

FIG. 8 is an enlarged plan view illustrating a portion of a toner passage control device around toner passage holes.

FIG. 9 is a cross-sectional view taken along line III-III of FIG. 8.

FIG. 10 is a view as viewed from a direction of arrow IV of FIG. 9.

FIG. 11 is a cross-sectional view taken along line V-V of FIG. 8.

FIG. 12 is a cross-sectional view taken along line VI-VI of FIG. 8.

FIG. 13 is a cross-sectional view taken along line VII-VII of FIG. 8.

FIG. 14 is a diagram illustrating the operation showing how a toner flies.

FIG. 15 is a cross-sectional view illustrating a schematic configuration of Example 3 of the image forming device of the present invention.

FIG. 16 is a cross-sectional view illustrating a schematic configuration of Example 3 of the image forming device.

FIG. 17 is an enlarged view illustrating a portion of toner passage control means of the same example around toner passage holes.

FIG. 18 is a vertical-sectional side view illustrating three operation states for a toner passage hole of the same example.

FIG. 19 is a cross-sectional view illustrating a schematic configuration of Example 4 of the image forming device of the present invention.

FIG. 20 is an enlarged view illustrating a portion of toner passage control means of the same example around toner passage holes.

FIG. 21 is a cross-sectional view illustrating a schematic configuration of an image forming device of Example 5 of the present invention.

FIG. 22 is a diagram illustrating, on an enlarged scale, an important part of toner passage control means.

FIG. 23 is a vertical-sectional side view illustrating three operation states for a toner passage hole of Example 5.

FIG. 24 is a cross-sectional view illustrating a schematic configuration of Example 6 of the image forming device of the present invention.

FIG. 25 is a cross-sectional view illustrating a schematic configuration of Example 7 of the image forming device of the present invention.

FIG. 26 is a cross-sectional view schematically illustrating an image forming device of Example 8 of the present invention with a toner supply unit having been set in a casing member.

FIG. 27 is an enlarged view illustrating a portion of toner passage control means around toner passage holes.

FIG. 28 is an enlarged view illustrating a portion of toner passage control means according to Example 8 of the present invention around toner passage holes.

FIG. 29 is a cross-sectional view illustrating three ways in which a toner flies through a toner passage hole according to Example 8 of the present invention.

FIG. 30 is a cross-sectional view illustrating a schematic configuration of Example 9 of the image forming device of the present invention.

FIG. 31 is a diagram illustrating a portion of a toner passage control device of the same example around toner passage holes (FIG. 31(a) is a plan view as viewed from the toner holder side, FIG. 31(b) is a cross-sectional view taken along line B-B of FIG. 31(a), and FIG. 31(c) is a plan view as viewed from the back electrode side).

FIG. 32 is an enlarged view illustrating a portion of a toner passage control device of the same example around toner passage holes (FIG. 32(a) is a plan view as viewed from the toner bolder side, FIG. 32(b) is a cross-sectional view taken along line B-B of FIG. 32(a), FIG. 32(c) is a cross-sectional view taken along line C-C of FIG. 32(a), FIG. 32(d) is a plan view as viewed from the back electrode side, and FIG. 32(e) a crosssectional view taken along line E-E of FIG. 32(a)).

FIG. 33 is a vertical-sectional side view illustrating three operation states for a toner passage hole of the same example.

FIG. 34 is a cross-sectional view illustrating a schematic configuration of Example 10 of the image forming device of the present invention.

FIG. 35 is an enlarged view illustrating a portion of a toner passage control device of the same example around toner passage holes (FIG. 35(a) is a plan view as viewed from the toner holder side, FIG. 35(b) is a cross-sectional view taken along line B-B of FIG. 35(a), FIG. 35(c) is a cross-sectional view taken along line C-C of FIG. 35(a), FIG. 35(d) is a plan view as viewed from the back electrode side, and FIG. 35(e) a cross-sectional view taken along line E-E of FIG. 35(a)).

FIG. 36 is a diagram illustrating a schematic configuration of a conventional image forming device.

FIG. 37 is a diagram illustrating a schematic configuration of a conventional image forming device using an image holding belt as an image receiving member.

FIG. 38 is a plan view illustrating an example of an arrangement of toner passage holes.

### BEST MODE FOR CARRYING OUT THE INVENTION

Best modes for carrying out the present invention will be described below in the form of Examples with reference to the drawings.

### EXAMPLE 1

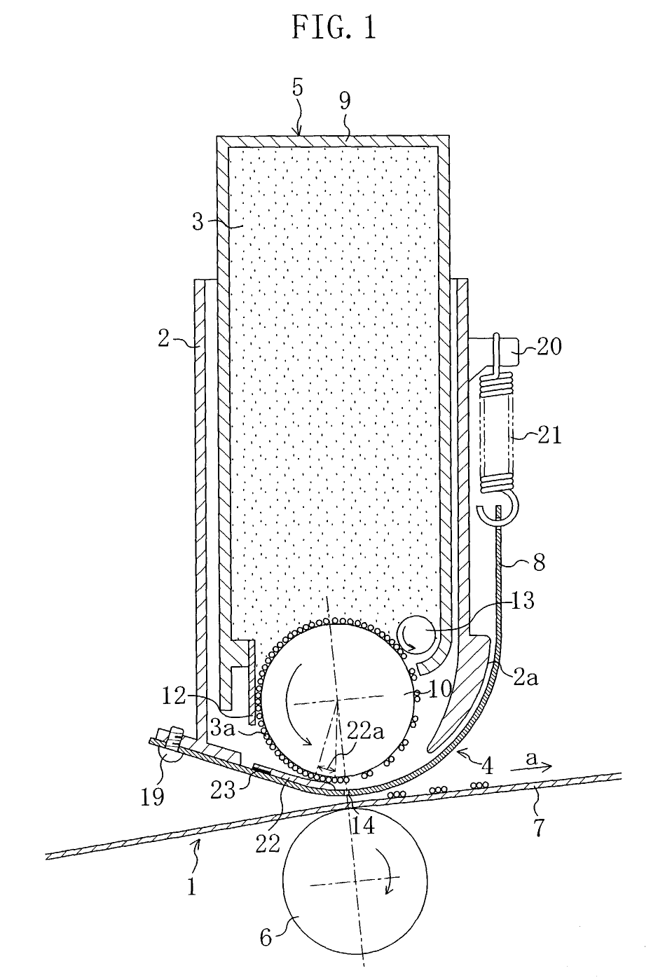

FIG. 1 schematically illustrates an image forming device according to Example 1 of the present invention. In the figure, reference numeral 1 is a print head, and the print head 1 includes a casing member 2 that is open on the upper side and has an opening in the bottom portion, a toner passage control device 4 arranged on the outer surface of a lower portion of the casing member 2 so as to cover the opening, and a toner supply unit 5 placed in the casing member 2. A counter electrode 6 is arranged below the print head 1 with an appropriate gap therebetween, and an image receiving member 7 such as recording paper is passed through between the counter electrode 6 and the print head 1.

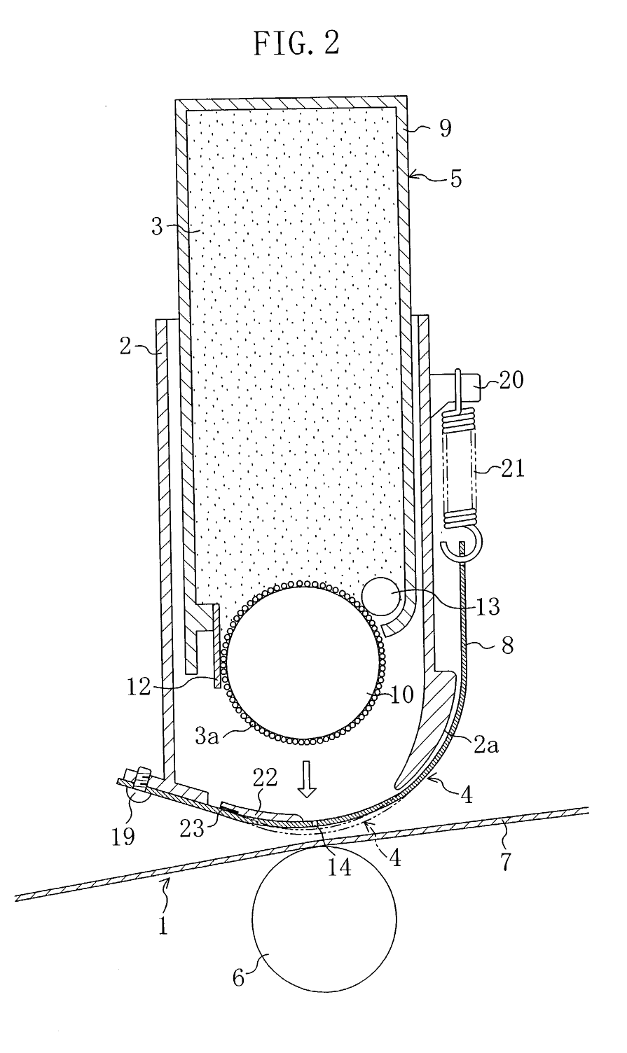

The toner supply unit 5 includes a storage container 9 for storing a toner 3, which is a developer, a toner holder 10 arranged so as to meet an opening that is formed in a lower portion of the storage container 9, a limiting blade 12 for limiting a toner layer 3a held and carried by the toner holder 10, and a supply roller 13 for stirring and frictionally charging the toner 3 in the storage container 9 while supplying the toner 3 to the toner holder 10. As illustrated in FIG. 2, the toner supply unit 5 is inserted into the casing member 2 vertically and downwardly in the figure and is set at a predetermined position in the casing member 2.

The toner holder 10 is formed in a generally cylindrical shape by using a metal such as aluminum or iron or an alloy, and rotates in the counterclockwise direction in FIG. 1 about the central axis thereof (moves from left to right in FIG. 1), thereby carrying the toner layer 3a to the toner carrying position in the lower portion (a position opposing a toner passage hole 14 to be described later). In the present example, the toner holder 10 is a rotatable sleeve made of aluminum having an outer diameter of 20 mm and a thickness of 1 mm, and the potential thereof is the ground potential.

The limiting blade 12 is made of an elastic member such as a urethane, and suitably has a hardness of 40 to 80 degrees (JIS K6301 A Scale), a free end length (the length of a portion thereof extending from the position where it is attached) of 5 to 15 mm, and a linear load on the toner holder 10 of 5 to 40 N/m. One to three toner layers 3a are formed on the toner holder 10 by the limiting blade 12. Note that in the present example, the limiting blade 12 is electrically floating.

The toner 3 is interposed between the toner holder 10 and the limiting blade 12, where it is subject to slight stirring and is charged by receiving a charge from the toner holder 10. In the present example, the toner 3 is a non-magnetic material having an average particle diameter of 6 μm, and has a negative charge of −10 μC/g.

The supply roller 13 is obtained by providing a synthetic rubber such as a urethane foam having a thickness of about 2 to 6 mm on a shaft made of a metal such as iron (having a diameter of 8 mm in the present example), so that the hardness thereof is 30 degrees (as measured by the method of JIS K6301 A Scale using a sample that has been processed into a roller shape). In addition to assisting in charging the toner 3, it controls the supply of the toner 3 to the toner holder 10. The amount by which the supply roller 13 is pushed into the toner holder 10 is preferably about 0.1 to 2 mm.

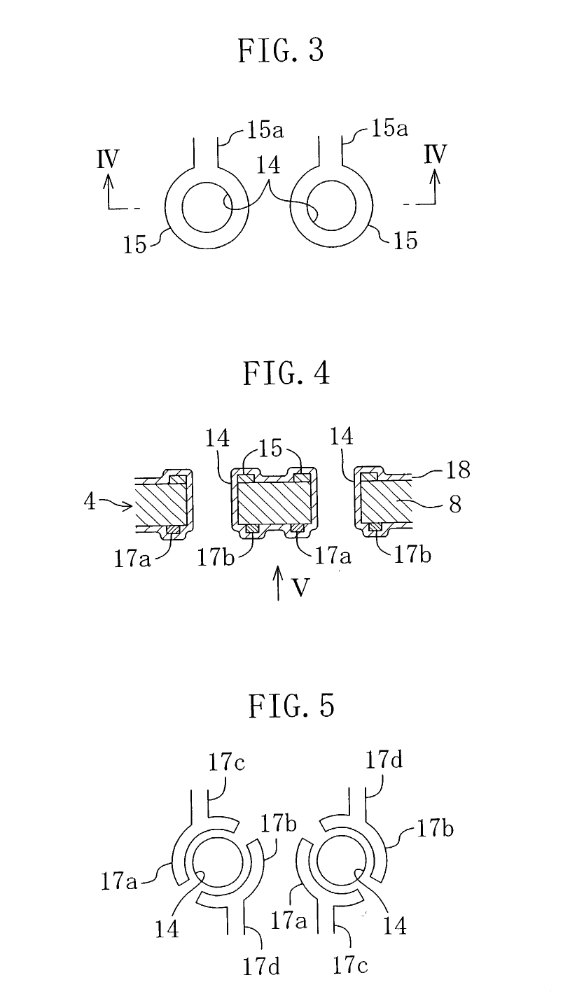

The toner passage control device 4 includes, as a base member, a flexible insulative member 8 having a thickness of about 50 μm and an effective width that corresponds to the effective width of the toner holder 10. The insulative member 8 is provided with a large number of toner passage holes 14 arranged at a minute pitch in the width direction of the image receiving member 7 (the direction of the central axis of the toner holder 10: the direction perpendicular to the sheet of FIG. 1), whereby one or more rows of toner passage holes 14 are formed, each row including the toner passage holes 14 arranged in the direction perpendicular to the direction in which the toner holder 10 moves. A ring-shaped control electrode 15 (see FIG. 3 and FIG. 4) is formed on the upper surface of the insulative member 8 along the entire periphery (or a portion thereof) of each of the toner passage holes 14 so as to surround the toner passage hole 14, and deflection electrodes 17a and 17b (see FIG. 4 and FIG. 5) are formed on the lower surface of the insulative member 8. The insulative member 8 is preferably made of a material such as polyimide or polyethylene terephthalate, and suitably has a thickness of 10 to 100 μm. In the present example, polyimide having a thickness of 50 μm is used as the insulative member 8.

FIG. 3 to FIG. 5 illustrate, on an enlarged scale, a portion of the toner passage control device 4 around the toner passage hole 14. As described above, the toner passage control device 4 includes the toner passage holes 14 provided in the insulative member 8 thereof and arranged in a row at a predetermined pitch in the central axis direction of the toner holder 10 (the direction perpendicular to the direction in which the toner holder 10 moves). In the present example, the pitch of the toner passage holes 14 is 125 μm, corresponding to 200 dpi, for a recording resolution of 600 dpi.

Moreover, the control electrode 15 is arranged on the upper surface of the insulative member 8 so as to surround the periphery of each toner passage hole 14, and a tip portion of a wire portion 15a extending from the control electrode 15 is connected to an IC chip (not shown) for applying an image signal to the control electrode 15. On the other hand, the pair of deflection electrodes 17a and 17b are arranged on the lower surface of the insulative member 8 so as to surround the toner passage hole 14 from opposite sides. As the control electrode 15, the deflection electrodes 17a and 17b are also provided with wire portions 17c and 17d, respectively, that are connected to the IC chip. The electrodes 15, 17a and 17b are made of a Cu film having a thickness of about 8 to 20 μm, which is patterned on the insulative member 8, and the surface of the toner passage control device 4 is coated with an insulative film 18 of 5 to 30 μm so as to prevent these electrodes 15, 17a and 17b from being shorted with one another.

While the shape of the toner passage hole 14 is a circular shape in FIG. 3 and FIG. 5, it may alternatively be another shape such as an oblong circle shape or an elliptical shape, and the size thereof is set so that the diameter is about 70 to 120 μm. Note that a voltage of 400 V or less is normally applied to the control electrode 15 for forming dots. In the present example, a voltage of 250 V is applied for forming dots and a voltage of −50 V for not forming dots.

As illustrated in FIG. 1 and FIG. 2, the toner passage control device 4 is attached and fixed to the casing member 2 by a screw 19, as attachment means, at an end portion thereof that is on the upstream side in the direction in which the toner holder 10 moves with respect to the toner passage hole 14 (an end portion opposite to the side to which the toner holder 10 moves: “moving direction rear end portion”), and an end portion that is on the downstream side in the direction in which the toner holder 10 moves (an end portion on the side to which the toner holder 10 moves: “moving direction front end portion”) is wound around a stay portion 2a (a bent portion) that is formed in the casing member 2 and having a curvature smaller than that of the outer perimeter of the toner holder 10, is bent along the stay portion 2a, and then attached to an attachment portion 20 protruding from the casing member 2 via a tension spring 21 (of course, the attachment positions of the opposite end portions of the toner passage control device 4 may be reversed from those described above). The contact pressure between the toner holder 10 and the toner passage control device 4 caused by the tension spring 21 (the toner holder 10 and the toner passage control device 4 contact each other via a spacer member 22 as will be described later) is suitably 2 to 20 kPa. This is because the toner holder 10 and the toner passage control device 4 need to be always in contact with each other under the same condition, following the eccentricity of the rotation axis of the toner holder 10, in order to maintain the interval between the toner holder 10 and the toner passage control device 4 at the position of the toner passage hole 14 to be substantially constant, and an excessive contact pressure deforms the toner layer 3a on the toner holder 10. Note that the contact pressure slightly varies depending on the material of the toner holder 10 and the toner passage control device 4, etc.

Reference numeral 22 is a spacer member that is bonded and fixed to the surface (upper surface) of the toner passage control device 4 that opposes the toner holder 1 via an adhesive layer 23. The upper surface of the spacer member 22 contacts the surface of the toner layer 3a on the toner holder 10 in a contact area 22a, whereby the interval (head interval) between the surface of the toner layer 3a on the toner holder 10 and the opening, on the side of the toner holder 10, of the toner passage hole 14 in the toner passage control device 4 is maintained at a constant interval that is substantially the same as the thickness of the spacer member 22 itself. Thus, the spacer member 22 is provided between the toner holder 10 and the toner passage control device 4 at a position that is on the upstream side in the direction in which the toner holder 10 moves with respect to the toner passage hole 14, with one of the surfaces in the thickness direction (the upper surface) thereof contacting the surface of the toner layer 3a on the toner holder 10, and the other surface (the lower surface) thereof contacting the upper surface of the toner passage control device 4. The thickness of the spacer member 22 is preferably 5 to 150 μm, more preferably 5 to 20 μm, and it is set to be 10 μm in the present example. Moreover, the spacer member 22 is made so that irregularities on the surface (the upper surface) of the toner passage control device 4 that is in contact with the spacer member 22 are not transferred onto the surface of the toner layer 3a or do not influence the smoothness of the upper surface of the spacer member 22. Specifically, the spacer member 22 is made of a steel strip or a conductive resin sheet, and is electrically grounded. In a case where a steel strip is used, it is preferably a stainless steel strip for springs (e.g., SUS 301-CSP), a carbon tool steel material (SK), a cold rolled steel strip for springs (e.g., SK4-CSP), a cold rolled stainless steel strip (e.g., SUS301), or the like, and it is preferred that the hardness Hv of the surface of the spacer member 22 is 400 to 600. On the other hand, in a case where a conductive resin is used, it is preferred to use a PET or polyimide sheet, as a base sheet, which is subjected to a surface treatment using an antistatic material. The surface treatment using an antistatic material is preferably performed by coating the surface with a boron-based antistatic polymer, and the coating thickness is preferably 5 to 10 μm. Moreover, the surface resistance value of the antistatic material is preferably 10¹⁰ Ω (Ω/□) or less, and more preferably 10⁷ to 10⁸ Ω. Note that a sheet made of a stainless steel strip for springs (SUS 301-CSP-H) and having a thickness of 10 μm is used in the present example. A stainless steel strip is used in order to prevent corrosion, and a spring steel with a tempering symbol “H” is used in order to obtain a hardness Hv of 430.

The surface roughness Rz (ten-point average roughness based on JIS B0601 with a reference length of 0.8 mm) of the surface of the spacer member 22 that contacts the toner layer 3a on the toner holder 10 (the upper surface: “toner layer 3a contact surface”) is preferably smaller than the average particle diameter of the toner 3 or 2 to 8 μm. Particularly, the surface roughness Rz in an area of the upper surface of the spacer member 22 that is 5 mm in length from one end thereof on the downstream side in the direction in which the toner holder 10 moves toward the upstream side is preferably set to be smaller than the average particle diameter of the toner 3 so that the smoothness of the surface of the toner layer 3a does not vary through the contact of the spacer member 22 to the toner layer 3a. Specifically, it is preferably 2 to 4 μm. Moreover, in an area of the upper surface of the spacer member 22 that is 1 mm in length from one end thereof on the downstream side in the direction in which the toner holder 10 moves toward the upstream side, it is preferred that the protrusion height with respect to the surface roughness average line is set to be 4 μm or less. In the present example, the surface roughness Rz of the entire spacer member 22 is set to be 6.3 Z (6.3 μm or less), the surface roughness Rz is 3.2 Z (3.2 μm or less) in an area of the upper surface of the spacer member 22 that is 5 mm in length from one end thereof on the downstream side in the direction in which the toner holder 10 moves toward the upstream side, and there is no protrusion having a height exceeding 4 μm with respect to the surface roughness average line, in the area of the upper surface of the spacer member 22 that is 1 mm in length from one end thereof on the downstream side in the direction in which the toner holder 10 moves toward the upstream side. Moreover, a corner portion of the spacer member 22 between the upper surface thereof and the end surface on the downstream side in the direction in which the toner holder 10 moves is rounded off through a chamfer process (e.g., an R-chamfer process) of a size equal to or greater than ½ of the thickness of the spacer member 22.

The adhesive layer 23 is preferably a resin-based or rubber-based adhesive or a double-sided adhesive tape. Moreover, the thickness thereof is preferably 2 to 120 μm, and more preferably 2 to 5 μm.

When the toner supply unit 5 is attached to the casing member 2, with the distance between the toner holder 10 and the counter electrode 6 being maintained at a predetermined dimension, the toner layer 3a formed on the peripheral surface of the toner holder 10 is in contact with the spacer member 22. The toner passage control device 4 is wound around the outer perimeter of the bent portion 2a of the casing member 2, and then elastically held by the casing member 2 via the tension spring 21 that is suspended at the end on the downstream side in the direction in which the toner holder 10 moves. In such a state, the tension spring 21 is displaced, resisting against the pressing force from the toner holder 10 to the spacer member 22 (the toner passage control device 4 is slightly displaced downward as indicated by a two-dot chain line in FIG. 2). Thus, the toner passage control device 4, across the entire width thereof, is in close contact with the surface of the toner layer 3a on the toner holder 10 via the spacer member 22. The interval (head interval) between the toner layer 3a on the toner holder 10 and the opening, on the side of the toner holder 10, of the toner passage hole 14 in the toner passage control device 4 is precisely maintained by the spacer member 22 at a value in the range of 0 to 200 μm, and 10 μm in the present example. The tension on the toner passage control device 4 caused by the tension spring 21 is a value that is appropriately set so as to obtain an appropriate contact pressure (2 to 20 kPa) between the toner holder 10 and the toner passage control device 4 as described above, and is relatively small for the rigidity of the toner passage control device 4 itself

The present example employs a configuration in which the toner passage control device 4 is contacted with the toner layer 3a on the toner holder 10 via the spacer member 22, as described above, whereby even if the toner holder 10 has outer diameter variations, a cylindricity non-uniformity, a radial runout, etc., the toner passage control device 4 moves in the vertical direction along the peripheral surface of the toner holder 10, whereby such variations can be absorbed. In this way, the head interval at the position of the row of toner passage holes 14 is maintained at a constant value that is substantially the same as the thickness of the spacer member 22, thereby preventing the recording characteristics from varying.

The counter electrode 6 is arranged so as to oppose the toner carrying position of the toner holder 10 with the toner passage control device 4 being interposed between the counter electrode 6 and the toner holder 10, and the counter electrode 6 is obtained by dispersing a conductive filler in a metal or a resin. A voltage for forming, between the counter electrode 6 and the toner holder 10, a transfer electrostatic field that sucks the toner 3 of the toner layer 3a on the toner holder 10 is applied to the counter electrode 6. Specifically, a DC voltage of about 500 to 2000 V is applied, and a voltage of 1000 V is applied in the present example. Moreover, the distance between the counter electrode 6 and the toner holder 10 is preferably 150 to 1000 m, and is set to be 350 μm in the present example. The image receiving member 7 such as recording paper is placed between the counter electrode 6 and the print head 1, and the image receiving member 7 is passed through therebetween by being carried in the direction of arrow “a” along a predetermined path extending between the counter electrode 6 and the toner passage control device 4.

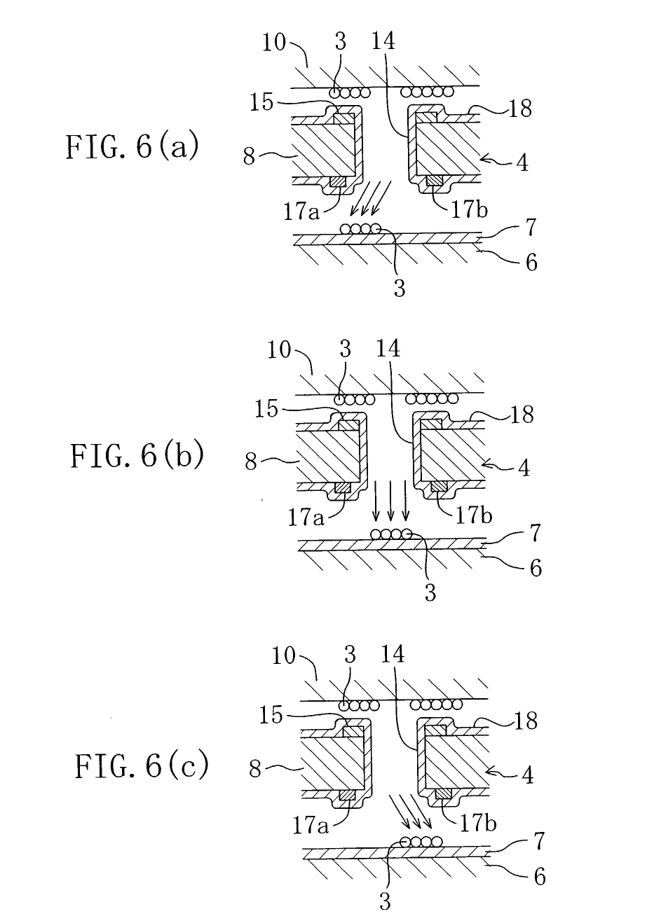

An image forming operation with such a configuration will be described with reference to FIG. 6. First, as illustrated in FIG. 6(a), the toner 3 of the toner layer 3a held by the toner holder 10 is allowed to fly by applying a voltage of 250 V to the control electrode 15 with +150 V being applied to the left deflection electrode 17a and −150 V being applied to the right deflection electrode 17b so that the negatively charged toner 3 is deflected to the left. Then, the toner 3 is pulled by the electric field formed by the counter electrode 6 to pass through the toner passage hole 14, and flies while being deflected to the left so as to attach to the image receiving member 7 at a position that is displaced by about 40 μm to the left from the position opposing the toner passage hole 14.

Then, as illustrated in FIG. 6(b), a voltage is applied to the control electrode 15 as described above with the left and right deflection electrodes 17a and 17b being brought to 0 V, whereby the toner 3 flies straight along the axis direction of the toner passage hole 14 without being deflected so as to attach to the image receiving member 7 at the position opposing the toner passage hole 14.

Next, as illustrated in FIG. 6(c), a voltage is applied to the control electrode 15 as described above with −150 V being applied to the left deflection electrode 17a and +150 V being applied to the right deflection electrode 17b so that the negatively charged toner 3 is deflected to the right, whereby the toner 3 flies while being deflected to the right so as to attach to the image receiving member 7 at a position that is displaced by about 40 μm to the right from the position opposing the toner passage hole 14. In this way, the toner 3 can be made to attach to three points, i e., the left, right and center points, with a single toner passage hole 14, by successively changing the voltages applied to the control electrode 15 and the deflection electrodes 17a and 17b. Note that during a non-image forming period, the voltage applied to the control electrode 15 is set to be −50 V so that the toner 3 does not fly.

Thus, in the example above, a sheet made of a stainless steel strip for springs and having a thickness of 10 μm is used, irregularities on the surface of the toner passage control device 4 (as a contact member contacting one of the surfaces of the spacer member 22 in the thickness direction thereof that is opposite to the surface contacting the toner layer 3a) will not influence the surface of the spacer member 22, and the irregularities will not be transferred onto the toner layer 3a to cause an image non-uniformity.

Specifically, as described above with reference to FIG. 3 to FIG. 5, the toner passage control device 4 includes, on the insulative member 8, the electrodes 15, 17a and 17b that are formed by patterning a Cu film having a thickness of about 8 to 20 μm, and the surface thereof is coated with the insulative film 18 of 5 to 30 μm for preventing these electrodes from being shorted with one another, with the insulative film 18 being coated on the surface of the electrodes 15, 17a and 17b with a constant thickness. Therefore, irregularities having a height of 8 to 20 μm which are caused by the thickness of the control electrode 15 appear on the upper surface of the toner passage control device 4 at the pitch of the control electrodes 15, i.e., 125 μm. On the other hand, as described above, the toner passage control device 4 is pressed against the toner layer 3a formed on the toner holder 10 with a contact pressure of 2 to 20 kPa via the spacer member 22. If the upper surface of the toner passage control device 4 having irregularities as described above is pressed with such a pressure uniformly against the toner layer 3a, the spacer member 22 may bent and deformed along the irregularities. In the example above, however, the spacer member 22 is made of a stainless steel strip for springs, whereby it does not undergo the bending deformation along the irregularities on the upper surface of the toner passage control device 4, and has a sufficient flexural rigidity so as not to transfer the irregularities to the upper surface of the spacer member 22. As a result, the upper surface precision of the spacer member 22 is not influenced by the irregularities on the upper surface of the toner passage control device 4, and the irregularities are prevented from being transferred onto the toner layer 3a with which the spacer member 22 contacts to cause an image non-uniformity.

Moreover, in the portion of the spacer member 22 that directly contacts the toner layer 3a, i.e., in the area of the upper surface of the spacer 22 that is 5 mm in length from one end thereof on the downstream side in the direction in which the toner holder 10 moves toward the upstream side, the surface roughness Rz is set to be 3.2 Z, whereby the height of the irregularities between top and bottom portions in that area is 3.2 μm at maximum. On the other hand, the average particle diameter of the toner 3 is 6 μm, as described above. Therefore, assuming that the toner layer 3a having a uniform thickness is ideally formed only with particles of the toner 3 having a particle diameter of 6 μm, the surface roughness Rz of the toner layer 3a is calculated to be 6×sin45°, i.e., 4.2 μm. As a result, the surface roughness in that area is set to be smaller than the surface roughness of the toner layer 3a formed with a uniform thickness, whereby the surface roughness of the toner layer 3a does not increase when the spacer member 22 contacts the toner layer 3a. Thus, the toner layer 3a contacted by the spacer member 22 is prevented from being scratched by minute irregularities or protrusions on the surface of the spacer member 22, and such minute irregularities or protrusions are prevented from being transferred onto the image to cause a minute streak in the recorded image. Herein, the toner 3 in fact has a particle diameter distribution, and the content of the toner 3 having a smaller particle diameter than the average particle diameter, e.g., the toner 3 having a particle diameter of 5 μm or less, is about 20 to 30%. On the other hand, the toner 3 having a large particle diameter of 11 μm or more is contained at about the same proportion. Therefore, it is assumed that if the toner 3 having a large particle diameter and the toner 3 having a small particle diameter are distributed substantially equally, the surface roughness Rz of the toner layer 3a is the same as the value above calculated from the average particle diameter.

Moreover, in the example above, the spacer member 22 is substantially parallel to the peripheral surface of the toner holder 10 in the contact area 22a, and the end of the spacer member 22 on the downstream side in the direction in which the toner holder 10 moves is located on the downstream side in the direction in which the toner holder 10 moves with respect to the contact area 22a. Moreover, in the area of the upper surface of the spacer member 22 that is 1 mm in length from one end thereof on the downstream side in the direction in which the toner holder 10 moves toward the upstream side, there is no protrusion whose height does not exceed 4 μm with respect to the surface roughness average line. Moreover, a corner portion of the spacer member 22 between the upper surface thereof and the end surface on the downstream side in the direction in which the toner holder 10 moves is chamfered by a size equal to or greater than ½ of the thickness of the spacer member 22. In this way, the toner layer 3a smoothly enters the contact area 22a of the spacer member 22, and the spacer member 22 contacts the toner layer 3a over a large area in the contact area 22a while an edge portion (end) on the upper surface of the spacer member 22 on the downstream side in the direction in which the toner holder 10 moves does not directly abut on the toner layer 3a. Therefore, even if there are minute irregularities on the surface of the edge portion, the stress applied on the toner layer 3a is not localized in the edge portion. As a result, the irregularities in the edge portion are prevented from being transferred onto the toner layer 3a, thereby preventing a scratch in the toner layer 3a and an image non-uniformity from occurring. Moreover, this eliminates the problem that a sufficient image density cannot be obtained due to a reduced thickness of the toner layer 3a.

Moreover, in the example above, the spacer member 22 is electrically grounded, and the surface roughness Rz of the spacer member 22 is limited in the predetermined area as described above, whereby it is possible to prevent the toner 3 from attaching to the surface of the spacer member 22 in a long-term use.

Specifically, when a recording operation is performed continuously over a long period of time with the surface roughness Rz of the spacer member 22 being set to be about 12.5 Z (12.5 μm or less), the toner 3 is accidentally fused on the portion 22a of the upper surface of the spacer member 22 that is in contact with the toner layer 3a, and the toner 3 gradually accumulates with the fused toner 3 being a nucleus. The portion of the upper surface of the spacer member 22 on which the toner 3 is fused forms a protrusion, whereby a streak-like scratch is formed on the toner layer 3a, which is regulated in a layer by the limiting blade 12, at a position opposing the spacer member 22, thus transferring a streak running in the secondary scanning direction (the direction in which the toner holder 10 moves) onto the image formed on the image receiving member 7. Moreover, the portion where the toner 3 is fused acts as a local resistance in the sliding movement against the toner layer 3a on the toner holder 10, whereby even more toner 3 is fused and the protrusion on the spacer member 22 grows, thus gradually enlarging the streak on the image.

If the recording operation is further continued over a long period of time, the number of such protrusions gradually increases while the size of each protrusion also increases, finally resulting in a state where the toner 3 is fused and accumulated in a planar shape over a certain area, though such an area is partial. If the amount of toner 3 accumulated varies in the direction parallel to the row of toner passage holes 14 (the primary scanning direction), it will not only scratch the surface of the opposing toner layer 3a, but also cause variations in the interval (head interval) between the toner passage control device 4 and the toner layer 3a in the primary scanning direction, thereby causing variations in the recording characteristics, which in turn cause a strip-shaped density nonuniformity parallel to the secondary scanning direction in the recorded image formed on the image receiving member 7.

On the other hand, no contact pressure is applied on a portion of the upper surface of the spacer member 22 that is in the vicinity of the contact area 22a and on the upstream side in the direction in which the toner holder 10 moves with respect to the contact area 22a because the portion is spaced apart from the toner layer 3a in a recording operation. However, if the toner 3 is accidentally fused on the portion, it in many cases remains unremoved on the upper surface of the spacer member 22 even if the adhesion force thereof is small. Then, the toner 3 further accumulates with the fused toner 3 being a nucleus, and when the tip thereof contacts the toner layer 3a, it scratches the toner layer 3a, thereby causing an image non-uniformity.

In order to prevent such a problem from occurring, the example above employs the configuration as described above. Specifically, first, the spacer member 22 is electrically grounded, thereby preventing the toner 3 from being newly charged by the sliding movement between the spacer member 22 and the toner layer 3a, and thus preventing the toner 3 from electrostatically attaching to the upper surface of the spacer member 22. Moreover, the surface roughness of the upper surface of the spacer member 22 is set to be 3.2 Z in the contact area 22a, thereby reducing the holding force of the toner 3 fused on the upper surface of the spacer member 22. Therefore, the fused toner 3 is easily removed by the sliding movement between the spacer member 22 and the toner layer 3a, thereby preventing the toner 3 from gradually accumulating with the fused toner 3 being a nucleus. Moreover, in a portion of the upper surface of the spacer member 22 other than the contact area 22a, no contact pressure is applied, whereby the adhesion force of the fused toner 3 is small, and thus the toner 3 is removed even with a surface roughness of about 6.3 Z., thus preventing the toner 3 from gradually accumulating with the fused toner 3 being a nucleus. Therefore, the toner 3 will not accumulate on the spacer member 22 in a long-term use, whereby it is possible to prevent a streak on the recorded image due to a scratch in the toner layer 3a.

Furthermore, in the example above, the spacer member 22 employs a stainless steel strip for springs with a tempering symbol “H” (SUS 301-CSP-H), whereby it is possible to obtain a hardness Hv of 430. Therefore, when the thin spacer member 22 (thickness: 10 μm) is bonded on the toner passage control device 4, the spacer member 22 is prevented from being plastically deformed to lower its smoothness due to a misoperation, etc. As a result, it is possible to prevent problems such as a scratch in the toner layer 3a or an image non-uniformity. Moreover, the work efficiency of the assembly operation can be significantly improved. Furthermore, it is possible to prevent the spacer member 22 from wearing off by the sliding movement between the toner layer 3a and the toner passage control device 4.

Note that while the spacer member 22 is a sheet made of a stainless steel strip for springs and having a thickness of 10 μm in the example above, a sheet made of a conductive resin may alternatively be used as described above.

Moreover, the spacer member 22 and the toner passage control device 4 are separate, individual components in the example above. Alternatively, the spacer member 22 and the toner passage control device 4 may be integrated together with the spacer member 22 being formed on the toner passage control device 4. Alternatively, a portion of the toner passage control device 4 in the vicinity of the opening of the toner passage hole 14 may directly contact the toner layer 3a without the upper surface of the toner passage control device 4 being partially raised (where the portion of the toner passage control device 4 in the vicinity of the opening of the toner passage hole 14 forms the spacer member 22). It is needless to say that, in either case, the present invention can be easily carried out, and functions/effects as those of the example above can be obtained.

### EXAMPLE 2

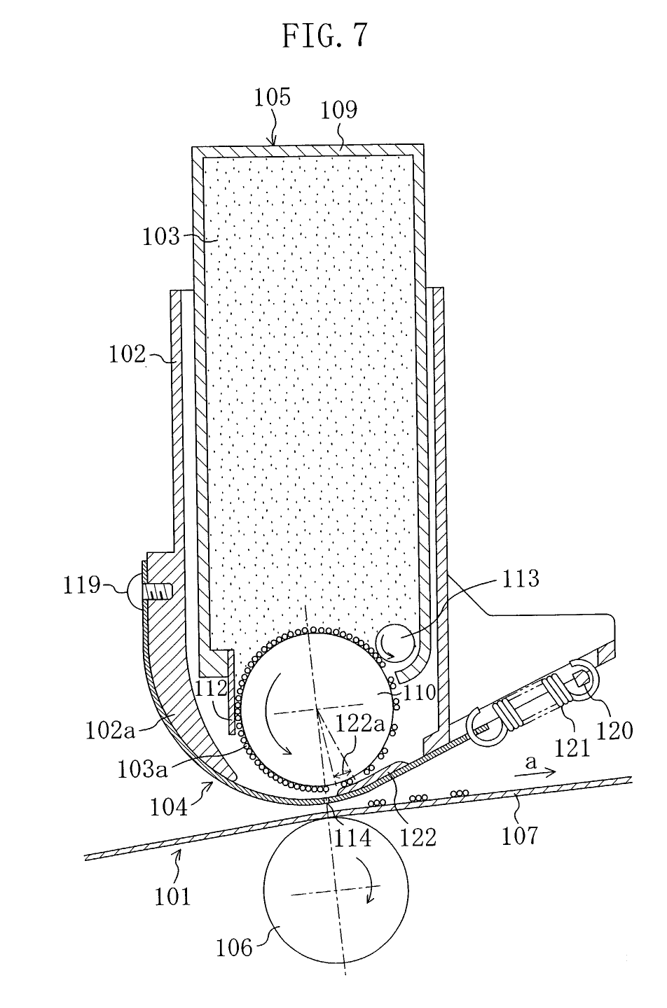

FIG. 7 schematically illustrates a toner passage control device and an image forming device according to Example 2 of the present invention. In the figure, reference numeral 101 is a print head, and the print head 101 includes a casing member 102 that is open on the upper side and has an opening in the bottom portion, a toner passage control device 104 arranged on the outer surface of a lower portion of the casing member 102 so as to cover the opening, and a toner supply unit 105 placed in the casing member 102. A counter electrode 106 is arranged below the print head 101 with an appropriate gap therebetween, and an image receiving member 107 such as recording paper is passed through between the counter electrode 106 and the print head 101.

The toner supply unit 105 includes a storage container 109 for storing a toner 103, which is a developer, a toner holder 110 arranged so as to meet an opening that is formed in a lower portion of the storage container 109, a limiting blade 112 for limiting a toner layer 103a held and carried by the toner holder 110, and a supply roller 113 for stirring and frictionally charging the toner 103 in the storage container 109 while supplying the toner 103 to the toner holder 110. The toner supply unit 105 is inserted into the casing member 102 vertically and downwardly in the figure and is set at a predetermined position in the casing member 102.

The toner holder 110 is formed in a generally cylindrical shape by using a metal such as aluminum or iron or an alloy, and rotates in the counterclockwise direction in FIG. 7 about the central axis thereof (moves from left to right in FIG. 7), thereby carrying the toner layer 103a to the toner carrying position in the lower portion (a position opposing a toner passage hole 114 to be described later). In the present example, the toner holder 110 is a rotatable sleeve made of aluminum having an outer diameter of 20 mm and a thickness of 1 mm, and the potential thereof is the ground potential.

The limiting blade 112 is made of an elastic member such as a urethane, and suitably has a hardness of 40 to 80 degrees (JIS K6301 A Scale), a free end length (the length of a portion thereof extending from the position where it is attached) of 5 to 15 mm, and a linear load on the toner holder 110 of 5 to 40 N/m. One to three toner layers 103aare formed on the toner holder 110 by the limiting blade 112. Note that in the present example, the limiting blade 112 is electrically floating.

The toner 103 is interposed between the toner holder 110 and the limiting blade 112, where it is subject to slight stirring and is charged by receiving a charge from the toner holder 110. In the present example, the toner 103 is a non-magnetic material having an average particle diameter of 8 μm, and has a negative charge of −10 μC/g.

The supply roller 113 is obtained by providing a synthetic rubber such as a urethane foam having a thickness of about 2 to 6 mm on a shaft made of a metal such as iron (having a diameter of 8 mm in the present example), so that the hardness thereof is 30 degrees (as measured by the method of JIS K6301 A Scale using a sample that has been processed into a roller shape). In addition to assisting in charging the toner 103, it controls the supply of the toner 103 to the toner holder 110. The amount by which the supply roller 113 is pushed into the toner holder 110 is preferably about 0.1 to 2 mm.

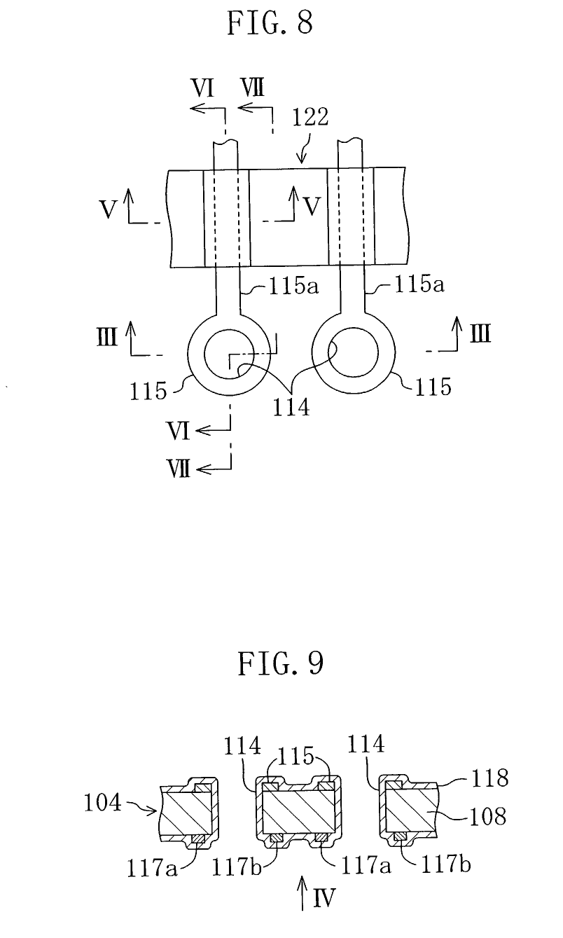

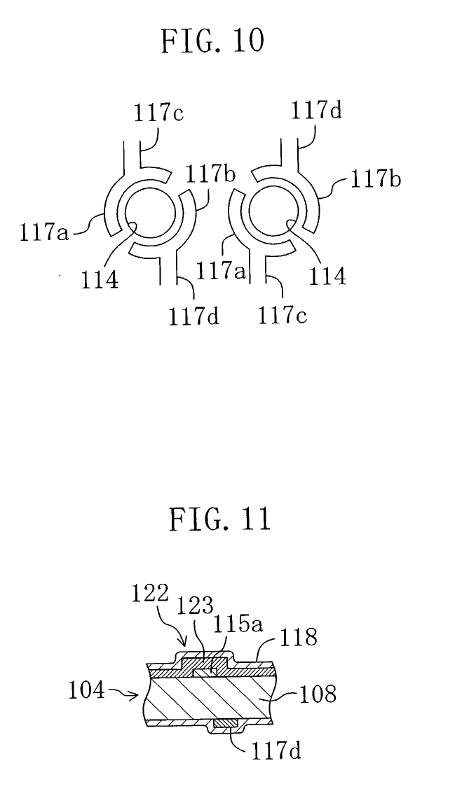

The toner passage control device 104 includes, as a base member, a flexible insulative member 108 having a thickness of about 50 μm and an effective width that corresponds to the effective width of the toner holder 110. The insulative member 108 is provided with a large number of toner passage holes 114 arranged at a minute pitch in the width direction of the image receiving member 107 (the direction of the central axis of the toner holder 110: the direction perpendicular to the sheet of FIG. 7), whereby one or more rows of toner passage holes 114 are formed, each row including the toner passage holes 114 arranged in the direction perpendicular to the direction in which the toner holder 110 moves. A ring-shaped control electrode 115 (see FIG. 8 and FIG. 9) is formed on the upper surface of the insulative member 108 along the entire periphery (or a portion thereof) of each of the toner passage holes 114 so as to surround the toner passage hole 114, and deflection electrodes 117a and 117b (see FIG. 9 and FIG. 10) are formed on the lower surface of the insulative member 108. The insulative member 108 is preferably made of a material such as polyimide or polyethylene terephthalate, and suitably has a thickness of 10 to 100 μm. In the present example, polyimide having a thickness of 50 μm is used as the insulative member 108.

FIG. 8 to FIG. 10 illustrate, on an enlarged scale, a portion of the toner passage control device 104 around the toner passage hole 114. As described above, the toner passage control device 104 includes the toner passage holes 114 provided in the insulative member 108 thereof and arranged in a row at a predetermined pitch in the central axis direction of the toner holder 110 (the direction perpendicular to the direction in which the toner holder 110 moves). In the present example, the pitch of the toner passage holes 114 is 125 μm, corresponding to 200 dpi, for a recording resolution of 600 dpi.

Moreover, the control electrode 115 is arranged on the upper surface of the insulative member 108 so as to surround the periphery of each toner passage hole 114, and a tip portion of a wire portion 115a extending from the control electrode 115 is connected to an IC chip (not shown) for applying an image signal to the control electrode 115. On the other hand, the pair of deflection electrodes 117a and 117b are arranged on the lower surface of the insulative member 108 so as to surround the toner passage hole 114 from opposite sides. As the control electrode 115, the deflection electrodes 117a and 117b are also provided with wire portions 117c and 117d, respectively, that are connected to the IC chip. The electrodes 115, 117a and 117b are made of a Cu film having a thickness of about 8 to 20 μm, which is patterned on the insulative member 108, and the surface of the toner passage control device 104 is coated with an insulative film 118 of 5 to 30 μm so as to prevent these electrodes 115S 117a and 117b from being shorted with one another.

While the shape of the toner passage hole 114 is a circular shape in FIG. 8 and FIG. 10, it may alternatively be another shape such as an oblong circle shape or an elliptical shape, and the size thereof is set so that the diameter is about 70 to 120 μm.

Note that a voltage of 400 V or less is normally applied to the control electrode 115 for forming dots. In the present example, a voltage of 250 V is applied for forming dots and a voltage of −50 V for not forming dots.

As illustrated in FIG. 7, the toner passage control device 104 is attached and fixed to the casing member 102 by a screw 119, as attachment means, at an end portion thereof that is on the upstream side in the direction in which the toner holder 110 moves with respect to the toner passage hole 114 (an end portion opposite to the side to which the toner holder 110 moves: “moving direction rear end portion”), and an end portion that is on the downstream side in the direction in which the toner holder 110 moves (an end portion on the side to which the toner holder 110 moves: “moving direction front end portion”) is attached to an attachment portion 120 protruding from the casing member 102 via a tension spring 121 (of course, the attachment positions of the opposite end portions of the toner passage control device 104 may be reversed from those described above). A portion of the toner passage control device 104 between the end portion on the upstream side in the direction in which the toner holder 110 moves and the toner passage hole 114 is wound around a stay portion 102a (a bent portion) that is formed in the casing member 102 and having a curvature smaller than that of the outer perimeter of the toner holder 110, and is bent along the stay portion 102a. The contact pressure between the toner holder 110 and the toner passage control device 104 caused by the tension spring 121 (the toner holder 110 and the toner passage control device 104 contact each other via a spacer member 122 as will be described later) is suitably 2 to 20 kPa. This is because the toner holder 110 and the toner passage control device 104 need to be always in contact with each other under the same condition, following the eccentricity of the rotation axis of the toner holder 110, in order to maintain the interval between the toner holder 110 and the toner passage control device 104 at the position of the toner passage hole 114 to be substantially constant, and an excessive contact pressure deforms the toner layer 103a on the toner holder 110. Note that the contact pressure slightly varies depending on the material of the toner holder 110 and the toner passage control device 104, etc.

Reference numeral 122 is a spacer member that is formed on the surface (upper surface) of the toner passage control device 104 that opposes the toner holder 1. The upper surface of the spacer member 122 contacts the surface of the toner layer 103a on the toner holder 110 in a contact area 122a, whereby the interval (head interval) between the surface of the toner layer 103a on the toner holder 110 and the opening, on the side of the toner holder 110, of the toner passage hole 114 in the toner passage control device 104 is maintained at a constant interval that is substantially the same as the thickness of the spacer member 122 itself The spacer member 122 contacts the surface of the toner layer 103a on the downstream side in the direction in which the toner holder 110 moves with respect to the toner passage hole 114, and does not contact the surface of the toner layer 103a on the upstream side in the direction in which the toner holder 110 moves with respect to the toner passage hole 114. Thus, the spacer member 122 is provided between the toner holder 110 and the toner passage control device 104 at a position that is on the downstream side in the direction in which the toner holder 110 moves with respect to the toner passage hole 114.

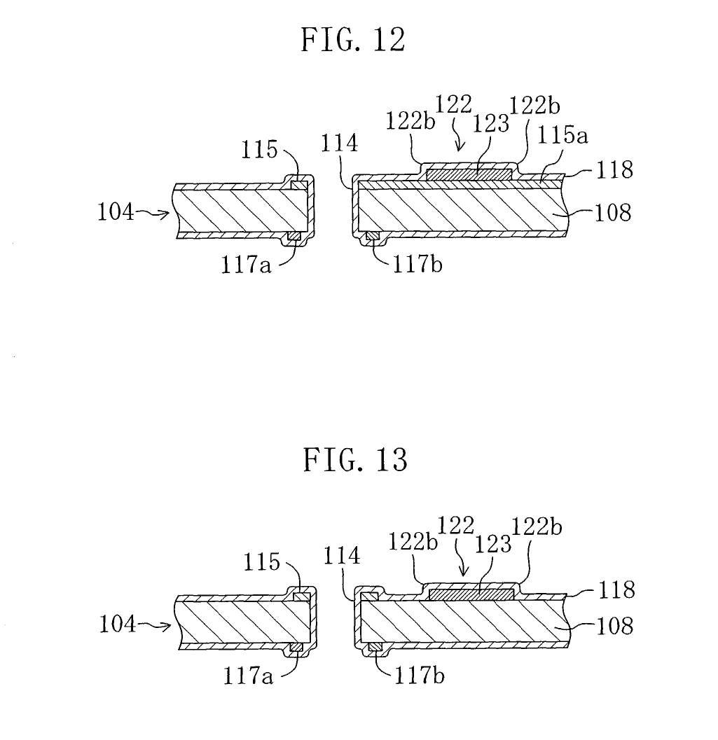

The spacer member 122 will be described in greater detail with reference to FIG. 8 and FIG. 11 to FIG. 13. Reference numeral 123 is a spacer film that is obtained by forming a film made of an insulative material on the insulative member 108 or the control electrode 115 through vapor deposition by a thin film process such as sputtering or chemical vapor deposition (CVD). The thickness of the spacer film 123 is preferably 5 to 150 μm, more preferably 5 to 20 μm, and it is set to be 10 μm in the present example. The vapor deposition of the spacer film 123 is performed with a uniform thickness on the insulative member 108 or the control electrode 115, whereby the surface (upper surface) of the spacer film 123 includes irregularities running in the primary scanning direction (the direction parallel to the rows of toner passage holes 114) and having a height that corresponds to the thickness of the control electrode 115.

The material of the spacer film 123 is preferably a polyparaxylene resin (parylene), and in the present example, it is formed through a coating process by chemical vapor deposition (CVD). Specifically, the spacer film 123 is formed by chemical vapor deposition after masking, in advance, portions where the spacer film 123 is not to be formed, e.g., portions that are to be the toner passage holes 114.

While the surface of the toner passage control device 104 is coated with an insulative film 118 of 5 to 30 μm so as to prevent the control electrode 115 and the deflection electrodes 117a and 117b from being shorted with one another, as described above with reference to FIG. 8 to FIG. 10, the insulative film 118 serves also as a protection layer covering the spacer film 123. The material of the insulative film 118 may be the same as, or different from, that of the spacer film 123. In the present example, it is formed through a coating process by chemical vapor deposition (CVD) using a polyparaxylene resin (parylene). By covering the spacer film 123 with the insulative film 118 formed through a coating process, the ridge portion of the spacer film 123 at each end in the direction in which the toner holder 110 moves (the corner portion in the spacer member 122 between the toner layer contact surface and the end portion on the upstream side in the direction in which the toner holder 110 moves) has a shape with a small curved surface portion 122b on the surface of the insulative film 118. Therefore, the end portion on the upstream side in the direction in which the toner holder 110 moves on the surface (upper surface) of the spacer member 122 that is in contact with the toner layer 103a is inclined away from the toner layer 103a in the direction toward the upstream side. Note that since the coating process of the insulative film 118 is also performed with a uniform thickness, the surface of the portion of the insulative film 118 corresponding to the spacer member 122 (i.e., the surface of the spacer member 122) also has irregularities running in the primary scanning direction and having a height that corresponds to the thickness of the control electrode 115.

Moreover, the surface of the insulative film 118 is subjected to a surface treatment using an antistatic material and electrically grounded. The surface treatment using an antistatic material is preferably performed by coating the surface with a boron-based antistatic polymer, and the coating thickness is preferably 5 to 10 μm. Moreover, the surface resistance value of the antistatic material is preferably 10¹⁰ Ω (Ω/□) or less, and more preferably 10⁷ to 10³ Ω.

Furthermore, the surface roughness Rz (ten-point average roughness based on JIS BO0601 with a reference length of 0.8 mm) of the spacer member 122 is preferably 2 to 8 μm, and the surface roughness Rz of the entire toner passage control device 104 is set to be 6.3 Z (6.3 μm or less) in the present example.

When the toner supply unit 105 is attached to the casing member 102, with the distance between the toner holder 110 and the counter electrode 106 being maintained at a predetermined dimension, the toner layer 103a formed on the peripheral surface of the toner holder 110 is in contact with the spacer member 122. The toner passage control device 104 is wound around the outer perimeter of the bent portion 102a of the casing member 102, and then elastically held by the casing member 102 via the tension spring 121 that is suspended at the end on the downstream side in the direction in which the toner holder 110 moves. In such a state, the tension spring 121 is displaced, resisting against the pressing force from the toner holder 110 to the spacer member 122. Thus, the toner passage control device 104, across the entire width thereof, is in close contact with the surface of the toner layer 103a on the toner holder 110 via the spacer member 122. The interval (head interval) between the toner layer 103a on the toner holder 110 and the opening, on the side of the toner holder 110, of the toner passage hole 114 in the toner passage control device 104 is precisely maintained by the spacer member 122 at a value in the range of 0 to 200 μm, and 10 μm in the present example. The tension on the toner passage control device 104 caused by the tension spring 121 is a value that is appropriately set so as to obtain an appropriate contact pressure (2 to 20 kPa) between the toner holder 110 and the toner passage control device 104 as described above, and is relatively small for the rigidity of the toner passage control device 104 itself

The present example employs a configuration in which the toner passage control device 104 is contacted with the toner layer 103a on the toner holder 110 via the spacer member 122, as described above, whereby even if the toner holder 110 has outer diameter variations, a cylindricity non-uniformity, a radial runout, etc., the toner passage control device 104 moves in the vertical direction along the peripheral surface of the toner holder 110, whereby such variations can be absorbed. In this way, the head interval at the position of the row of toner passage holes 114 is maintained at a constant value that is substantially the same as the thickness of the spacer member 122, thereby preventing the recording characteristics from varying.

The counter electrode 106 is arranged so as to oppose the toner carrying position of the toner holder 110 with the toner passage control device 104 being interposed between the counter electrode 106 and the toner holder 110, and the counter electrode 106 is obtained by dispersing a conductive filler in a metal or a resin. A voltage for forming, between the counter electrode 106 and the toner holder 110, a transfer electrostatic field that sucks the toner 103 of the toner layer 103a on the toner holder 110 is applied to the counter electrode 106. Specifically, a DC voltage of about 500 to 2000 V is applied, and a voltage of 1000 V is applied in the present example. Moreover, the distance between the counter electrode 106 and the toner holder 110 is preferably 150 to 1000 μm, and is set to be 350 μm in the present example. The image receiving member 107 such as recording paper is placed between the counter electrode 106 and the print head 101, and the image receiving member 107 is passed through therebetween by being carried in the direction of arrow “a” along a predetermined path extending between the counter electrode 106 and the toner passage control device 104.

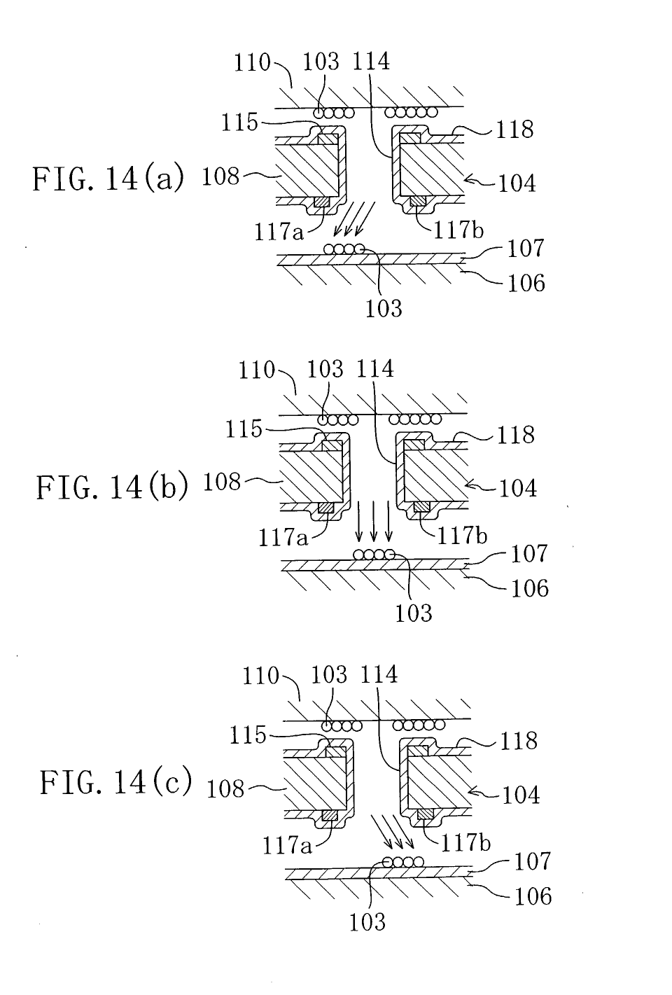

An image forming operation with such a configuration will be described with reference to FIG. 14. First, as illustrated in FIG. 14(a), the toner 103 of the toner layer 103a held by the toner holder 110 is allowed to fly by applying a voltage of 250 V to the control electrode 115 with +150 V being applied to the left deflection electrode 117a and −150 V being applied to the right deflection electrode 117b so that the negatively charged toner 103 is deflected to the left. Then, the toner 103 is pulled by the electric field formed by the counter electrode 106 to pass through the toner passage hole 114, and flies while being deflected to the left so as to attach to the image receiving member 107 at a position that is displaced by about 40 μm to the left from the position opposing the toner passage hole 114.

Then, as illustrated in FIG. 14(b), a voltage is applied to the control electrode 115 as described above with the left and right deflection electrodes 117a and 117b being brought to 0 V, whereby the toner 103 flies straight along the axis direction of the toner passage hole 114 without being deflected so as to attach to the image receiving member 107 at the position opposing the toner passage hole 114.

Next, as illustrated in FIG. 14(c), a voltage is applied to the control electrode 115 as described above with −150 V being applied to the left deflection electrode 117a and +150 V being applied to the right deflection electrode 117b so that the negatively charged toner 103 is deflected to the right, whereby the toner 103 flies while being deflected to the right so as to attach to the image receiving member 107 at a position that is displaced by about 40 μm to the right from the position opposing the toner passage hole 114. In this way, the toner 103 can be made to attach to three points, i.e., the left, right and center points, with a single toner passage hole 114, by successively changing the voltages applied to the control electrode 115 and the deflection electrodes 117a and 117b. Note that during a non-image forming period, the voltage applied to the control electrode 115 is set to be −50 V so that the toner 103 does not fly.

Thus, in the example above, the spacer member 122 is provided on the downstream side in the direction in which the toner holder 110 moves with respect to the toner passage hole 114 so that on the upstream side, the toner layer 103a, which is regulated in a layer by the limiting blade 112, is supplied directly to the toner passage hole 114 without contacting anything. Therefore, even if there are minute irregularities or protrusions on the surface of the spacer member 122 that is in contact with the toner layer 103a, thereby scratching the toner layer 103a in contact with the irregularities or protrusions, the toner layer 103a has already supplied the toner 103 to the toner passage hole 114 (the toner layer 103a is scratched after passing the position opposing the toner passage hole 114, and the toner layer 103a is not scratched at the position opposing the toner passage hole 114), whereby a disturbance in the toner layer due to such a scratch is prevented from being transferred onto the recorded image to cause a minute streak in the recorded image. Moreover, the scratch occurring in the toner layer 103a after it passes the position opposing the toner passage hole 114 is further moved along with the rotation of the toner holder 110, and is recovered to the original state by the supply roller 113 or the limiting blade 112 so that it will not influence the subsequent recording operations.

Thus, very stringent requirements in the surface roughness or flatness are not imposed on the spacer member 122, thereby reducing the component cost. Moreover, the manufacturing step of forming the spacer member 122 does not require a very careful operation for the formation and handling of the spacer member 122, thereby reducing the number of assembly steps in mass production, and reducing the frequency of occurrence of a misoperation or a defective.

Moreover, when a recording operation is performed continuously over a long period of time, toner particles may accidentally attach to the surface of the spacer member 122 that is in contact with the toner layer 103a, and the toner 103 gradually accumulates with an attached toner particle being a nucleus, thereby forming a protrusion in an area of the surface of the spacer member 122 that is in contact with the toner layer 103a where the toner 103 has been fused. Even in such a case, since the toner layer 103a scratched by such a protrusion has already supplied the toner 103 to the toner passage hole 114, as described above, the disturbance in the toner layer 103a due to the protrusion is prevented from being transferred onto the recorded image to cause a minute streak in the recorded image. As a result, it is possible to prevent the reliability from lowering.

Furthermore, the spacer member 122 of the example above includes the spacer film 123 and the insulative film 118, wherein the spacer film 123 is obtained by forming a film made of an insulative material on the insulative member 108 or the control electrode 115 of the toner passage control device 104 through vapor deposition by a thin film process such as sputtering or chemical vapor deposition (CVD), after which it is coated with the insulative film 118 by chemical vapor deposition (CVD), or the like. Therefore, the ridge portion of the spacer member 122 at each end in the direction in which the toner holder 110 moves (particularly at the end on the upstream side) has a shape with the curved surface portion 122b on the surface of the insulative film 118. Thus, the toner layer 103a is prevented from being scratched off by the ridge portion of the spacer member 122 when the toner layer 103a enters the area of the spacer member 122, and thus the toner 103, which has been scratched off, will not accumulate in the space between the toner passage control device 104 and the toner holder 110, whereby it is possible to suppress a so-called “fogging phenomenon” in which the toner 103 is ejected from the toner passage hole 114 during a non-image forming period.

Moreover, by forming the spacer film 123 through vapor deposition, the spacer member 122, which is as thin as about 10 μm, can be easily and stably formed, as compared to a method in which a metal sheet, or the like, which has been cut to a predetermined size is attached to the surface of the toner passage control device 104.

Moreover, in a method in which the spacer member 122 having a thickness of about 10 μm to which flatness, etc., is required is attached to the toner passage control device 104, the spacer member 122 is easily deformed in the assembly operation. However, there is no such problem, and it is possible to further reduce the number of assembly steps in mass production and to further reduce the frequency of occurrence of a misoperation or a defective.

Furthermore, the vapor deposition of the spacer film 123 is performed with a uniform thickness on the insulative member 108 or the control electrode 115, whereby the surface of the spacer film 123 includes irregularities running in the primary scanning direction and having a height that corresponds to the thickness of the control electrode 115.

Similarly, since the coating process of the insulative film 118 is also performed with a uniform thickness, the surface of the portion of the insulative film 118 corresponding to the spacer member 122 also has irregularities running in the primary scanning direction and having a height that corresponds to the thickness of the control electrode 115. However, with which the spacer member 122 is to contact is the toner layer 103a that has already supplied the toner 103 to the toner passage hole 114, as described above, whereby a disturbance in the toner layer 103a occurring due to the contact with the irregularities will not be transferred onto the recorded image to cause a minute streak in the recorded image.

Specifically, when the spacer member 122 is formed through vapor deposition, or the like, there is a problem that the irregularities of an underlying layer, e.g., an electrode, appear on the surface thereof However, such a problem can be eliminated by arranging the spacer member 122 on the downstream side in the direction in which the toner holder 110 moves with respect to the toner passage hole 114.

Moreover, in the example above, the surface of the insulative film 118 is subjected to a surface treatment using an antistatic material made of a boron-based antistatic polymer, and is electrically grounded, thereby preventing the toner 103 from being excessively charged by the sliding movement between the surface of the spacer member 122 and the toner layer 103a, and preventing the toner 103 from electrostatically attaching to the surface of the spacer member 122. Moreover, even if excessive charging occurs, what is newly charged by the sliding movement against the spacer member 122 is the toner layer 103a, which has already supplied the toner 103 to the toner passage hole 114, and it will not influence the flight characteristics of the toner 103 through the toner passage hole 114 to cause the image density, the pixel forming position, etc., to vary.

Therefore, the level of antistatic performance required for the spacer member 122 may be low as long as it is possible to prevent the toner 103 from electrostatically attaching to the surface of the spacer member 122, and may be lower than that in a case where the spacer member 122 is contacted with the toner layer 103a on the upstream side in the direction in which the toner holder 110 moves with respect to the toner passage hole 114. Thus, the surface resistance value may be about 10⁷ to 10⁸ Ω.

Furthermore, in the example above, the surface roughness Rz of the spacer member 122 is set to be 6.3 Z, whereby it is possible to prevent the toner 103 from attaching to the surface of the spacer member 122 in a long-term use. In a case where the surface roughness of the spacer member 122 is about 12.5 Z, if a recording operation is performed continuously over a long period of time, the toner 103 is accidentally fused on the surface of the spacer member 122 and gradually accumulates with the fused toner 103 being a nucleus, whereby the portion of the surface of the spacer member 122 on which the toner 103 is fused forms a protrusion. Moreover, if the recording operation is further continued over a long period of time, the number of such protrusions gradually increases while the size of each protrusion also increases, finally resulting in a state where the toner 103 is fused and accumulated in a planar shape over a certain area, though such an area is partial. If the amount of toner 103 accumulated varies in the direction parallel to the row of toner passage holes 114 (the primary scanning direction), it will cause variations in the interval (head interval) between the toner passage control device 104 and the toner layer 103a in the primary scanning direction, thereby causing variations in the recording characteristics, which in turn cause a strip-shaped density non-uniformity parallel to the secondary scanning direction in the recorded image formed on the image receiving member 107.

In contrast, by setting the surface roughness Rz of the spacer member 122 to be about 6.3 Z, the adhesion force of the fused toner 103 is reduced so that the fused toner 103 is easily removed by the sliding movement against the toner layer 103a, thereby preventing the toner 103 from gradually accumulating with the fused toner 103 being a nucleus. Therefore, it is possible to prevent a density non-uniformity on the recorded image from occurring due to variations in the head interval in a long-term use.

Note that while the spacer member 122 and the toner passage control device 104 are integrated together in the example above, the spacer member 122 and the toner passage control device 104 may be separate and individual members that are attached to each other. Alternatively, a portion of the toner passage control device 104 in the vicinity of the opening of the toner passage hole 114 may directly contact the toner layer 103a without the upper surface of the toner passage control device 104 being partially raised (where the portion of the toner passage control device 104 in the vicinity of the opening of the toner passage hole 1014 forms the spacer member 122). Also in such cases, the present invention can be carried out, and functions/effects as those of the example above can be obtained.

Moreover, while the spacer member 122 is formed by covering the spacer film 123 on the insulative member 108 with the insulative film 118, the spacer film 123 may alternatively be formed through vapor deposition, or the like, on the surface of the insulative film 118. In such a case, by selecting a conductive material for the spacer film 123, the surface treatment using an antistatic material can be omitted, whereby it is possible to reduce the cost.

Furthermore, the end portion on the upstream side in the direction in which the toner holder 110 moves on the surface of the spacer member 122 that is in contact with the toner layer 103a is inclined by the curved surface portion 122b away from the toner layer 103a in the direction toward the upstream side. Alternatively, it may be inclined by providing a flat surface portion (slope portion) away from the toner layer 103a in the direction toward the upstream side.

### EXAMPLE 3

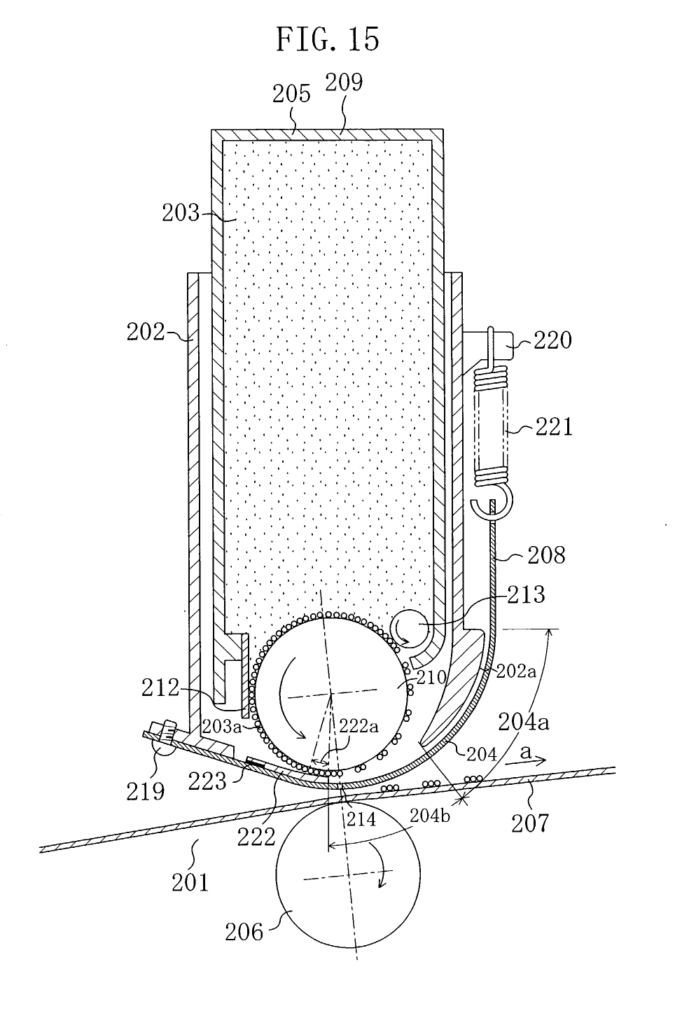

Example 3 of the image forming device of the present invention will be described with reference to FIG. 15 to FIG. 18. In FIG. 15 illustrating a general configuration of the image forming device, reference numeral 201 is a print head, and the print head 201 includes a casing member 202 that is open on the upper side and has an opening in the bottom portion, toner passage control means 204 arranged on the outer surface of a lower portion of the casing member 202 so as to cover the opening, and a toner supply unit 205 placed in the casing member 202. A back electrode 206 is arranged below the print head 201 with an appropriate gap therebetween, and an image receiving member 207 such as recording paper is passed through between the back electrode 206 and the print head 201.

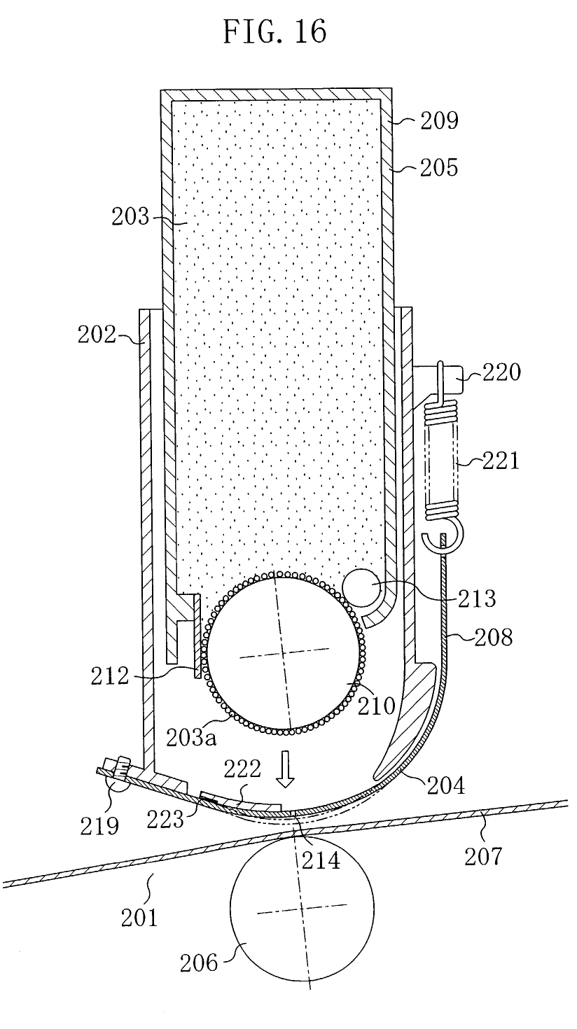

The toner supply unit 205 includes a storage container 209 for storing a toner 203, which is a developer, a toner holder 210 arranged so as to meet an opening that is formed in a lower portion of the storage container 209, a limiting blade 212 for limiting a toner layer 203a held and carried by the toner holder 210, and a supply roller 213 for stirring and frictionally charging the toner 203 in the storage container 209 while supplying the toner 203 to the toner holder 210. As illustrated in FIG. 16, the toner supply unit 205 is inserted into the casing member 202 horizontally from right to left in the figure and is set at a predetermined position in the casing member 202.

The toner holder 210 is formed by using a metal such as aluminum or iron or an alloy. In the present example, the toner holder 210 is a rotatable sleeve made of aluminum having an outer diameter of 20 mm and a thickness of 1 mm, and the potential thereof is the ground potential.

The limiting blade 212 is made of an elastic member such as a urethane, and suitably has a hardness of 40 to 80 degrees (JIS K6301 A Scale), a free end length (the length of a portion thereof extending from the position where it is attached) of 5 to 15 mm, and a linear load on the toner holder 210 of 5 to 40 g/cm, for forming one to three layers of toner 203 on the toner holder 210. The limiting blade 212 is electrically floating in the present example.

The toner 203 is interposed between the toner holder 210 and the limiting blade 212, where it is subject to slight stirring and is charged by receiving a charge from the toner holder 210. In the present example, the toner 203 is a non-magnetic material having an average particle diameter of 8 μm, and has a negative charge of −10 μC/g.

The supply roller 213 is obtained by providing a synthetic rubber such as a urethane foam having a thickness of about 2 to 6 mm on a shaft made of a metal such as iron (having a diameter of 8 mm in the present example), so that the hardness thereof is 30 degrees (as measured by the method of JIS K6301 A Scale using a sample that has been processed into a roller shape). In addition to assisting in charging the toner 203, it controls the supply thereof The amount by which it is pushed into the toner holder 210 is preferably about 0.1 to 2 mm.

Reference numeral 204 is toner passage control means including a flexible insulative base member 208 having an effective width that corresponds to the effective width of the toner holder 210. The insulative base member 208 is provided with a large number of toner passage holes 214 arranged at a minute pitch in the width direction of the image receiving means 207, whereby one or more rows of toner passage holes 214 are formed. A ring-shaped control electrode (not shown) is formed so as to surround each toner passage hole 214, and deflection electrodes (not shown) are formed on the lower surface of the insulative base member 208. The insulative base member 208 is preferably made of a material such as polyimide or polyethylene terephthalate, and suitably has a thickness of 10 to 100 μm. In the present example, polyimide having a thickness of 50 μm is used as the insulative base member 208.

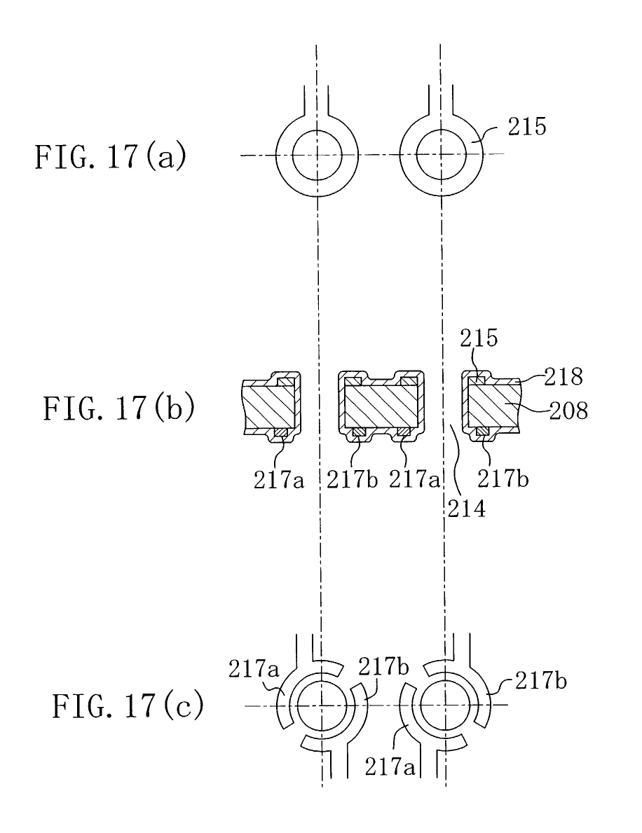

FIG. 17 is an enlarged view illustrating an electrode portion of the toner passage control means 204. In the toner passage control means 204, a row of toner passage holes 214 is arranged in parallel to the toner holder 210, as described above. Moreover, a control electrode 215 is arranged on the upper surface of the insulative substrate 208 having a thickness of about 50 i m so as to surround the periphery of each toner passage hole 214, and an IC chip (not shown) for applying an image signal is connected to a lead electrode extending from the control electrode. A pair of deflection electrodes 217a and 217b are arranged on the lower surface of the insulative substrate 208 so as to surround the toner passage hole 214 from opposite sides. The electrodes 215, 217a and 217b are made of a Cu film having a thickness of about 8 to 20 μm, which is patterned on the insulative substrate 208. The surface of the toner passage control means 204 is coated with an insulative film 218 of 5 to 30 μm so as to prevent these electrodes from being shorted with one another. While the shape of the toner passage hole 214 is a circular shape in the figure, it may alternatively be another shape such as an oblong circle shape or an elliptical shape. The size thereof is set so that the diameter is about 70 to 120 μm. Note that a voltage of 400 V or less is normally applied to the control electrode 215, and in the present example, a voltage of 250 V is applied for forming dots and a voltage of −50 V for not forming dots.

The toner passage control means 204 is fixed to the casing member 202 by attachment means 219 at a position on the upstream side in the toner holder moving direction with respect to the point where it contacts the toner holder 210, and it is fixed via attachment means 220 and a tension spring 221 on the downstream side. Of course, the upstream side and the downstream side may be reversed. The contact pressure between the toner holder 210 and the toner passage control means 204 caused by the tension spring 221 is suitably 0.2 to 2 gf/mm². This is because the toner holder 210 and the toner passage control means 204 need to be always in contact with each other under the same condition, following the eccentricity of the rotation axis of the toner holder 210, in order to maintain the interval between the toner holder 210 and the toner passage control means 204 at the position of the toner passage hole 214 to be always constant, and because it is necessary to ensure that the toner layer on the toner holder 210 is not deformed by an excessive contact pressure. The contact pressure slightly varies depending on the material of the toner holder 210 and the toner passage control means 204, etc.

Reference numeral 222 is a spacer that is bonded and fixed by an adhesive layer 223 on the surface of the toner passage control means 204 opposing the toner holder 210, and the spacer 222 contacts the toner holder 210 in a contact area 222a, thereby limiting the interval (head interval) between the toner holder 210 and the toner passage control means 204 to the thickness of the spacer 222 itself. The spacer 222 is a sheet made of a metal or a conductive resin, and the thickness thereof is preferably 5 to 150 μm, and more preferably 5 to 20 μm. Moreover, the adhesive layer 223 is preferably a resin-based or rubber-based adhesive or a double-sided adhesive tape, and the thickness thereof is preferably 2 to 120 μm, and more preferably 2 to 5 μm.

When the toner supply unit 205 is attached to the casing member 202, with the distance between the toner holder 210 and the back electrode 206 being limited to a predetermined dimension, the toner layer 203a formed on the peripheral surface of the toner holder 210 abuts on the spacer 222. The toner passage control means 204 is located at the left end of the casing member 202, wound around the outer perimeter of a bent portion 202a, which has a curvature smaller than that of the outer perimeter of the toner holder 210, and then elastically held by the casing member 202 via the tension spring 221 that is suspended at the end on the downstream side. In such a state, the tension spring 221 is displaced, resisting against the pressing force from the toner holder 210 to the spacer 211. Thus, the toner passage control means 204, across the entire width thereof, is in close contact with the toner holder 210 via the spacer 222. The distance (head interval) between the toner layer 203a on the toner holder 210 and the toner passage control means 204 is precisely maintained by the spacer 222 at a value in the range of 0 to 200 μm, and 10 μm in the present example. The tension on the toner passage control means 204 caused by the tension spring 221 is a value that is appropriately set so as to obtain an appropriate contact pressure (0.2 to 2 gf/mm²) between the toner holder 210 and the toner passage control means 204 as described above, and is relatively small for the rigidity of the toner passage control means 204 itself

The toner passage control means 204 is flat in a separated state where no tension is being applied by the tension spring 221. However, when it is attached to the casing member 202, it is wound around the bent portion 202a of the casing member 202, as described above, whereby the toner passage control means 204 has a curvature equal to that of the bent portion 202a, which has a curvature that is smaller than that of the outer perimeter of the toner holder 210, in an area 204a (hereinafter “winding area”) where the toner passage control means 204 is in contact with the bent portion 202a. On the other hand, in the contact area 222a in which the toner layer 203a is contacted, the spacer means 222 formed on the toner passage control means 204 has a curvature equal to that of the toner holder 210. In an area 204b (hereinafter “spaced-apart area”) located between the contact area 222a in which the toner layer 203a is contacted and the winding area 204a, where the toner passage control means 204 and the toner layer 203a are spaced apart from each other, with no tension being applied from the tension spring 221, the spacer means 222 on the toner passage control means 204 has a curvature equal to that of the toner holder 210 in the upper end portion of the toner passage control means 204, the toner passage control means 204 itself has a curvature equal to that of the bent portion 202a in the lower end portion, and the curvature continuously changes between the two different curvatures in the spaced-apart area 204b therebetween.

When the toner passage control means 204 is attached to the casing member 202 and a tension is applied on the tension spring 221, the curvature of the toner passage control means 204 in the spaced-apart area 204b is slightly reduced from that in a separated state where no tension is applied thereon. However, the tension applied on the toner passage control means 204 is relatively small for the rigidity of the toner passage control means 204 itself, as described above. Therefore, even with a tension being applied on the tension spring 221, the toner passage control means 204 is attached to the casing member 202 while it has the continuously changing curvature in the same direction as the toner holder and is spaced apart from the toner layer in the spaced-apart area 204b.

Therefore, the head interval between the toner layer 203a on the toner holder 210 and the toner passage control means 204 gradually increases in the direction away from the lower end portion of the contact area 222a. However, in the vicinity of the lower end portion of the contact area 222a, the toner passage control means 204 has a curvature approximate to that of the toner holder 210. Therefore, in the area between the vicinity of the lower end portion of the contact area 222a and the vicinity of the position at which the toner holder 210 and the image receiving means 207 come closest to each other, the amount of increase in the head interval is very small, and the head interval is maintained to be equal to the thickness of the spacer means 222 in this area.

With such a configuration, even if the position of the toner passage hole row 214 in the toner holder moving direction varies due to factors such as an error in the attachment of the toner passage control means 204 via the fixing means 219, the head interval at the position of the row of toner passage holes is maintained to be equal to the thickness of the spacer means 222, thereby preventing the recording characteristics from varying.

Moreover, the present example employs a configuration in which the toner passage control means 204 is abutted on the toner layer 203a on the toner holder 210 via the spacer means 222, as described above, whereby even if the toner holder 210 has outer diameter variations, a cylindricity non-uniformity, a radial runout, etc., the toner passage control means 204 moves in the horizontal direction along the peripheral surface of the toner holder 210, whereby such variations can be absorbed. The toner passage control means 204 is fixed in the vertical direction to the casing member 202 by the fixing means 219 so that the movement thereof in the vertical direction is restricted. If the toner holder 210 has outer shape variations, a cylindricity non-uniformity, or a radial runout, the positional relationship between the toner passage hole 214 formed in the toner passage control means 204 and the toner holder 210 in the toner holder moving direction varies. However, even in such a case, the head interval does not vary, and can be maintained to be constant, at the position of the toner passage holes, as described above.

Moreover, in the present example, the end portion of the spacer means 222 on the downstream side in the toner holder moving direction is located on the upstream side in the toner holder moving direction with respect to the position at which the toner holder 210 and the image receiving means 207 come closest to each other. With such a configuration in combination with the configuration in which the toner passage control means 204 has a curvature in the same direction as the toner holder and is spaced apart from the toner layer 203a in the spaced-apart area 204b, there is provided an effect of preventing the head interval from varying along with the change in the position of the row of toner passage holes 214. In addition, by arranging the row of toner passage holes 214 at the position at which the toner holder 210 and the image receiving means 207 come closest to each other, the head interval and the distance between the toner passage control means 204 and the image receiving means 207 can be minimized, thereby stabilizing the toner flight and reducing the applied voltage to the control electrode 215 that is required for the toner flight.

Moreover, it is possible to prevent the problem that after the spacer means 222 once abuts on the toner layer at a position in the contact area 222a, the toner passage control means 204 and the toner layer 203a may contact each other again at a position on the downstream side in the toner holder moving direction with respect to the abutting position. As a result, it is possible to prevent the problem that the contact between the spacer means 222 and the toner layer 203a may become unstable in the intended contact area 222a, thereby varying the head interval and thus varying the recording characteristics.

Moreover, in the present example, the spacer means 222 is parallel to the peripheral portion of the toner holder in the contact area 222a, and the end portion of the spacer means 222 on the downstream side in the toner holder moving direction is located at the terminal portion of the contact area on the downstream side in the toner holder moving direction. In this way, the toner layer 203a smoothly enters the contact area 222a, and the spacer means 222 contacts the toner layer 203a over a large area in the contact area 222a while the edge of the spacer means 222 on the downstream side in the toner holder moving direction will not be brought into a linear contact with the toner layer 203a. Thus, it is possible to prevent the stress applied on the toner layer from being localized at the abutting position, thereby reducing the thickness of the toner layer 203a and failing to obtain a sufficient image density.

Moreover, even if there are minute irregularities on the surface of the edge portion, the edge portion will not directly abut on the toner layer 203a, whereby the irregularities will not be transferred onto the toner layer to scratch the toner layer and to cause an image non-uniformity. Additional effects can be obtained if the end portion of the spacer means 222 on the downstream side in the toner holder moving direction is subjected to a chamfer process or an R process.

Reference numeral 206 is a back electrode arranged so as to oppose the toner holder 210 with the toner passage control means 204 interposed therebetween, and the back electrode 206 functions as a counter electrode so as to form an electric field between the back electrode 206 and the toner holder 210. The back electrode 206 may be a metal or a resin in which a conductive filler is dispersed. While a DC voltage of about 500 V to 2000 V is applied to the back electrode 206, a voltage of 1000 V is applied in the present example. Moreover, the distance between the back electrode 206 and the toner holder 210 is 150 to 1000 μm, and it is set to be 350 μm in the present example. An image receiving member such as recording paper is passed through between the back electrode 206 and the print head 201.

Reference numeral 207 is image receiving means such as recording paper or an image holding belt that is carried in the direction of arrow “a” along a predetermined path extending between the back electrode 206 and the toner passage control means 204.

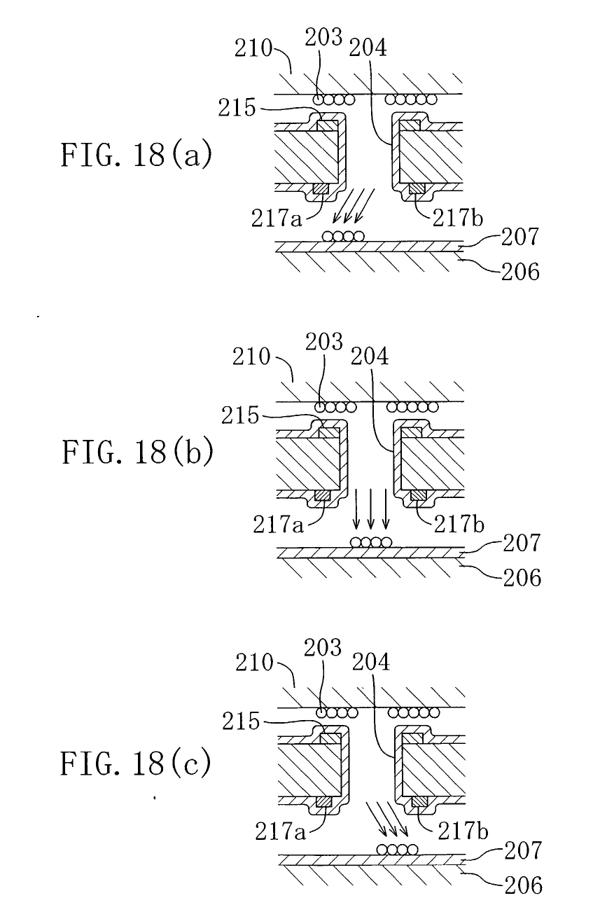

An operation with such a configuration in an image forming period will be described with reference to FIG. 18. First, as illustrated in FIG. 18(a), the toner 203 adsorbed on the toner holder 210 is allowed to fly by first applying a voltage of 250 V to the control electrode 215, with +150 V being applied to the left deflection electrode 217a and −150 V being applied to the right deflection electrode 217b so that the negatively charged toner 203 is deflected to the left. The toner 203 is pulled by the electric field formed by the back electrode 206 to pass through the toner passage hole 214, and flies while being deflected to the left so as to be applied to the image receiving means 207 at a position that is displaced by about 40 μm to the left from the position opposing the toner passage hole 214. Next, as illustrated in FIG. 18(b), a voltage is applied to the control electrode 215 as described above with the left and right deflection electrodes 217a and 217b being brought to 0 V, whereby the toner 203 is applied to the image receiving means 207 at the position opposing the toner passage hole 214. Furthermore, as illustrated in FIG. 18(c), a voltage is applied to the control electrode 215 as described above with −150 V being applied to the left deflection electrode 217a and +150 V being applied to the right deflection electrode 217b so that the negatively charged toner 203 is deflected to the right, whereby the toner is applied to the image receiving means 207 at a position that is displaced by again about 40 μm to the right from the position opposing the toner passage hole 214. In this way, the toner is applied to three points, i.e., the left, right and center points, with a single toner passage hole 214, by successively changing the voltages applied to the control electrode 215 and the deflection electrodes 217a and 217b.

Note that during a non-image forming period, the voltage applied to the control electrode 215 is set to be −50 V so that the toner 203 does not fly.

Note that in the present example, the spacer means 222 has a curvature equal to that of the toner holder 210 in the upper end portion of the toner passage control means 204, the toner passage control means 204 itself has a curvature equal to that of the bent portion 202a in the lower end portion thereof, and the curvature continuously changes between the two different curvatures in the spaced-apart area 204b therebetween. Alternatively, the curvature of the bent portion 202a can be approximated to the curvature of the toner holder 210 while arranging the bent portion 202a close to the outer perimeter of the toner holder 210 so that the center of curvature is close to the center of the toner holder 210, whereby the curvature of the toner passage control means 204 in the spaced-apart area 204b can be made substantially equal to the curvature thereof in the contact area 222a and substantially constant in the spaced-apart area. In this way, as compared to a case as described above where the curvature continuously changes in the spaced-apart area 204b, it is possible to reduce the amount of increase in the head interval on the downstream side in the toner holder moving direction, and to further reduce the variations in the recording characteristics due to the variations in the head interval caused by the change in the position of the row of toner passage holes 214.

### EXAMPLE 4

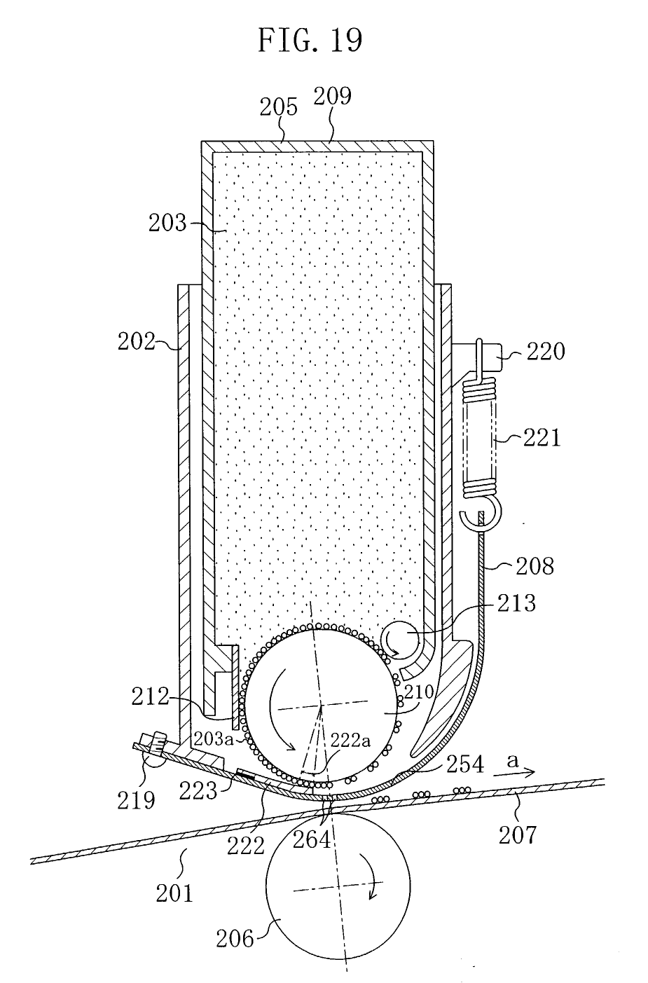

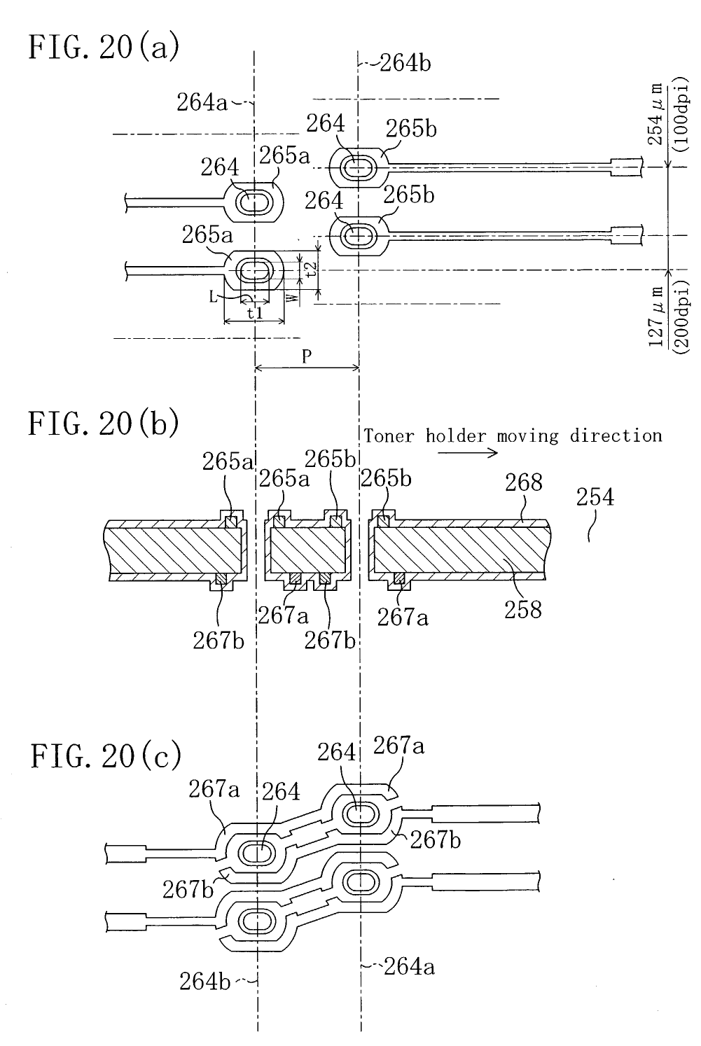

Next, Example 4 of the image forming device of the present invention will be described with reference to FIG. 19 and FIG. 20. Note that the same elements as those of Example 3 will be denoted by the same reference numerals and will not be described below, and only the difference therebetween will be described.

The image forming device of the present example has a configuration different from that of Example 3 with respect to the toner passage control means 204 as illustrated in FIG. 20.

As illustrated in FIG. 20(a), toner passage control means 254 includes, on the upper surface of a main film 258, toner passage hole rows 264a and 264b each including a plurality of toner passage holes 264, and the toner passage hole rows 264a and 264b are arranged in parallel to each other at a predetermined pitch p in the toner holder moving direction. For example, if two rows of toner passage holes are arranged so as to be staggered in the hole row direction, as illustrated in the figure, with each of the toner passage hole rows 264a and 264b having a hole pitch of 254 μm (corresponding to 100 dpi), the total hole pitch for the two toner passage hole rows 264a and 264b is 127 μm (corresponding to 200 dpi). The toner flies through each toner passage hole while being deflected in three directions as in Example 3. As a result, an image of 600 dpi can be formed on the image receiving means 207. Thus, along with the improvement in the recording resolution, it is possible to realize a process at a low cost while ensuring a sufficient opening area of the toner passage hole 264 and to stably control the toner flight.

A control electrode 265 is arranged on the upper surface of the insulative substrate 258 having a thickness of about 50 μm so as to surround the periphery of each of the toner passage holes 264a and 264b, and an IC chip (not shown) for applying an image signal is connected to a lead electrode extending from the control electrode 265.

A pair of deflection electrodes 267a and 267b are arranged on the lower surface of the insulative substrate 258 so as to surround each toner passage hole 264 from opposite sides. The electrodes 265, 267a and 267b are made of a Cu film having a thickness of about 8 to 20 μm, which is patterned on the insulative substrate 258. The surface of the toner passage control means 254 is coated with an insulative film 268 of 5 to 30 μm so as to prevent these electrodes from being shorted with one another.

The planar shape of each toner passage hole 264 is made of a long hole whose length L in the toner holder moving direction is greater than its width W in the direction perpendicular to the toner holder moving direction, as illustrated in FIG. 20(a). In the illustrated example, the length L is set to be about 100 μm, and the width W is set to be about 70 to 80 μm. Moreover, the width of the control electrode 265 around the toner passage hole 264 is set so that the width t1 in the major axis direction of the toner passage hole 264 is greater than the width t2 in the minor axis direction.

The control electrode 265 and the driving IC therefor are connected to each other via a connection electrode 265a that is extending to the upstream side for the row 264a of toner passage holes 264 on the upstream side in the direction in which the toner holder 210 moves, and via a connection electrode 265b that is extending to the downstream side for the row 264b of toner passage holes 264 on the downstream side in the direction in which the toner holder 210 moves. A voltage of 400 V or less is normally applied to the control electrode 265, and in the present example, a voltage of 250 V is applied for forming dots and a voltage of −50 V for not forming dots.

Moreover, as illustrated in FIG. 20(b), the connection between the deflection electrodes 267a and 267b and the driving IC therefor is as follows. For the deflection electrodes 267a on one side of the toner passage hole 264, the deflection electrodes 267a of both of the rows 265a and 265b are connected together and connected to the driving IC via the connection electrode 267a extending to the upstream side in the direction in which the toner holder 210 moves. For the deflection electrodes 267b on the other side of the toner passage hole 264, the deflection electrodes 267b of both of the rows 265a and 265b are connected together and connected to the driving IC via the connection electrode 267b extending to the downstream side in the direction in which the toner holder 210 moves.

FIG. 19 is a diagram illustrating a state where the toner passage control means 254 including a plurality of rows of toner passage holes 264 as described above is mounted on the developer supply unit 205 and the casing member 202 as those of Example 3. Two toner passage hole rows are arranged in symmetry with respect to a line between the center of the toner holder 210 and the center of the back electrode 206, which corresponds to the position at which the toner holder 210 and the image receiving means 207 come closest to each other, whereby it is possible to minimize the head intervals in the two rows of toner passage holes 264 and the distance between the toner passage control means 254 and the image receiving means 207, and to realize a configuration in which the difference between the head interval in one of the two rows of toner passage holes 264 and the head interval in the other one of the two rows of toner passage holes 264 is reduced. In this way, even when employing a configuration in which the toner passage control means 254 includes a plurality of rows of toner passage holes 264 in the toner holder moving direction in order to improve the recording resolution, variations in the recording characteristics among different rows of toner passage holes will not occur due to the variations in the head interval among the rows of toner passage holes 264, whereby the plurality of rows of toner passage holes 264 can be controlled under the same conditions.

Note that while the toner passage control means and the toner layer 203a abuts on each other via the spacer means 222 in Examples 3 and 4, the toner passage control means may alternatively abut directly on the toner layer 203a without the spacer means 222 therebetween. It is possible to reduce the head interval, thereby reducing the applied voltage to the control electrode 215 that is required for the toner flight for obtaining a sufficient recording density.

### EXAMPLE 5

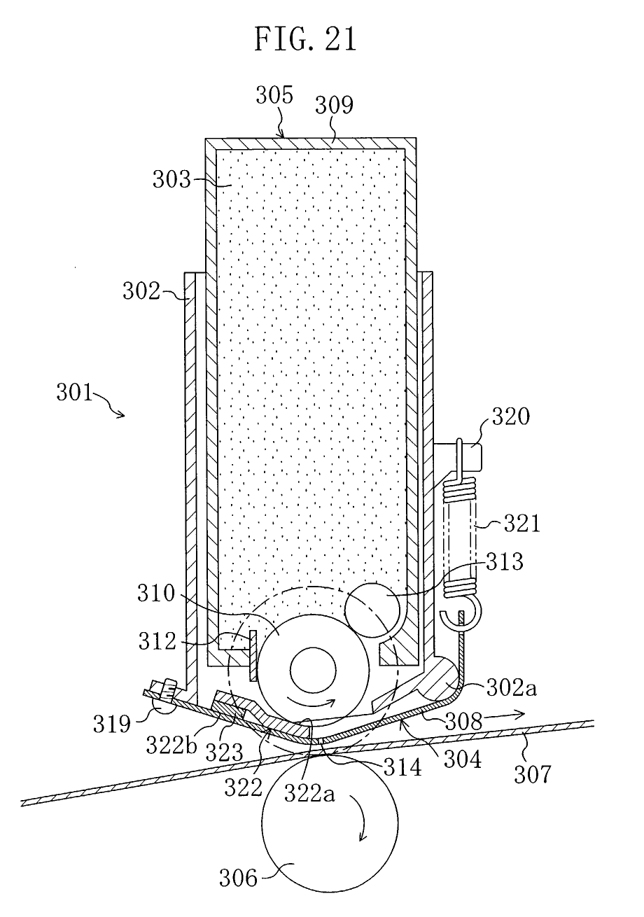

Example 5 of the present invention will be described with reference to FIG. 21 to FIG. 23. FIG. 21 illustrates a general configuration of an image forming device according to Example 5. In FIG. 21, reference numeral 301 is a print head, and the print head 301 includes a casing member 302 that is open on the upper side and has an opening in the bottom portion, toner passage control means 304 arranged on the outer surface of a lower portion of the casing member 302 so as to cover the opening, and a toner supply unit 305 placed in the casing member 302. A back electrode 306 is arranged below the print head 301 with an appropriate gap therebetween, and image receiving means 307 is passed through between the back electrode 306 and the print head 301.

The toner supply unit 305 includes a storage container 309 for storing a toner 303, which is a developer, a toner holder 310 arranged so as to meet an opening that is formed in a lower portion of the storage container 309, a limiting blade 312 for limiting a toner layer held and carried by the toner holder 310, and a supply roller 313 for stirring and frictionally charging the toner 303 in the storage container 309 while supplying the toner 303 to the toner holder 310.

The toner holder 310 is formed by using a metal such as aluminum or iron or an alloy. In the present example, the toner holder 310 is a rotatable sleeve made of aluminum having an outer diameter of 20 mm and a thickness of 1 mm, and the potential thereof is the ground potential.

The limiting blade 312 is made of an elastic member such as a urethane, and suitably has a hardness of 40 to 80 degrees (JIS K6301 A Scale), a free end length (the length of a portion thereof extending from the position where it is attached) of 5 to 15 mm, and a linear load on the toner holder 310 of 5 to 40 g/cm. One to three layers of toner are formed on the toner holder 310 by the limiting blade 312. The limiting blade 312 is electrically floating in the present example.

The toner 303 is interposed between the toner holder 310 and the limiting blade 312, where it is subject to slight stirring and is charged by receiving a charge from the toner holder 310. In the present example, the toner 303 is a non-magnetic material having an average particle diameter of 8 μm, and has a negative charge of −10 μC/g.

The supply roller 313 is obtained by providing a synthetic rubber such as a urethane foam having a thickness of about 2 to 6 mm on a shaft made of a metal such as iron (having a diameter of 8 mm in the present example), so that the hardness thereof is 30 degrees (as measured by the method of JIS K6301 A Scale using a sample that has been processed into a roller shape). In addition to assisting in charging the toner 303, it controls the supply thereof The amount by which the supply roller 313 is pushed into the toner holder 310 is preferably about 0.1 to 2 mm.

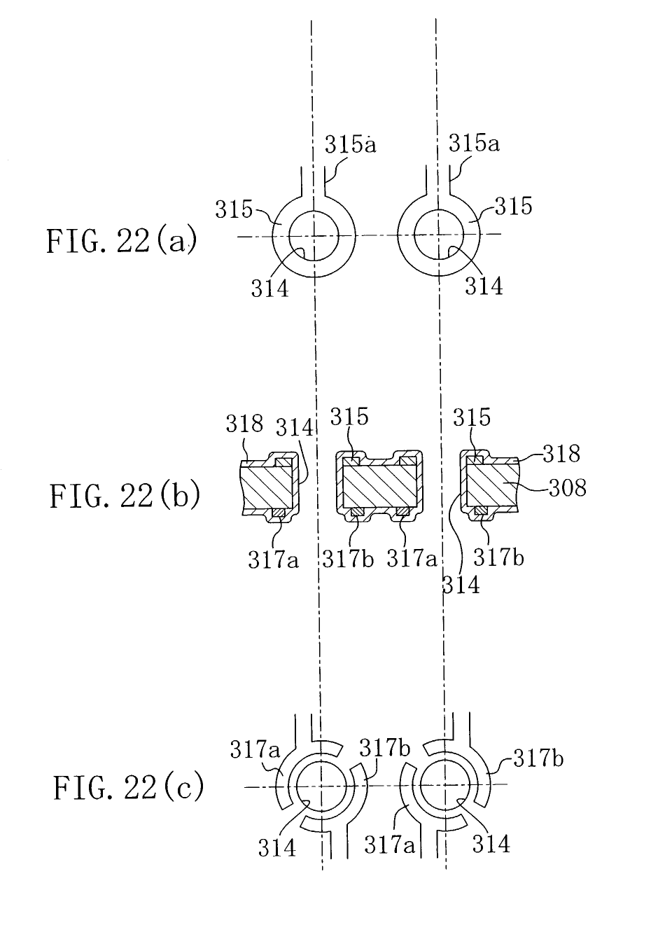

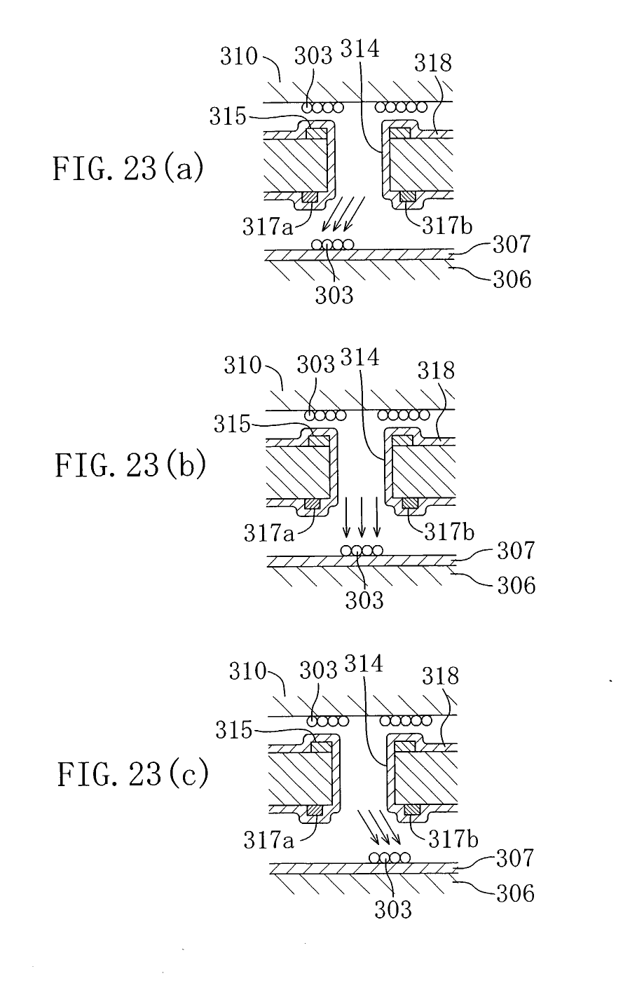

The toner passage control means 304 includes a flexible insulative base member 308 having an effective width that corresponds to the effective width of the toner holder 310. The insulative base member 308 is provided with a large number of toner passage holes 314 arranged at a minute pitch in the width direction of the image receiving means 307, whereby one or more rows of toner passage holes 314 are formed. A ring-shaped control electrode 315 (see FIG. 22 and FIG. 23) is formed so as to surround each toner passage hole 314, and deflection electrodes 317a and 317b (see FIG. 22 and FIG. 23) are formed on the lower surface of the insulative base member 308. The insulative base member 308 is preferably made of a material such as polyimide or polyethylene terephthalate, and suitably has a thickness of 10 to 100 μm. In the present example, polyimide having a thickness of 50 μm is used as the insulative base member 308.

FIG. 22 illustrates, on an enlarged scale, an important part of the toner passage control means 304. In the toner passage control means 304, the plurality of toner passage holes 314 provided in the insulative base member 308 having a thickness of about 50 μm are arranged in rows parallel to the toner holder 310. Moreover, as illustrated in FIG. 22(a), the control electrode 315 is arranged on the upper surface of the insulative base member 308 so as to surround the periphery of each of the toner passage holes 314, and a lead electrode 315a extending from the control electrode 315 is connected to an IC chip, not shown, for applying an image signal. On the other hand, as illustrated in FIG. 22(c), the pair of deflection electrodes 317a and 317b are arranged on the lower surface of the insulative substrate 308 so as to surround each toner passage hole 314 from opposite sides.

The electrodes 315, 317a and 317b are made of a Cu film having a thickness of about 8 to 20 μm, which is patterned on the insulative substrate 308. As illustrated in FIG. 22(b), the surface of the toner passage control means 304 is coated with an insulative film 318 of 5 to 30 μm so as to prevent these electrodes 315, 317a and 317b from being shorted with one another. While the shape of the toner passage hole 314 is a circular shape in the illustrated example, it may alternatively be another shape such as an oblong circle shape or an elliptical shape. The diameter of the toner passage hole 314 is set to be about 70 to 120 μm, for example. A voltage of 400 V or less is normally applied to the control electrode 315, and in the present example, a voltage of 250 V is applied for forming dots and a voltage of −50 V for not forming dots.

Referring again to FIG. 21, the toner passage control means 304 is fixed to the casing member 302 by attachment means 319, at an end portion thereof that is on the upstream side in the direction in which the toner holder 310 moves with respect to the contact point with the toner holder 310 (the moving direction rear end portion), and the downstream end portion (the moving direction front end portion) is fixed to attachment means 320 via a tension spring 321. (Of course, the upstream side portion and the downstream side portion of the toner passage control means 304 may be reversed from those described above). The contact pressure between the toner holder 310 and the toner passage control means 304 caused by the tension spring 321 is suitably 0.2 to 2 gf/mm².

This is because the toner holder 310 and the toner passage control means 304 need to be always in contact with each other under the same condition, following the eccentricity of the rotation axis of the toner holder 310, in order to maintain the interval between the toner holder 310 and the toner passage control means 304 at the position of the toner passage hole 314 to be always appropriate, and because it is necessary to prevent an excessive contact pressure from deforming the toner layer on the toner holder 310. The contact pressure slightly varies depending on the material of the toner holder 310 and the toner passage control means 304, etc.

A spacer 322 (distance limiting means) is provided on the surface of the toner passage control means 304 that opposes the toner holder 310, and the spacer 322 includes a contact area 322a in which the spacer 322 contacts the toner holder 310 via the toner layer on the surface thereof The spacer 322 contacts the toner holder 310 in the contact area 322a, thereby maintaining the interval (head interval) between the toner holder 310 and the toner passage control means 304 to be a constant interval that is the same as the thickness of the spacer 322 itself The spacer 322 is a sheet made of a metal or a conductive resin, and the thickness thereof is preferably 5 to 150 μm, and more preferably 5 to 20 μm.

When the toner supply unit 305 is attached to the casing member 302, with the distance between the toner holder 310 and the back electrode 306 being limited to a predetermined dimension, the peripheral surface of the toner holder 310 abuts on the spacer 322, and a pressing force from the toner holder 310 acts on the spacer 322, thereby displacing the tension spring 321 that is suspended at an end of the toner passage control means 304. Thus, the toner passage control means 304, across the entire width thereof, is in close contact with the toner holder 310 via the spacer 322. The distance (head interval) between the toner layer on the toner holder 310 and the toner passage control means 304 is precisely set by the spacer 322 at a value in the range of 0 to 200 μm, and 10 μm in the present example.

The spacer 322 is bonded and fixed by fixing means 323 to the toner passage control means 304. The fixing means 323 is preferably a resin-based or rubber-based adhesive or a double-sided adhesive tape, and the thickness thereof is preferably 2 to 150 μm, and more preferably 2 to 5 μm.

Moreover, in a case where an antistatic layer (not shown) is coated on the surface of the toner passage control means 304 in an area around the toner passage hole 314, it is preferred that the fixing means 323 is provided not in that area but in an area where the antistatic layer is not present. This is because it is then possible to prevent the antistatic layer from being peeled off.

The fixing means 323 is arranged in an adhesion area 322b that does not overlap, in the thickness direction, with the contact area 322a in which the toner holder 310 is contacted, whereby even if the thickness of the fixing means 323 has individual variations or variations in the toner passage hole row direction, it will not influence and cause the head interval to vary. Thus, it is possible to constantly maintain the interval to be equal to the thickness of the spacer 322 itself entirely across the row of toner passage holes 314, and thus to form a uniform image without non-uniformity.

Moreover, in order to allow a sufficient amount of toner 303 for ensuring a required recording density to fly under a constant voltage application condition, it is necessary to set the head interval to be very small, i.e., about 10 μm. In such a case, however, even a slight head interval variation results in a relatively increased degree of variation, whereby it is typically very difficult to obtain a constant recording density entirely across the row of toner passage holes 314 without non-uniformity. However, in the present example, the head interval is maintained by the thickness of the spacer 322 itself irrespective of the variations in the thickness of the fixing means 323. Therefore, it is possible to easily ensure a minute head interval of about 10 μm, and to form a uniform image without non-uniformity entirely across the row of toner passage holes 314.

Moreover, by reducing the thickness of the adhesive layer of the fixing means 323 to be smaller than the average particle diameter of the toner 303, it is possible to prevent the toner 303 from intruding into a portion other than the adhesion area 322b along the interface between the spacer 322 and the toner passage control means 304 to increase the head interval by the thickness of the intruding toner, thereby constantly maintaining the interval to be equal to the thickness of the spacer 322 itself.

Furthermore, since the adhesion area 322b is arranged on the upstream side in the toner holder rotation direction with respect to the contact area 322a, the frictional force applied from the toner holder 310 to the spacer 322 in the contact area 322a equals the tensile force that acts on the spacer 322 between the contact area 322a and the adhesion area 322b. Therefore, even when the spacer 322 is made of a very thin member having a thickness of 20 μm or less, the spacer 322 will not be buckled or bent, and the flatness of the spacer 322 is desirably ensured.

Moreover, the spacer 322 has a shape and a size such that the spacer 322 does not contact the surface of the toner layer formed on the toner holder 310 in an area on the upstream side in the toner holder moving direction with respect to the contact area 322a, whereby it is possible to prevent an image non-uniformity due to the toner layer being disturbed before the contact area 322a.

Moreover, the back electrode 306 is arranged so as to oppose the toner holder 310 with the toner passage control means 304 interposed therebetween. The back electrode 306 functions as a counter electrode so as to form an electric field between the back electrode 306 and the toner holder 310, and the back electrode 306 is a metal or a resin in which a conductive filler is dispersed. While a DC voltage of about 500 V to 2000 V is applied to the back electrode 306, a voltage of 1000 V is applied in the present example. Moreover, the distance between the back electrode 306 and the toner holder 310 is 150 to 1000 μm, and it is set to be 350 μm in the present example. The image receiving means 307 such as recording paper is passed through between the back electrode 306 and the print head 301.

Moreover, the image receiving means 307 is recording paper, an image holding belt, or the like, and is carried in the direction of an arrow along a predetermined path extending between the back electrode 306 and the toner passage control means 304.

An image forming operation with an image forming device having such a configuration will be described with reference to FIG. 23. As illustrated in FIG. 23(a), first, the negatively charged toner 303 that is adsorbed on the toner holder 310 is allowed to fly by applying a voltage of 250 V to the control electrode 315, with +150 V being applied to the left deflection electrode 317a and −150 V being applied to the right deflection electrode 317b. The toner 303 is pulled by the electric field formed by the back electrode 306 to pass through the toner passage hole 314, and flies while being deflected to the left so as to be applied to the image receiving means 307 at a position that is displaced by about 40 μm to the left from the position opposing the toner passage hole 314. Next, as illustrated in FIG. 23(b), a voltage is applied to the control electrode 315 as described above with the left and right deflection electrodes 317a and 317b being brought to 0 V. Thus, the toner 303 is applied to the image receiving means 307 at the position opposing the toner passage hole 314. Furthermore, as illustrated in FIG. 23(c), a voltage is applied to the control electrode 315 as described above with −150 V being applied to the left deflection electrode 317a and +150 V being applied to the right deflection electrode 317b, whereby the toner 303 is applied to the image receiving means 307 at a position that is displaced by again about 40 μm to the right from the position opposing the toner passage hole 314. In this way, the toner 303 is applied to three points, i.e., the left, right and center points, with a single toner passage hole 314, by successively changing the voltages applied to the control electrode 315 and the deflection electrodes 317a and 317b. Note that during a non-image forming period, the voltage applied to the control electrode 315 is set to be −50 V so that the toner 303 does not fly.

### EXAMPLE 6

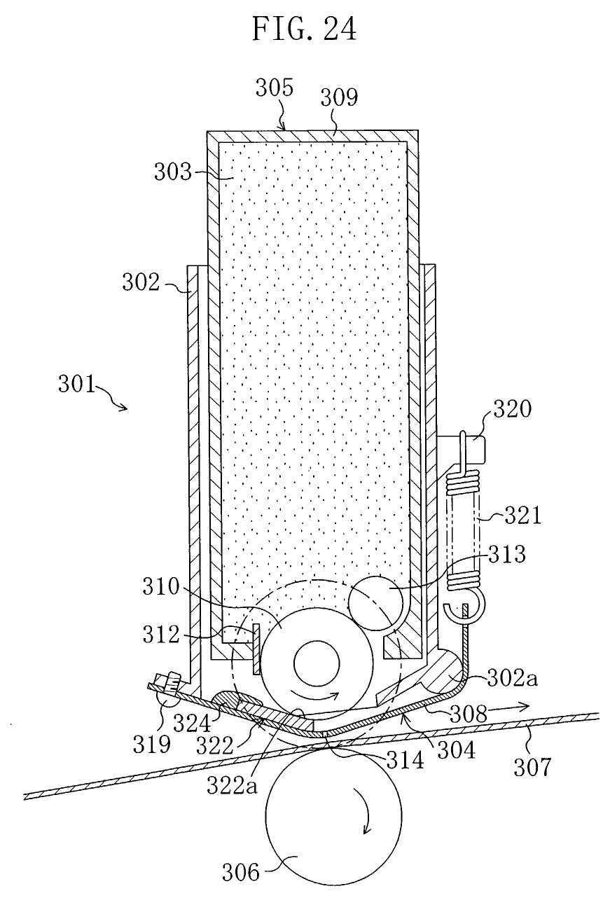

Next, Example 6 of the present invention will be described with reference to FIG. 24. Note that in Example 6 and Example 7 to follow, the same elements as those of Example 5 will be denoted by the same reference numerals and will not be described in detail below, and only the difference therebetween will be described.

Specifically, the image forming device of the present example employs a configuration different from that of Example 5 with respect to the fixing means for the spacer 322 and the toner passage control means 304, as illustrated in FIG. 24.

Fixing means 324 of the present example is extending over the spacer 322 and the toner passage control means 304 so as to seal an end portion of the spacer 322 in the toner holder moving direction, and is formed by applying a resin-based or rubber-based adhesive on the portion and then curing it through a drying step. Note that in a case where an antistatic layer (not shown) is coated on the surface of the toner passage control means 304 in an area around the toner passage hole 314, it is preferred that the fixing means 324 is provided not in that area but in an area where the antistatic layer is not present. This is because it is then possible to prevent the antistatic layer from being peeled off.

The present example provides the following effect in addition to those obtained in Example 5. That is, by using the fixing means 324 extending over the spacer 322 and the toner passage control means 304 so as to seal an end portion of the spacer 322 on the upstream side in the direction in which the toner holder 310 moves (the moving direction rear end portion), the spacer 322 and the toner passage control means 304 can be in close contact with each other across the entire area of the spacer 322 in the direction in which the toner holder 310 moves. Therefore, as compared to Example 5 where the spacer 322 is bent in the area between the adhesion area 322b and the contact area 322a, the flatness of the spacer 322 can be improved, and the corrugation of the spacer 322 in the contact area 322a in the direction parallel to the row of toner passage holes 314 can be reduced.

In addition, since no adhesive layer is present between the spacer 322 and the toner passage control means 304, the adherence between the spacer 322 and the toner passage control means 304 is improved, the intrusion of the toner 303 into the interface between the spacer 322 and the toner passage control means 304 is reduced from that of Example 5, and the head interval can be stably and constantly maintained to be equal to the thickness of the spacer 322 itself for a long period of time.

### EXAMPLE 7

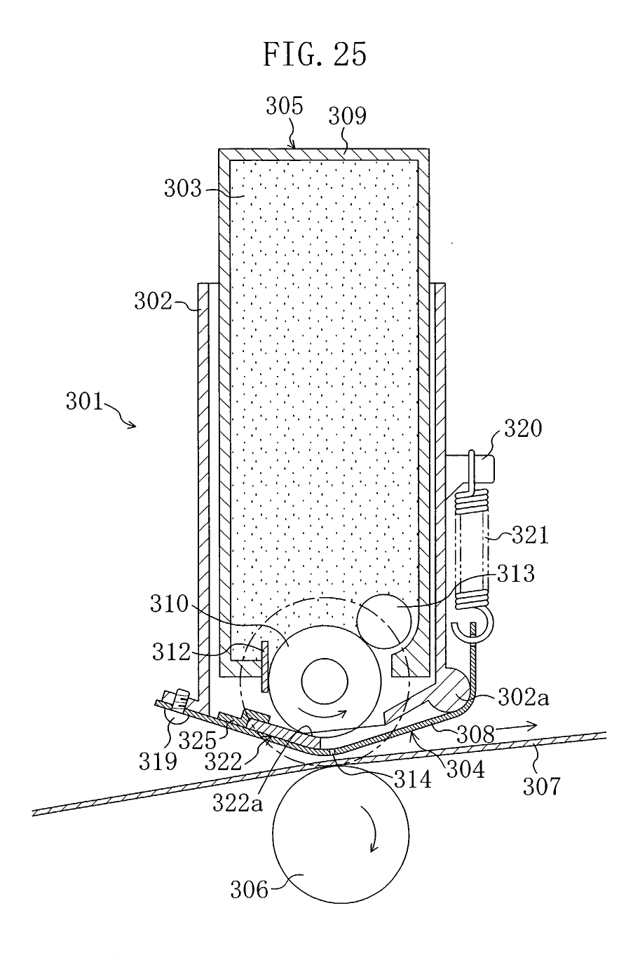

Next, Example 7 of the present invention will be described with reference to FIG. 25. An image forming device of the present example employs a configuration different from those of Examples 5 and 6 with respect to the fixing means between the spacer 322 and the toner passage control means 304, as illustrated in FIG. 25.

Fixing means 325 of the present example is made of an adhesive tape attached over the toner passage control means 304 and the spacer 322 so as to cover an end portion of the spacer 322 on the upstream side in the direction in which the toner holder 310 moves (the moving direction rear end portion), and provides the following effect in addition to those obtained in Examples 5 and 6.

That is, by using an adhesive tape as the fixing means 325, as compared to a case where the fixing means 324 of a sealing material of Example 6 is used, the adhesive application step, the curing step and the drying step can be omitted, thereby significantly improving the assembly efficiency in fixing the spacer 322 to the toner passage control means 304.

Moreover, in a case where an antistatic layer (not shown) is coated on the surface of the toner passage control means 304 in an area around the toner passage hole 314, it is preferred that the fixing means 325 is provided not in that area but in an area where the antistatic layer is not present. This is because it is then possible to prevent the antistatic layer from being peeled off.

Moreover, with the fixing means 325 of the present example, as compared to the fixing means 324 of Example 6 as a sealing material, the thickness of the fixing means itself can be reduced due to the use of an adhesive tape. Moreover, it is not necessary to take into consideration the variations in the thickness of the fixing means that are caused by the variations in the amount of adhesive applied in the application step, and it is possible to reduce the distance of the space between the toner layer and the fixing means 325 that is provided for preventing the fixing means 325 and the toner layer from contacting each other. With such a configuration, the fixing means 325 can be arranged at a position close to the toner holder 310, and the length of the spacer 322 in the direction in which the toner holder 310 moves can be reduced, thereby reducing the size of the device.

Note that in Examples 5 to 7, the fixing means 323 to 325 are provided in the direction parallel to the row of toner passage holes 314 and over a larger area than the row of toner passage holes 314, whereby it is possible to precisely maintain the head interval to be constant across the entire length of the row of toner passage holes 314.

Moreover, in Examples 6 and 7, the fixing means 324 and 325 may be provided in the direction parallel to the row of toner passage holes 314 and over a larger area than the row of toner passage holes 314 while being divided into a plurality of portions in the direction parallel to the row of toner passage holes 314. In the step of bonding and fixing the spacer 322 to the toner passage control means 304, it is possible to prevent the corrugation of the spacer 322 occurring in the direction parallel to the row of toner passage holes 314 during the bonding operation, and it is possible to reduce the amount of material used in the fixing means 324 and 325, thereby reducing the cost.

### EXAMPLE 8

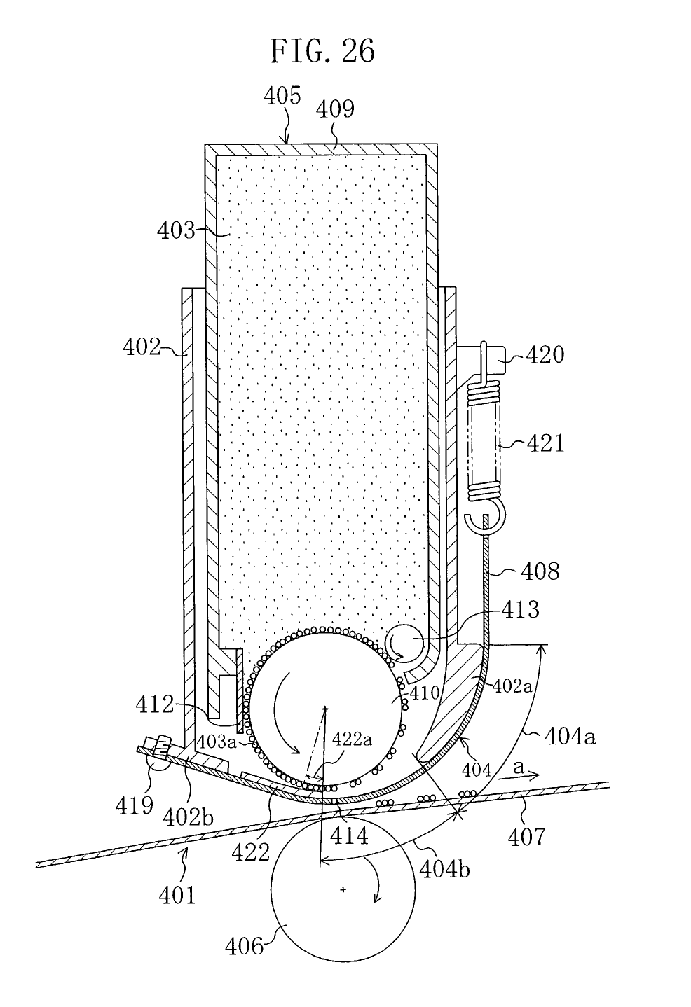

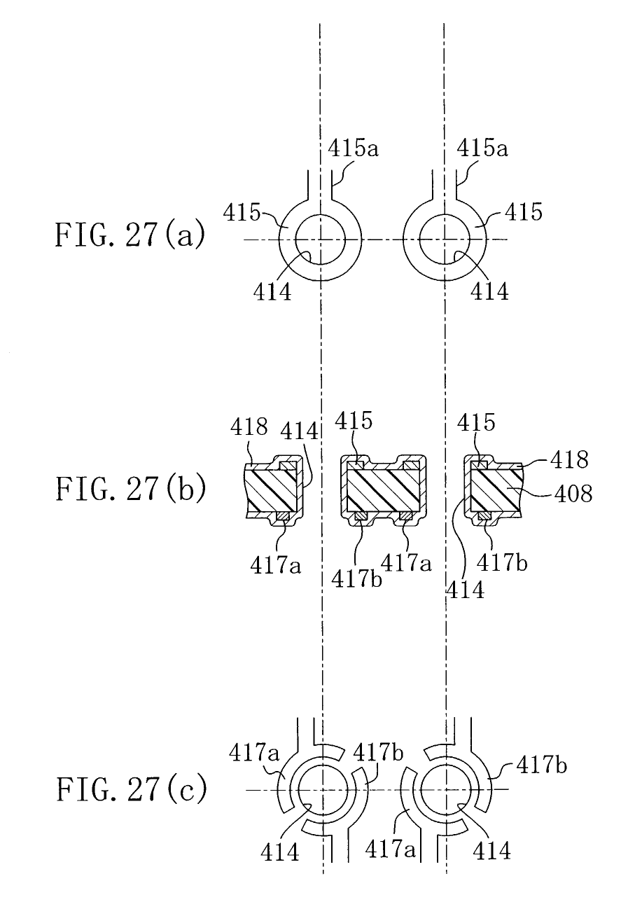

FIG. 26 and FIG. 27 illustrate a general configuration of an image forming device of Example 8 of the present invention. Reference numeral 401 is a print head, and the print head 401 includes a casing member 402, as an image forming device main body, that is open on the upper side and has an opening in the bottom portion, toner passage control means 404 arranged on the outer surface of a lower portion of the casing member 402 so as to cover the opening, and a toner supply unit 405 placed in the casing member 402. A back electrode 406 is arranged below the print head 401 with an appropriate gap therebetween, and image receiving means 407 such as recording paper is passed through between the back electrode 406 and the print head 401.

The toner supply unit 405 includes a storage container 409 for storing a toner 403, which is a developer, a cylindrical toner holder 410 that is arranged so as to meet an opening that is formed in a lower portion of the storage container 409 for holding the toner 403 and rotating while forming a toner layer 403a, a limiting blade 412 for limiting the toner layer 403a held and carried by the toner holder 410, and a supply roller 413 for stirring and frictionally charging the toner 403 in the storage container 409 while supplying the toner 403 to the toner holder 410. As illustrated in FIG. 27, the toner supply unit 405 is inserted into the casing member 402 vertically and downwardly and is set at a predetermined position in the casing member 402.

The toner holder 410 is formed by using a metal such as aluminum or iron or an alloy. In the present example, the toner holder 410 is a rotatable sleeve made of aluminum having an outer diameter of 20 mm and a thickness of 1 mm, and the potential thereof is the ground potential.

The limiting blade 412 is made of an elastic member such as a urethane, and suitably has a hardness of 40 to 80 degrees (JIS K6301 A Scale), a free end length (the length of a portion thereof extending from the position where it is attached) of 5 to 15 mm, and a linear load on the toner holder 410 of 5 to 40 N/m (g/cm). One to three toner layers 403a are formed on the toner holder 410 by the limiting blade 412. The limiting blade 412 is electrically floating in the present example.

The toner 403 in the storage container 409 is interposed between the toner holder 410 and the limiting blade 412, where it is subject to slight stirring and is charged by receiving a charge from the toner holder 410. In the present example, the toner 403 is a non-magnetic material having an average particle diameter of 8 μm, and has a negative charge of −10 μC/g.

The supply roller 413 is obtained by providing a synthetic rubber such as a urethane foam having a thickness of about 2 to 6 mm on a shaft made of a metal such as iron (having a diameter of 8 mm in the present example), so that the hardness thereof is 30 degrees (as measured by the method of JIS K6301 A Scale using a sample that has been processed into a roller shape). In addition to assisting in charging the toner 403, it controls the supply thereof The amount by which the supply roller 413 is pushed into the toner holder 410 is preferably about 0.1 to 2 mm.

The toner passage control means 404 includes a flexible insulative base member 408 having a thickness of about 50 μm and having an effective width that corresponds to the effective width of the toner holder 410. The insulative base member 408 is provided with a large number of toner passage holes 414 arranged at a minute pitch in the width direction of the image receiving means 407, whereby one or more rows of toner passage holes are formed. A ring-shaped control electrode 415 (see FIG. 27) is formed so as to surround each toner passage hole 414, and deflection electrodes 417a and 417b (see FIG. 27) are formed on the lower surface of the insulative base member 408. The insulative base member 408 is preferably made of a material such as polyimide or polyethylene terephthalate, and suitably has a thickness of 10 to 100 μm. In the present example, polyimide having a thickness of 50 μm is used as the insulative base member 408.

FIG. 27 illustrates, on an enlarged scale, a portion of the toner passage control means 404 around the toner passage hole 414. FIG. 27(a) illustrates the control electrode 415, FIG. 27(b) illustrates the toner passage hole 414, and FIG. 27(c) illustrates the deflection electrodes 417a and 417b. As described above, the toner passage control means 404 includes the insulative base member 408 in which a large number of toner passage holes 414 are formed in a row parallel to the toner holder 410 at a predetermined pitch interval. In the present example, the pitch of the toner passage holes 414 is set to be 125 μm, corresponding to 200 dpi, for a recording resolution of 600 dpi. Note that while the shape of the toner passage hole 414 is a circular shape in the illustrated example, it may alternatively be another shape such as an oblong circle shape or an elliptical shape. The diameter of the toner passage hole 414 is set to be about 70 to 120 μm.

Moreover, as illustrated in FIG. 27(a) and FIG. 27(b), the control electrode 415 is arranged on the upper surface of the insulative substrate 408 so as to surround the periphery of each toner passage hole 414, and an IC chip (not shown) for applying an image signal is connected to the control electrode 415 via a lead electrode 415a. A voltage of 400 V or less is normally applied to the control electrode 415. In the present example, a voltage of 250 V is applied for forming dots and a voltage of −50 V for not forming dots.

On the other hand, as illustrated in FIG. 27(b) and FIG. 27(c), the pair of deflection electrodes 417a and 417b are arranged on the lower surface of the insulative substrate 408 so as to surround each toner passage hole 414 from opposite sides.

The control electrode 415 and the deflection electrodes 417a and 417b are made of a Cu film having a thickness of about 8 to 20 μm, which is patterned on the insulative substrate 408. The surface of the toner passage control means 404 is coated with an insulative film 418 of 2 to 30 μm so as to prevent these electrodes 415, 417a and 417b from being shorted with one another.

The material of the insulative film 418 is preferably a polyparaxylene resin (parylene), which is coated by chemical vapor deposition (CVD), or silicon oxide or silicon nitride, which is also coated by chemical vapor deposition (CVD). Particularly, the latter is preferred because a sufficient degree of insulation and moisture resistance can be obtained with a thickness of about 2 μm, whereby the head interval can be considerably reduced as compared to the thickness of 5 to 20 μm that is required in the former, and the applied voltage to the control electrode 415 that is required for allowing the toner to fly can be reduced. Note that in the present example, the insulative film made of silicon oxide and having a thickness of 2 μm is formed by chemical vapor deposition (CVD).

Moreover, the surface of the insulative film 418 is subjected to a surface treatment using an antistatic material (not shown) and electrically grounded. The antistatic material is preferably a boron-based antistatic polymer, which is coated to a thickness that is preferably 5 to 10 μm, and the surface resistance value is preferably 10⁷ to 10⁸. While the shape of the toner passage hole 414 is a circular shape in the figure, it may alternatively be another shape such as an oblong circle shape or an elliptical shape, and the size thereof is set so that the diameter is about 70 to 120 μm. A voltage of 400 V or less is normally applied to the control electrode 415, and in the present example, a voltage of 250 V is applied for forming dots and a voltage of −50 V for not forming dots.

As illustrated in FIG. 26 and FIG. 27, the toner passage control means 404 is fixed to a fixing portion 402b of the casing member 402 by attachment means 419, at a position that is on the upstream side (the left side in the figure) in the toner holder moving direction with respect to the contact point with the toner holder 410, and is fixed to attachment means 420 of the casing member 402 via a tension spring 421 at a position that is on the downstream side (the right side in the figure). The fixing portion 402b is a planar portion that is arranged so as to extend substantially along the extension in the extension direction in which the toner passage control means 404 is extended to the upstream side in the toner holder moving direction after coming apart from the toner holder 410. The contact pressure between the toner holder 410 and the toner passage control means 404 caused by the tension spring 421 is suitably 2 to 20 MPa (0.2 to 2 gf/mm²). This is because the toner holder 410 and the toner passage control means 404 need to be always in contact with each other in an appropriate manner under the same condition, following the eccentricity of the rotation axis of the toner holder 410, in order to always maintain the interval between the toner holder 410 and the toner passage control means 404 at the position of the toner passage hole 414, and because it is necessary to prevent an excessive contact pressure from deforming the toner layer 403a on the toner holder 410. The contact pressure slightly varies depending on the material of the toner holder 410 and the toner passage control means 404, etc.

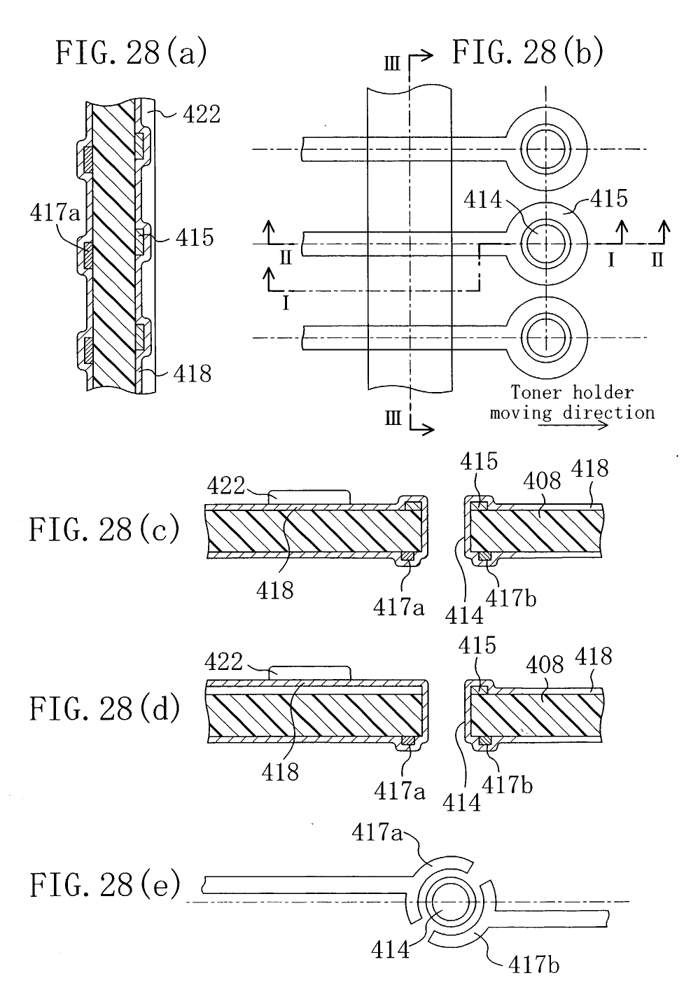

In FIG. 28, reference numeral 422 is spacer means formed on the surface of the toner passage control means 404 that opposes the toner holder 410. The spacer means 422 contacts the toner holder 410 in a contact area 422a illustrated in FIG. 26, thereby limiting the interval (head interval) between the toner holder 410 and the toner passage control means 404 to the thickness of the spacer means 422 itself.

FIG. 28(a) to FIG. 28(e) are cross-sectional views illustrating the toner passage control means 404 taken in a direction parallel to, and in a direction perpendicular to, the toner holder moving direction, and a plan view and a bottom view illustrating the toner passage control means 404. The spacer means 422 will be described in detail with reference to these figures. The spacer means 422 is formed by printing a conductive thick film on the insulative film 418.

The thickness of the spacer means 422 is preferably 5 to 150 μm, and more particularly 5 to 20 μm, and it is set to be 10 μm in the present example. The material of the spacer means 422 is a cold setting silver paste. After screen-printing the silver paste on the insulative film 418, it is left standing for five minutes for leveling, and then dried and cured at a temperature of 220° C. or less, specifically 60 to 80° C., and for 30 minutes. While the surface of the insulative film 418 includes irregularities running in the primary scanning direction and having a height that corresponds to the thickness of the control electrode 415, the surface of the spacer means 422 formed on the insulative film 418 is limited to the height at which a squeegee passes in the screen printing process. Therefore, the irregularities are leveled by being filled with the silver paste, thereby making the surface of the spacer means 422 flat. Moreover, even if irregularities remain on the surface of the spacer means 422, the irregularities can be eliminated by increasing the degree of dilution of the silver paste or increasing the amount of time for which the silver paste is left standing for leveling.

The surface roughness Rz (JIS B0601 with a reference length of 0.8 mm) of the spacer means 422 is preferably 2 μm or more and 8 μm or less, and in the present example, the surface roughness Rz of the toner passage control means 404 as a whole is set to be 3.2 z. Note that while a silver paste is used in the present example, it may alternatively be another conductive paste such as Au, Ag—Pd, or the like.

As illustrated in FIG. 26, when the toner supply unit 405 is attached to the casing member 402, with the distance between the toner holder 410 and the back electrode 406 being limited to a predetermined dimension, the toner layer 403a formed on the peripheral surface of the toner holder 410 abuts on the spacer 422. Moreover, the toner passage control means 404 is wound around the outer perimeter of a bent portion 402a, which is located at the lower end portion of the casing member 402 and which has a curvature smaller than that of the outer perimeter of the toner holder 410, and then elastically held by the attachment means 420 of the casing member 402 via the tension spring 421 that is suspended at the end on the downstream side. In such a state, the tension spring 421 is displaced, resisting against the pressing force from the toner holder 410 to the spacer 422. Thus, the toner passage control means 404, across the entire width thereof, is in close contact with the toner holder 410 via the spacer 422. The distance (head interval) between the toner layer 403a on the toner holder 410 and the toner passage control means 404 is precisely maintained by the spacer 422 at a value in the range of 0 to 200 μm, and 10 μm in the present example. The tension on the toner passage control means 404 caused by the tension spring 421 is a value that is set so as to obtain an appropriate contact pressure of 2 to 20 MPa (0.2 to 2 gf/mm²) between the toner holder 410 and the toner passage control means 404 as described above, and is relatively small for the rigidity of the toner passage control means 404 itself

The present example employs a configuration in which the toner passage control means 404 is abutted on the toner layer 403a on the toner holder 410 via the spacer means 422, as described above, whereby even if the toner holder 410 has outer diameter variations, a cylindricity non-uniformity, or a radial runout, the toner passage control means 404 moves in the horizontal direction along the peripheral surface of the toner holder 410, whereby such variations can be absorbed. In this way, the head interval at the position of the row of toner passage holes is maintained to be equal to the thickness of the spacer means 422, thereby preventing the recording characteristics from varying.

Reference numeral 406 is a back electrode arranged so as to oppose the toner holder 410 with the toner passage control means 404 interposed therebetween, and the back electrode 406 functions as a counter electrode so as to form an electric field between the back electrode 406 and the toner holder 410. The back electrode 406 may be a metal or a resin in which a conductive filler is dispersed. While a DC voltage of about 500 V to 2000 V is applied to the back electrode 406, a voltage of 1000 V is applied in the present example. Moreover, the distance between the back electrode 406 and the toner holder 410 is 150 to 1000 μm, and it is set to be 350 μm in the present example. An image receiving member 7 such as recording paper is passed through between the back electrode 406 and the print head 401. As illustrated in FIG. 26, reference numeral 407 is image receiving means such as recording paper or an image holding belt that is carried in the direction of arrow “a” along a predetermined path extending between the back electrode 406 and the toner passage control means 404.

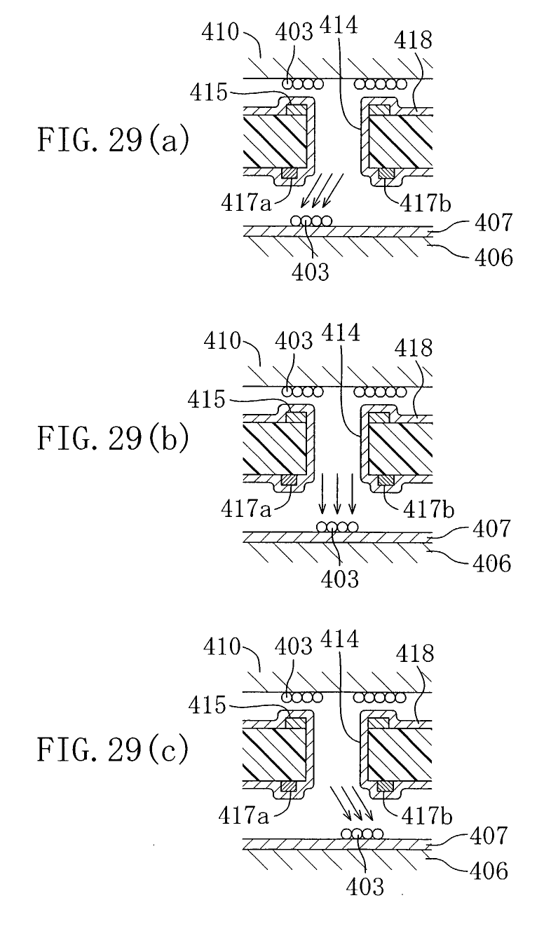

An image forming operation with such a configuration will be described with reference to FIG. 29. First, as illustrated in FIG. 29(a), the toner 403 adsorbed on the toner holder 410 is allowed to fly by applying a voltage of 250 V to the control electrode 415 with +150 V being applied to the deflection electrode 417a on the left in FIG. 29 and −150 V being applied to the deflection electrode 417b on the right so that the negatively charged toner 403 is deflected to the left. The toner 403 having flown off the toner holder 410 is pulled by the electric field formed by the back electrode 406 to pass through the toner passage hole 414, and flies while being deflected to the left so as to be applied to the image receiving means 407 at a position that is displaced by about 40 μm, for example, to the left from the position opposing the toner passage hole 414. Then, as illustrated in FIG. 29(b), a voltage is applied to the control electrode 415 as described above with the left and right deflection electrodes 417a and 417b being brought to 0 V, whereby the toner 403 is applied to the image receiving means 407 at the position opposing the toner passage hole 414. Next, as illustrated in FIG. 29(c), a voltage is applied to the control electrode 415 as described above with −150 V being applied to the left deflection electrode 417a and +150 V being applied to the right deflection electrode 417b so that the negatively charged toner 403 is deflected to the right. Thus, the toner 403 is applied to the image receiving means 407 at a position that is displaced by again about 40 μm, for example, to the right from the position opposing the toner passage hole 414. In this way, the toner 403 can be applied to three points, i.e., the left, right and center points, with a single toner passage hole 414, by successively changing the voltages applied to the control electrode 415 and the deflection electrodes 417a and 417b.

Note that during a non-image forming period, the voltage applied to the control electrode 415 is set to be −50 V so that the toner 403 does not fly.

As described above, in the present example, since the spacer means 422 can be formed integrally with the toner passage control means 404 by printing a thick conductive film on the insulative film 418, it is possible to easily form the spacer means 422 having a thickness of about 10 μm on the toner passage control means 404. Moreover, the thickness can be further reduced, and it is then possible to reduce the head interval and to reduce the applied voltage to the control electrode 415 that is required for allowing the toner 403 to fly.

Moreover, the positional precision of the spacer means 422 with respect to the toner passage hole 414 can be improved, and it is possible to prevent variations in the flight characteristics of the toner 403 which are caused by the variations in the head interval when the distance between the spacer means 422 and the toner passage hole 414 varies.

Moreover, this eliminates the assembly operation of precisely attaching the spacer means 422 having a thickness on the order of 10 μm or so to the toner passage control means 404 so that the spacer means 422 is not deformed. Thus, it is possible to eliminate the problem in the prior art that a very careful handling of the spacer means 422, which is a separate piece, is required, thereby increasing the number of assembly steps in mass production and increasing the cost due to frequent misoperation.

Moreover, with the method for forming the spacer means 422 according to the present example, depressions of the irregularities on the surface of the insulative film 418 that have a height corresponding to the thickness of the control electrode 415 are filled with a silver paste and are leveled, thereby making the surface of the spacer means 422 flat. Thus, it is possible to prevent the irregularities on the surface of the insulative film 418 from being expressed as irregularities on the surface of the spacer means 422, thereby causing irregularities on the toner layer 403a that contacts the spacer means 422 which are transferred onto the image to cause a minute density non-uniformity in the recorded image.

In a case where the spacer means 422 is formed through vapor deposition by a thin film process such as sputtering or chemical vapor deposition (CVD), the vapor deposition of the spacer means 422 is performed with a uniform thickness on the insulative base member 408 or the control electrode 415, whereby the surface of the spacer means 422 includes irregularities running in the primary scanning direction and having a height that corresponds to the thickness of the control electrode 415, and such irregularities cause a thickness non-uniformity in the toner layer, thus causing the minute density nonuniformity. In the present example, such problems as described above do not occur, whereby the minute density non-uniformity can be eliminated.

Moreover, the material of the spacer means 422 is a cold setting silver paste.

After screen-printing the silver paste, it is dried and cured at a temperature of 220° C. or less, specifically 60 to 80° C., and for 30 minutes. In this way, it is possible to reduce the occurrence of a crease and corrugation in the toner passage control means 404 due to heat contraction.

Moreover, in a case where the spacer means 422 is formed only in a portion of the toner passage control means 404 having a large surface area, as in the image forming device of the present invention, the method for forming the spacer means 422 according to the present example is more advantageous in that the material can be screen-printed only in portions where it is required, thus providing the effect of reducing the material cost and the depreciation cost of facilities, as compared to the case of using a thin film process in which the material is vapor-deposited across the entire area of the toner passage control means 404 including portions that are masked.

Moreover, the spacer means 422 is made of a thick conductive film and has a good conductivity, whereby it is possible to prevent the toner 403 from being excessively charged by the sliding movement between the surface of the spacer means 422 and the toner layer 403a, to prevent the toner 403 from electrostatically attaching to the surface of the spacer 422, and to prevent such excessive charging from influencing the flight characteristics of the toner 403 through the toner passage hole 414 to cause the image density, the pixel forming position, etc., to vary.

Moreover, the spacer means 422 is made of a metal material and has a good abrasion resistance. The abrasion resistance can further be improved further by vapor-depositing Ni to a thickness of about 1 to 2 μm on the surface of the spacer means 422. The hardness is preferably 200 Hv or more.

Moreover, in the present example, the surface roughness Rz (JIS B0601 with a reference length of 0.8 mm) of the spacer means 422 is set to be 3.2 z. With such a configuration, it is possible to prevent the toner 403 from attaching to the surface of the spacer means 422 in a long-term use. In a case where a recording operation is performed continuously over a long period of time, with the surface roughness of the spacer means 422 being about 12.5 z, toner particles will accidentally be fused on the surface of the spacer means 422 and the toner will gradually accumulate with the fused toner being a nucleus. Then, the protrusion scratches the toner layer, and the disturbance in the toner layer is transferred onto the recorded image, thereby causing a minute streak in the recorded image. When the recording operation is further continued over a long period of time, the number of such protrusions gradually increases while the size of each protrusion also increases, finally resulting in a state where the toner 403 is fused and accumulated in a planar shape over a certain area, though such an area is partial. If the amount of toner accumulated varies in the direction parallel to the row of toner passage holes (the primary scanning direction), it will cause variations in the interval (head interval) between the toner passage control means 404 and the toner layer in the primary scanning direction, thereby causing variations in the recording characteristics, which in turn cause a strip-shaped density non-uniformity parallel to the secondary scanning direction in the recorded image formed on the image receiving means 407.

In contrast, by setting the surface roughness Rz of the spacer means 422 to be about 3.2 z, the adhesion force of the fused toner particle is reduced so that the fused toner particle is easily removed by the sliding movement against the toner layer, thereby preventing the toner 403 from gradually accumulating with the fused toner particle being a nucleus. Thus, it is possible to prevent a density non-uniformity from occurring on the recorded image due to variations in the head interval in a long-term use.

Moreover, in the present example, the insulative film 418 is formed by chemical vapor deposition (CVD) of silicon oxide. Therefore, a sufficient degree of insulation and moisture resistance can be obtained with a thickness of about 2 μm, while the head interval can be reduced as compared to the thickness of 5 to 20 μm that is required in other methods, and the applied voltage to the control electrode 415 that is required for allowing the toner 403 to fly can be reduced.

Moreover, the surface of the insulative film 418 is subjected to a surface treatment using an antistatic material and electrically grounded. Therefore, it is possible to prevent the toner 403 from being excessively charged by the sliding movement between the surface of the toner passage control means 404 and the toner layer 403a, to prevent the toner 403 from electrostatically attaching to the surface of the toner passage control means 404, and to prevent such excessive charging from influencing the flight characteristics of the toner 403 through the toner passage hole 414 to cause the image density, the pixel forming position, etc., to vary.

Note that while the present example employs a configuration in which the spacer means 422 is arranged on the upstream side in the toner holder moving direction with respect to the row of toner passage holes 414, effects as those of the present invention can be provided by an alternative configuration in which the spacer means 422 is arranged on the downstream side in the toner holder moving direction with respect to the row of toner passage holes 414.

Moreover, while the spacer means 422 is formed on the insulative film 418 by a thick film process, the spacer means 422 may alternatively be covered with an insulative film after forming it on the surface of the insulative substrate 408 in a similar manner. In such a case, by selecting an insulative material for the spacer means 422, the material can be directly printed on the control electrode 415.

### EXAMPLE 9

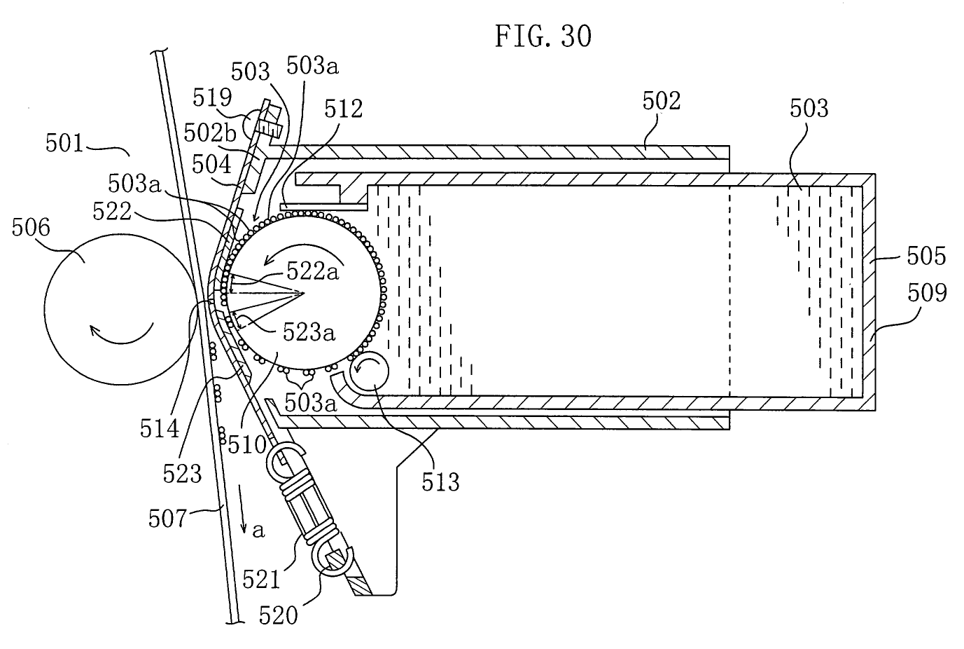

Next, Example 9 of the image forming device of the present invention will be described with reference to FIG. 30 to FIG. 33.

In FIG. 30 illustrating a general configuration of the image forming device, reference numeral 501 is a print head, and the print head 501 includes a casing 502 that is open on one side (the right side in FIG. 30) and has an opening in a portion on the opposite side (a portion on the left side in the figure), a toner supply unit 505 placed in the casing 502, and a toner passage control device 504 arranged so as to cover the opening of the casing 502 from the outside. A back electrode 506 is arranged at a position opposing the toner supply unit 505 with the toner passage control device 504 being interposed therebetween, and with an appropriate interval between the back electrode 506 and the toner passage control device 504. An image receiver 507 such as recording paper is passed in the direction of arrow “a” shown in the figure along a predetermined path between the back electrode 506 and the print head 501.

The toner supply unit 505 includes a container 509 having an opening in the bottom portion thereof for storing a toner 503, which is a developer, a toner holder 510 that is arranged in the opening of the container 509 so as to be rotatable about an axis line extending in the width direction of the image receiver 507 (the direction perpendicular to the passage direction “a”), a supply roller 513 that is arranged in the vicinity of the toner holder 510 so as to be rotatable about an axis line parallel to the axis of the toner holder 510 and so as to be pushed into the toner holder 510 for stirring and frictionally charging the toner 503 in the container 509 while supplying the toner to the toner holder 510, and a limiting blade 512 attached to the container 509 for limiting the toner layer held and carried on the toner holder 510. The toner supply unit 505 is inserted into the casing 502 from right to left in the figure and is set at a predetermined position in the casing 502.

The toner holder 510 is formed by using a metal such as aluminum or iron or an alloy. In the present example, the toner holder 510 is a sleeve made of an aluminum alloy having an outer diameter of 20 mm and a thickness of 1 mm, and the potential thereof is the ground potential.

The supply roller 513 is obtained by providing a synthetic rubber such as a urethane foam having a uniform thickness of about 2 to 6 mm on a shaft made of a metal such as iron (having a diameter of 8 mm in the present example), so that the hardness thereof is 30 degrees (as measured by the method of JIS K6301 A Scale using a sample that has been processed into a roller shape). In addition to assisting in charging the toner 503, it controls the supply of the toner to the toner holder 510. Note that the amount by which it is pushed into the toner holder 510 is preferably about 0.1 to 2 mm.

The limiting blade 512 is made of an elastic member such as a urethane, and forms one to three layers of toner particles 503a on the toner holder 510. The limiting blade 512 is electrically floating in the present example. Note that it suitably has a hardness of 40 to 80 degrees (on the same scale as above), a free end length (the length of a portion thereof extending from a portion of the container 509 to which it is attached) of 5 to 15 mm, and a linear load on the toner holder 510 of 5 to 40 N/m (5 to 40 g/cm).

The toner 503 is interposed between the toner holder 510 and the limiting blade 512, where it is subject to slight stirring and is charged by receiving a charge from the toner holder 510. In the present example, the toner 503 is a non-magnetic material having an average particle diameter of 8 μm, and has a negative charge of −10 μC/g.

The toner passage control device 504 includes a flexible insulative base member 508 having an effective width that corresponds to the effective width of the toner holder 510. The insulative base member 508 is preferably made of a material such as polyimide or polyethylene terephthalate, and suitably has a thickness of 10 to 100 μm. In the present example, polyimide having a thickness of 50 μm is used as the insulative base member 508. The insulative base member 508 is provided with a large number of toner passage holes 514, and the toner passage holes 514 are arranged in one or more rows at a minute pitch in the direction parallel to the axis of the toner holder 510, whereby one or more rows of toner passage holes are formed. In the present example, the pitch between the toner passage holes 514 and 14 is set to be 125 μm, corresponding to 200 dpi, for a recording resolution of 600 dpi, and the toner passage holes are arranged in a single row. Each of the toner passage holes 514 is provided with a control electrode and deflection electrodes to be described next.

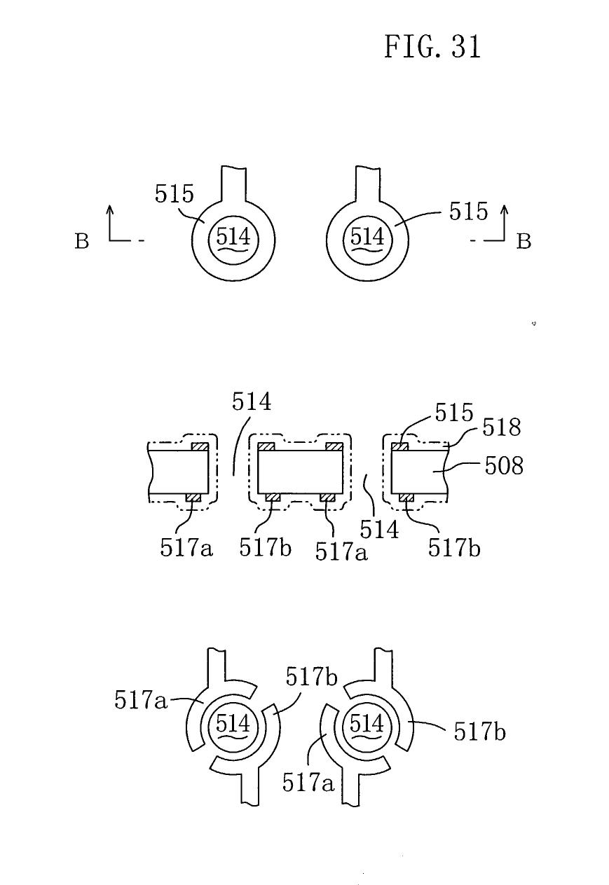

FIG. 31 is an enlarged view illustrating an electrode portion of the toner passage control device 504. As illustrated in FIG. 31(a), the control electrode 515 mentioned above is arranged on the surface of the insulative base member 508 that is closer to the toner holder 510 so as to have a ring shape surrounding the periphery of each toner passage hole 514, and an IC chip (not shown) for applying an image signal is connected to a lead portion extending from each control electrode 515. A voltage of 400 V or less is normally applied to the control electrode 515, and in the present example, a voltage of 250 V is applied during an image forming period and a voltage of −50 V during a non-image forming period. On the other hand, on the surface of the insulative base member 508 that is closer to the back electrode 506, the deflection electrodes 517a and 517b mentioned above are provided as illustrated in FIG. 31(c). The deflection electrodes 517a and 517b form a pair and are arranged so as to surround the toner passage hole 514 from opposite sides. The control electrode 515 and the deflection electrodes 517a and 517b are made of a Cu film having a thickness of about 8 to 20 μm, which is patterned on the insulative base member 508. An insulative film 518 having a thickness of 2 to 30 μm is formed on surface of the toner passage control device 504, as illustrated in FIG. 31(b), so as to prevent these electrodes 515, 517a and 517b from being shorted with one another. Such an insulative film 518 is preferably formed by coating a polyparaxylene resin (parylene) through chemical vapor deposition (CVD), and in the present example, it is formed by depositing an insulative film having a thickness of 20 μm and made of a polyparaxylene resin through chemical vapor deposition. Moreover, the surface of the insulative film 518 is subjected to a surface treatment using an antistatic material (not shown), and the antistatic material is electrically grounded. The surface treatment using an antistatic material is preferably a coating process using a boron-based antistatic polymer. The thickness thereof is preferably 5 to 10 μm, and the surface resistance value is preferably 10⁷ to 10¹³ Ω/□. While the shape of the toner passage hole 514 is a circular shape and the size thereof is set so that the diameter is about 70 to 120 μin the illustrated example, it may alternatively be another shape such as an oblong circle shape or an elliptical shape.

The toner passage control device 504 is fixed to a fixing portion 502b of the casing 502 by attachment means 519, at a position that is on the upstream side (the left side in FIG. 30) in the toner holder moving direction with respect to the contact point with the toner holder 510, and is fixed to a stop portion 520 of the casing 502 via a tension spring 521 at a position that is on the downstream side (the right side in the figure). Of course, the positional relationship of being on the upstream side and the downstream side between the attachment means 519 and the tension spring 521 may be reversed. The contact pressure between the toner holder 510 and the toner passage control device 504 caused by the tension spring 521 is suitably 0.002 to 0.02 MPa (0.2 to 2 gf/mm²). This is because the toner holder 510 and the toner passage control device 504 need to be always in contact with each other under the same condition, following the eccentricity of the rotation axis of the toner holder 510, in order to always maintain the head interval, i.e., the interval between the toner holder 510 and the toner passage control device 504 at the position of the toner passage hole, and because it is necessary to prevent an excessive contact pressure from deforming the toner layer on the toner holder 510. The contact pressure slightly varies depending on the material of the toner holder 510 and the toner passage control device 504, etc.

The back electrode 506 functions as a counter electrode for forming, between the back electrode 506 and the toner holder 510, a transfer electric field for sucking the toner 503 on the toner holder 510, and is made of a material obtained by dispersing a conductive filler in a metal or a resin. A DC voltage of about 500 to 2000 V is typically applied to the back electrode 506, and a voltage of 1000 V is applied in the present example. Moreover, while the distance between the back electrode 506 and the toner holder 510 is suitably 150 to 1000 μm, it is set to be 350 μm in the present example.

Furthermore, in the present example, the toner passage control device 504 is provided with spacer portions 522 and 523 that are formed on the upstream side and the downstream side in the toner holder moving direction with respect to the row of toner passage holes. The spacer portions 522 and 523 are in contact with the toner layer on the toner holder 510 in contact areas 522a and 523a, respectively, thereby limiting the head interval to the thickness of the spacer portions 522 and 523 themselves.

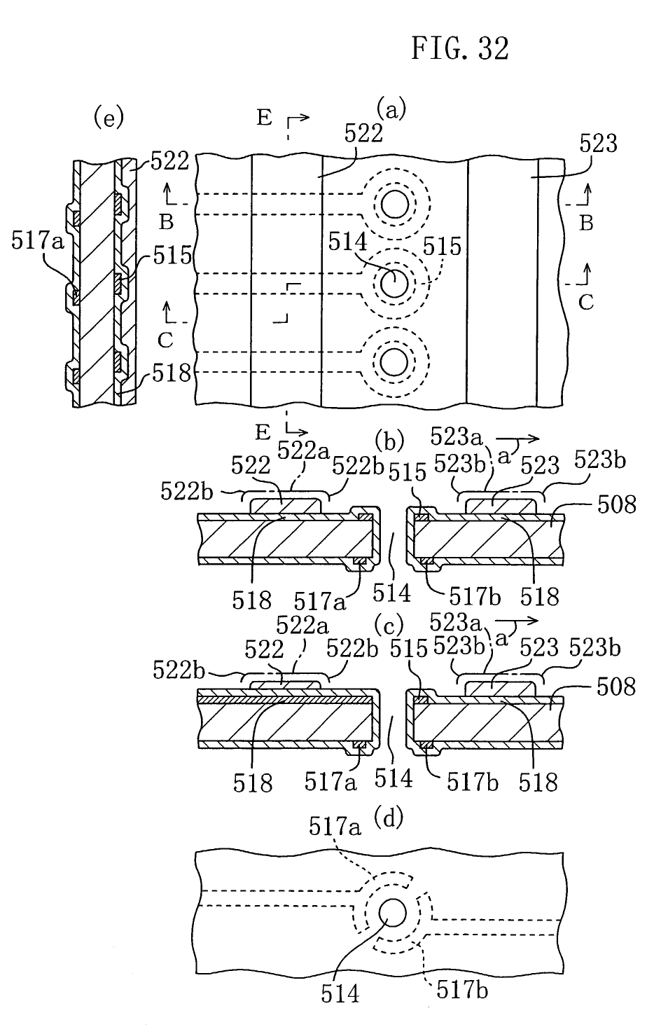

The spacer portions 522 and 523 will be described in detail with reference to FIG. 32. The spacer portions 522 and 523 are formed by screen-printing a thick conductive film on the insulative film 518. The thickness of the spacer portions 522 and 523 is preferably 5 to 150 μm, and more preferably 5 to 20 μm. In the present example, they have an equal thickness of 10 μm. The material of the spacer portions 522 and 523 is a cold setting silver paste. The silver paste is screen-printed on the insulative film 518, and then left standing for 5 minutes for leveling, after which it is dried and cured at a temperature of 220° C. or less, specifically 60 to 80° C., and for 30 minutes. While the surface of the insulative film 518 includes irregularities running in the primary scanning direction (the direction of the row of toner passage holes) and having a height that corresponds to the thickness of the control electrode 515, the surface of the spacer portion 522 formed on the insulative film 518 is limited to the height at which a squeegee passes in the screen printing process. Therefore, they are leveled with each depression between the control electrodes 515 and 515 being filled with the silver paste, thereby making the surface of the spacer portions 522 and 523 flat. Note that if irregularities remain on the surface of the spacer portions 522 and 523, the irregularities can be eliminated by increasing the degree of dilution of the silver paste or increasing the amount of time for which the silver paste is left standing for leveling. The surface roughness Rz (JIS B0601 with a reference length of 0.8 mm) of the spacer portions 522 and 523 is preferably 2 μm or more and 8 μm or less. In the present example, the surface roughness Rz of the toner passage control device 504 as a whole, including the spacer portions 522 and 523, is suppressed to 3.2 Z. Moreover, the spacer portions 522 and 523 are made of a metal material and have a good abrasion resistance. The abrasion resistance can further be improved further by vapor-depositing Ni to a thickness of about 1 to 2 μm on the surface of the spacers 522 and 523. The hardness is preferably 200 Hv or more. Note that while a silver paste is used as the material of the spacer portions 522 and 523 in the present example, it may alternatively be another conductive paste such as Au, Ag—Pd, or the like.

In the image forming device as described above, when the toner supply unit 505 is placed in the casing 502, with the distance between the toner holder 510 and the back electrode 506 being limited to a predetermined dimension, the toner passage control device 504 is elastically held in the casing 502 via the tension spring 521 that is suspended at the end on the downstream side, and the toner layer formed on the peripheral surface of the toner holder 510 successively comes into contact with the spacer portions 522 and 523 as the toner holder 510 rotates. In such a state, the tension spring 521 is displaced, resisting against the pressing force from the toner holder 510 to the spacer portions 522 and 523. Thus, the toner passage control device 504, across the entire width thereof, is in close contact with the toner holder 510 via the spacer portions 522 and 523, whereby the head interval is precisely maintained by the spacer portions 522 and 523 at a value in the range of 5 to 150 μm, and 10 μm in the present example. The tension on the toner passage control device 504 caused by the tension spring 521 is a value that is appropriately set so as to obtain an appropriate contact pressure of 0.002 to 0.02 MPa (0.2 to 2 gf/mm²) between the toner holder 510 and the toner passage control device 504 as described above.

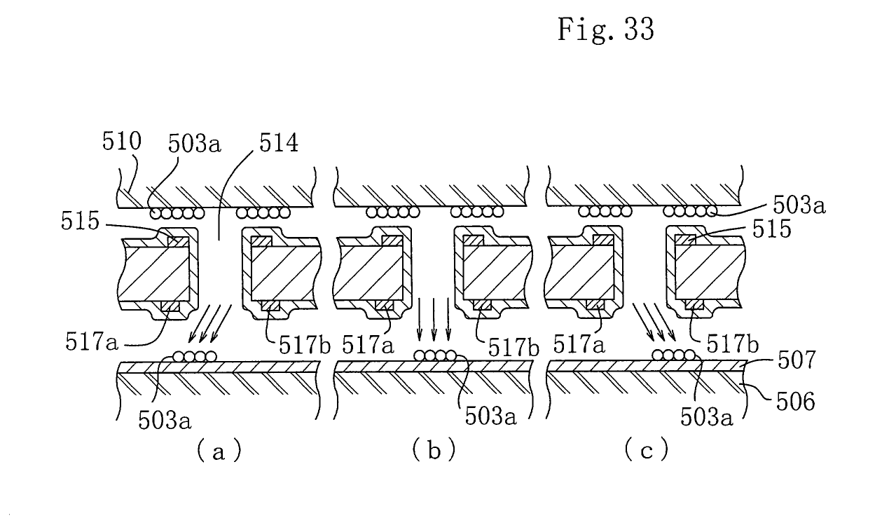

An image forming operation of the image forming device having such a configuration will be described with reference to FIG. 33. First, as illustrated in FIG. 33(a), the toner particles 503a adsorbed on the toner holder 510 are allowed to fly by applying a voltage of 250 V to the control electrode 515 with a voltage of +150 V being applied to the left deflection electrode 517a and a voltage of −150 V being applied to the right deflection electrode 517b so that the charged toner 503 is deflected to the left. The toner particles 503a are pulled by the electric field formed by the back electrode 506 to pass through the toner passage hole 514, and fly while being deflected to the left, whereby the toner particles 503a are applied to the image receiver 507 at a position that is displaced by about 40 μm to the left from the position opposing the toner passage hole 514. Then, as illustrated in FIG. 33(b), a voltage is applied to the control electrode 515 as described above with the applied voltage to the left and right deflection electrodes 517a and 517b being brought to 0 V, whereby the toner particles 503a are applied to the image receiver 507 at the position opposing the toner passage hole 514. Next, as illustrated in FIG. 33(c), a voltage is applied to the control electrode 515 as described above with a voltage of −150 V being applied to the left deflection electrode 517a and a voltage of +150 V being applied to the right deflection electrode 517b so that the toner particles 503a are deflected to the right. Thus, the toner particles 503a are applied to the image receiver 507 at a position that is displaced by again about 40 μm to the right from the position opposing the toner passage hole 514. In this way, the toner particles 503a can be applied to three points, i.e., the left, right and center points, with a single toner passage hole 514, by successively changing the voltages applied to the control electrode 515 and the deflection electrodes 517a and 517b. Note that during a non-image forming period, the voltage applied to the control electrode 515 is set to be −50 V so that the toner particles 503a do not fly.

As described above, in the image forming device of the present example, the spacer portions 522 and 523 are provided on the upstream side and the downstream side in the toner holder moving direction with respect to the row of toner passage holes of the toner passage control device 504, and the spacer portions 522 and 523 are in contact with the toner layer on the toner holder 510, whereby the head interval in the vicinity of the row of toner passage holes between the contact areas 522a and 523a corresponding to the upstream and downstream spacer portions 522 and 523, respectively, can be maintained to be constant, thus preventing the toner flight characteristics from varying.

Now for the purpose of comparison, the conventional example will be described again. The spacer portion is provided only on the upstream side with respect to the row of toner passage holes, with the toner passage control device being attached to the casing 502 via the tension spring 521 on the downstream side thereof. In such a case, the curvature of the toner passage control device on the downstream side with respect to the spacer portion is determined by the balance between the flexural rigidity of the toner passage control device itself and the tension from the tension spring 521. Therefore, the curvature of the toner passage control device will be varied by various factors such as variations in rigidity due to variations in the base member thickness of the toner passage control device, etc., variations in rigidity due to changes in the temperature, a decrease in rigidity over time (by being reshaped), variations in the tensile force of the tension spring 521, and variations in the position at which the toner passage control device is attached to the casing 502. Then, due to such variations in curvature, the head interval varies in the vicinity of the row of toner passage holes, whereby the toner flight characteristics vary to lower the image quality. Particularly, where the thickness of the spacer portion is as small as about 10 μm, the spacer portion once contacts the toner layer at a position in the contact area, and then the toner passage control device and the toner layer contact again with each other on the downstream side in the toner holder moving direction with respect to the contact position. As a result, the contact between the spacer portion and the toner layer in the intended contact area becomes unstable, thereby varying the head interval and thus varying the recording characteristics.

In contrast, in the present example, the spacer portions 522 and 523 are arranged on the upstream side and the downstream side in the toner holder moving direction with respect to the row of toner passage holes of the toner passage control device 504, as described above, whereby the head interval can be maintained to be constant in the vicinity of the row of toner passage holes. Therefore, as described above, the head interval can be stably maintained even if the flexural rigidity of the toner passage control device 504 changes due to the temperature, etc., and it is possible to prevent problems such as a decrease in the image quality.

Moreover, even if the toner holder 510 has outer diameter variations, a cylindricity non-uniformity, or a radial runout, the toner passage control device 504 moves along the peripheral surface of the toner holder 510 forward and backward in the direction in which the toner holder 510 moves while maintaining the head interval to be constant, whereby such variations, etc., can be absorbed. In this way, the head interval at the position of the row of toner passage holes is maintained to be equal to the thickness of the spacer portions 522 and 523, thereby preventing the recording characteristics from varying.

Next, the present example provides the following advantages with respect to the attachment of the toner passage control device 504 to the casing 502.

That is, the fixing portion 502b of the casing 502, to which the toner passage control device 504 is fixed on the upstream side, is located substantially along the extension in the direction in which the toner passage control device 504 is extended after coming apart from the toner holder 510, and the stop portion 520 of the casing 502, to which the toner passage control device 504 is fixed on the downstream side via the tension spring 521, is also located substantially along the extension in the direction in which the toner passage control device 504 is extended after coming apart from the toner holder 510. Thus, no undesired bending moment occurs in the toner passage control device 504, and the spacer portions 522 and 523 can be uniformly contacted with the toner layer in the contact areas 522a and 523a.

This similarly applies to the area of the row of toner passage holes located between the contact areas 522a and 523a. Specifically, the cross-sectional shape of the toner passage control device 504 between the contact areas 522a and 523a is determined by the curvatures of the contact areas 522a and 523a, and the tension applied by the tension spring 521 on the toner passage control device 504 does not act as a bending moment for the toner passage control device 504 in the area. Therefore, the head interval can be stably maintained at a predetermined dimension.

Moreover, between the row of toner passage holes and the fixing portion 502b, the toner passage control device 504 is extended substantially along a straight line with no undesired bending. Therefore, when the toner passage control device 504 is attached to the casing 502, the positioning precision of the row of toner passage holes with respect to the toner holder 510 and the casing 502 can be improved. Moreover, between the row of toner passage holes and the fixing portion 502b, the toner passage control device 504 is similarly extended substantially along a straight line with no undesired bending. Therefore, in the toner passage control device 504, which has once been positioned and fixed to the casing 502, the radius of curvature will not be changed by a change in the flexural rigidity thereof due to a change in the temperature, etc., or the position of the row of toner passage holes will not be changed by a change in the temperature.

Next, the present example provides the following advantages due to the use of a thick film printing process for the formation of the spacer portions 522 and 523.

The spacer portions 522 and 523 are formed by screen-printing a conductive cold setting silver paste on the insulative film 518. If the degree of dilution of the silver paste is increased and an appropriate leveling time is provided after the screen printing process, ridge portions 522b and 523b on the upstream side and the downstream side of the spacer portions 522 and 523 in the toner holder moving direction are formed to have a curved cross section with a radius that is about ½ of the thickness of the spacer portions 522 and 523 due to the surface tension of the material. In this way, when the toner layer enters the contact area 523a in which the downstream side spacer portion 523 is contacted, the toner 503 is prevented from being scratched off by the upstream side ridge portion 523b of the spacer portion 523. Therefore, the toner 503, which has been scratched off, will not accumulate in the space between the toner passage control device 504 and the toner holder 510, and a so-called “fogging phenomenon” in which the toner 503 is ejected from the toner passage hole 514 during a non-image forming period will not occur.

Moreover, in the step of forming the spacer portions 522 and 523, depressions of the irregularities on the surface of the insulative film 518 that have a height corresponding to the thickness of the control electrode 515 are filled with a silver paste and are leveled, thereby making the surface of the spacer portions 522 and 523 flat. Thus, it is possible to prevent the irregularities on the surface of the insulative film 518 from being expressed as irregularities on the surface of the spacer portions 522 and 523, thereby causing irregularities on the toner layer that contacts the spacer portions 522 and 523 which are transferred onto the image to cause a minute density non-uniformity in the recorded image. In a case where the spacer portion 522 is formed through vapor deposition by a thin film process such as sputtering or chemical vapor deposition, the vapor deposition of the spacer portions 522 and 523 is performed with a uniform thickness on the insulative base member 508 or the control electrode 515, whereby the surface of the spacer portions 522 and 523 includes irregularities running in the primary scanning direction and having a height that corresponds to the thickness of the control electrode 515, and such irregularities cause a thickness non-uniformity in the toner layer, thus causing the minute density non-uniformity. In the present example, however, such problems do not occur as described above, whereby the minute density non-uniformity can be eliminated.

Moreover, the material of the spacer portions 522 and 523 is a cold setting silver paste that is screen-printed and then dried and cured at a temperature of 220° C. or less, specifically 60 to 80° C., and for 30 minutes. In this way, it is possible to reduce the occurrence of a crease and corrugation in the toner passage control device 504 due to heat contraction.

Moreover, in devices such as the present image forming device in which the spacer portions 522 and 523 are formed only in portions of the toner passage control device 504, which has a large area, with the method for forming the spacer portions 522 and 523 according to the present example, the material can be screen-printed only in portions where it is required. Therefore, the material cost and the depreciation cost of facilities can be reduced, as compared to, for example, the case of using a thin film process in which the material is vapor-deposited across the entire area of the toner passage control device 504 including portions that are masked.

Next, the present invention provides the following advantages in that the spacer portions 522 and 523 can be formed integrally with the toner passage control device 504 through a screen printing process.

That is, it is possible to easily form the spacer portions 522 and 523 having a thickness of about 10 μm on the toner passage control device 504. Moreover, the thickness can be further reduced, whereby it is possible to reduce the head interval and to reduce the applied voltage to the control electrode 515 that is required for allowing the toner particles 503a to fly.

Moreover, the positional precision of the spacer portions 522 and 523 with respect to the toner passage hole 514 can be improved, and thus it is possible to prevent variations in the flight characteristics of the toner 503 which are caused by the variations in the head interval when the distance between the toner passage hole 514 and the spacer portions 522 and 523 varies.

Moreover, it is possible to eliminate an assembly operation of precisely attaching spacer portions, which are separate pieces in the prior art, to the toner passage control device without deforming the spacer portions, thereby preventing the number of assembly steps in mass production from increasing and the cost from increasing due to frequent misoperation.

In addition, the present example provides the following advantages. That is, since the spacer portions 522 and 523 are conductive, it is possible to prevent the toner from being excessively charged by the sliding movement against the toner layer, whereby it is possible to prevent the toner 503 from electrostatically attaching to the surface of the spacer portions 522 and 523, and to prevent such excessive charging from adversely influencing the flight characteristics of the toner 503 through the toner passage hole 514 to cause the image density, the pixel forming position, etc., to vary.

Moreover, since the surface roughness Rz of the spacer portions 522 and 523 is suppressed to 3.2 Z, the adhesion force of the toner particles 503a fused on the surface of the spacer portions 522 and 523 can be suppressed to be small, and thus the fused toner particles 503a can be easily removed by the sliding movement against the toner layer, thereby preventing the toner from gradually accumulating with the fused toner particles 503a being a nucleus. Thus, it is possible to prevent the toner 503 from attaching to the surface of the spacers 22 and 523 in a long-term use, and to prevent a density nonuniformity from occurring on the recorded image due to variations in the head interval.

Moreover, the surface of the insulative film 518 is subjected to a surface treatment using an antistatic material, and is electrically grounded. Therefore, it is possible to prevent the toner particles 503a from being excessively charged by the sliding movement between the surface of the toner passage control device 504 and the toner layer, whereby it is possible to prevent the toner particles 503a from electrostatically attaching to the surface of the toner passage control device 504 and to prevent such excessive charging from adversely influencing the flight characteristics of the toner 503 through the toner passage hole 514 to cause the image density, the pixel forming position, etc., to vary.

Note that the toner passage holes 514 are arranged in a single row, and the spacer portions 522 and 523 on the upstream side and the downstream side of the row of toner passage holes have an equal thickness in the present example. Alternatively, a plurality of rows of toner passage holes may be arranged in the direction in which the toner holder 510 moves, with the thickness of the spacer portion 522 on the upstream side of the plurality of rows of toner passage holes being different from the thickness of the spacer portion 523 on the downstream side. In such a case, in the area between the contact areas 522a and 523a, the head interval continuously varies in the range equal to the difference between the two thickness dimensions of the spacer portions 522 and 523. Therefore, a head interval appropriate for each row of toner passage holes can be set by independently setting the thicknesses of the spacer portions 522 and 523. Particularly, the amount of toner 503 to be supplied tends to relatively decrease for a row of toner passage holes on the downstream side with respect to another row of toner passage holes on the upstream side, whereby it is possible to obtain, on the downstream side, flight characteristics as those on the upstream side by compensating for the decrease in the toner supply, if the head interval for a row of toner passage holes on the downstream side is set to be smaller than that for another row of toner passage holes on the upstream side.

Moreover, the spacer portions 522 and 523 on the upstream side and the downstream side are formed to be separate from each other in the present example. Alternatively, it is possible to provide a spacer portion having a rectangular ring shape by connecting ends of the spacer portions 522 and 523 to each other in a non-recording area on the outer side of each end of each row of toner passage holes in the toner passage control device 504, where the toner passage holes 514 are not present. In such a case, the spacer portions 522 and 523 can be continuously contacted with the toner layer in the nonrecording area, thereby stably holding the toner passage control device 504.

Moreover, while the spacer portions 522 and 523 are formed on the insulative film 518 in the present example, the spacer portions 522 and 523 may be covered with an insulative film after forming them directly on the surface of the insulative base member 508. In such a case, by selecting an insulative material for the spacer portions 522 and 523, the material can be directly printed on the control electrode 515. EXAMPLE 10

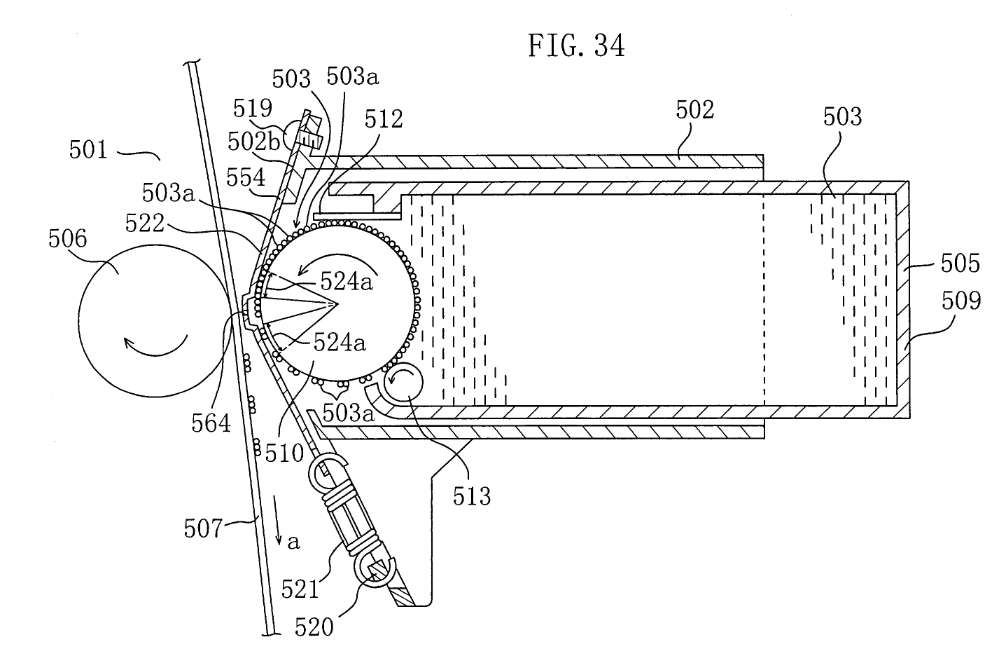

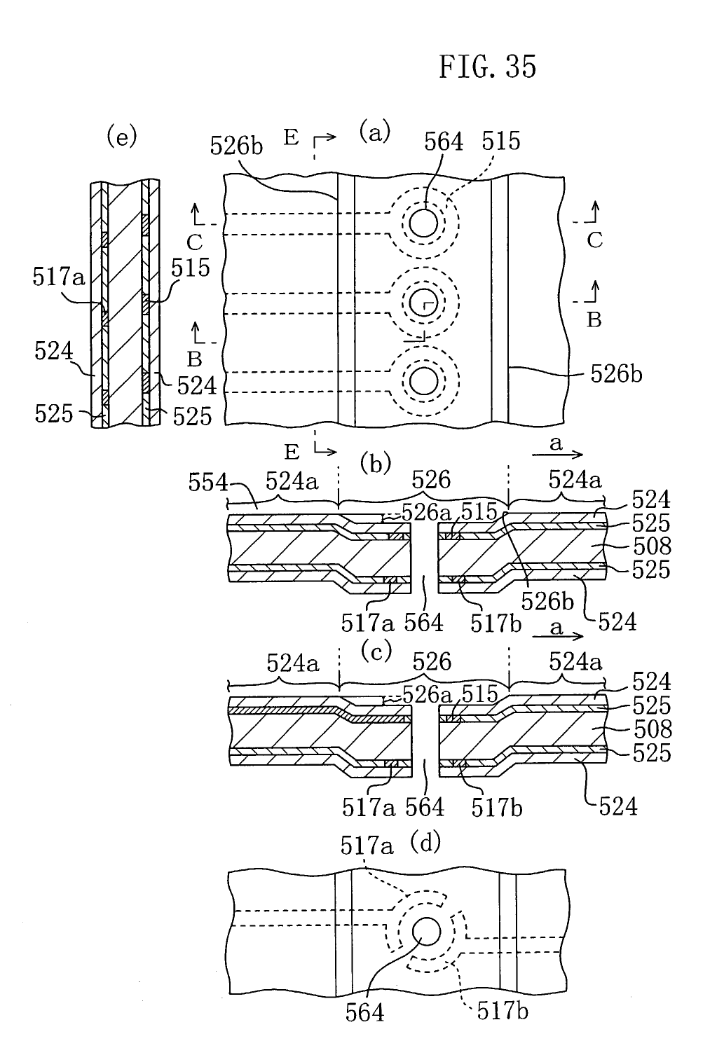

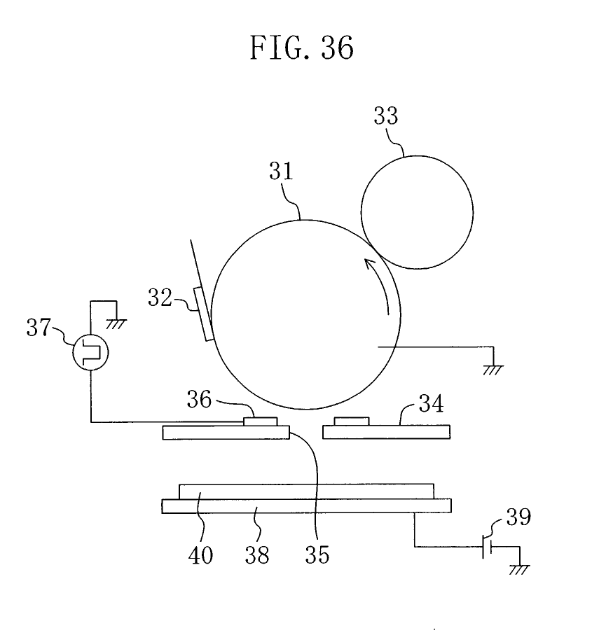

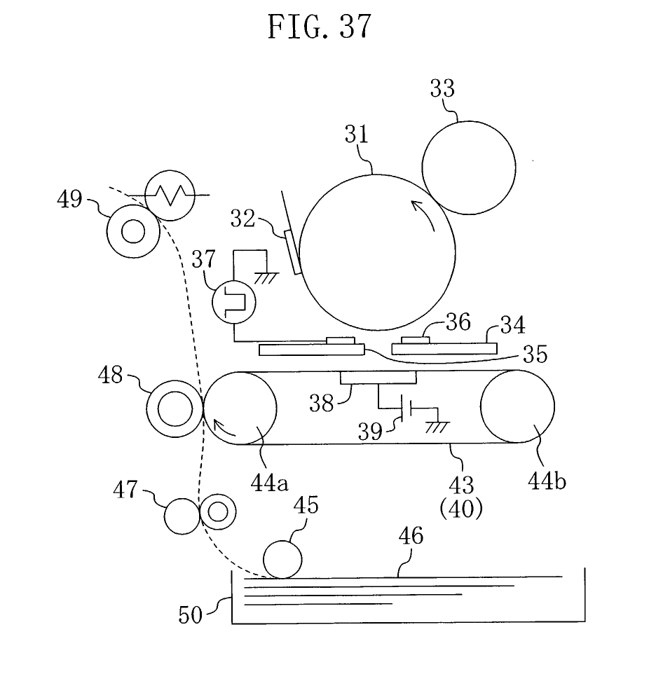

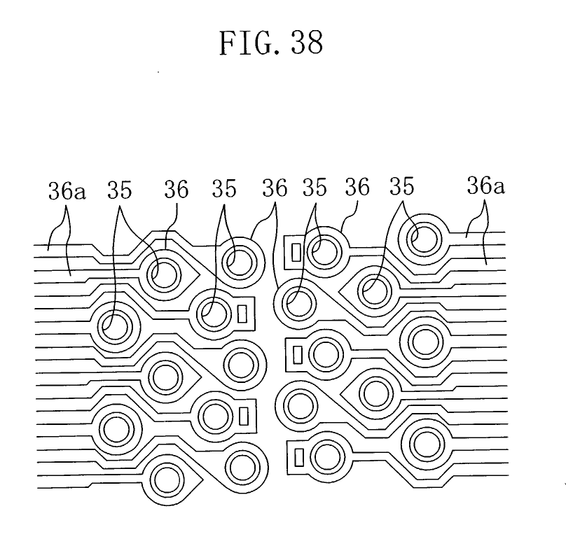

Next, Example 10 of the image forming device of the present invention will be described with reference to FIG. 34 to FIG. 35. The image forming device of the present example employs a configuration different from that of Example 9 with respect to the cross-sectional structure of a toner passage control device 554 as illustrated in FIG. 34. Note that the same elements as those of Example 9 will be denoted by the same reference numerals and will not be described below, and the description below will be mainly on only the difference therebetween.

As illustrated in FIG. 35, each toner passage hole 564 formed in the insulative base member 508 is provided with the control electrode 515 and the pair of deflection electrodes 517a and 517b, which are structurally the same as those of Example 9,on the upper surface and the reverse surface, respectively, so as to surround the periphery of the toner passage hole 564, with cover layers 524 being layered so as to sandwich the insulative base member 508 therebetween. The material of the cover layer 524 is preferably polyimide, polyethylene terephthalate, or the like, and the thickness thereof is suitably 10 to 100 μm. In the present example, it is formed using polyimide to a thickness of 20 μm, and bonded to the insulative base member 508 by being pressed with heat via an adhesive layer 525.

The adhesive layer 525 is preferably a sheet having a thickness of about 10 μm and made of a thermosetting resin such as an epoxy modified resin. Moreover, the heat pressing process is performed at 80 to 120° C., and then it is left standing at 100 to 150° C. for one hour for thermal setting. The thickness of each of the control electrode 515 and the deflection electrodes 517a and 517b is substantially the same as the thickness of the adhesive layer 525, and the irregularities caused by the control electrode 515 and the deflection electrodes 517a and 517b are absorbed as the depressions thereof are filled with the softened adhesive layer 525 during the heat pressing process, whereby the irregularities are prevented from being expressed on the surface of the toner passage control device 554. In a layered structure in which the cover layers 524 are bonded to opposite sides of the insulative base member 508, on which the control electrode 515 and the deflection electrodes 517a and 517b have been formed, so as to be integrated therewith, as described above, the toner passage holes 564 are opened by an excimer laser process, or the like.

Moreover, in the present example, a groove-shaped depressed portion 526 having a depth 526a of 200 μm or less is formed across the entire width of the toner passage control device 554 in the area of the row of toner passage holes of the toner passage control device 554, and the head interval is ensured by the depressed portion 526. Thus, the toner passage control device 554 contacts the toner layer on the toner holder 510 in each contact area 524a of the cover layer 524 on the upstream side and the downstream side of the toner holder with respect to the depressed portion 526.

The depressed portion 526 is formed by heat-pressing the toner passage control device 554 by using a die of a predetermined shape, which has been heated through a heat press process, so as to heat-set the insulative base member 508 and the cover layer 524. The shape and dimension of the depressed portion 526, particularly the step shape on each wall surface, can be optimally set by the shape of the die. Specifically, it is preferred that the groove depth 526a is 10 μm, and at least the wall surface on the downstream side in the toner holder moving direction is a slope with a ridge portion 526b being rounded. Moreover, the heating temperature in the heat set process is suitably 200 to 400° C. Moreover, when heat-pressing the toner passage control device 554, it is preferred that not only the area in which the depressed portion 526 is to be formed and the vicinity thereof, but also the surrounding area (specifically, the area including the contact areas 522a and 523a in which the toner layer on the toner holder 510 is contacted), are pressed at once by the die simultaneously with the formation of the depressed portion. This is because of the following reason. If only the area in which the depressed portion 526 is to be formed and the vicinity thereof are heat-pressed, a crease or corrugation occurs in the insulative base member 508 and the cover layer 524 in the surrounding area. In contrast, if the whole area including the surrounding area is heat-pressed, it is possible not only to prevent such a crease or corrugation, but also to improve the flatness of the insulative base member 508 and the cover layer 524 as compared to that before the heat pressing process. Note that the toner passage holes 564 may be opened after the formation of the depressed portion 526. Moreover, the surface of the cover layer 524 is subjected to a surface treatment using an antistatic material, which is not shown, and is electrically grounded. The antistatic material is preferably a boron-based antistatic polymer, which is coated to a thickness that is preferably 5 to 10 μm, and the surface resistance value is preferably 10⁷ to 10¹³ Ω/□. Moreover, the abrasion resistance can further be improved by vapor-depositing Ni to a thickness of about 1 to 2 μm on the surface of the toner passage control device 554. The hardness is preferably 200 Hv or more.

In the image forming device as described above, when the toner supply unit 505 is placed in the casing 502, with the distance between the toner holder 510 and the back electrode 506 being limited to a predetermined dimension, the toner passage control device 504 is elastically held in the casing 502 via the tension spring 521 that is suspended at the end on the downstream side, and the toner layer formed on the peripheral surface of the toner holder 510 successively comes into contact with the contact areas 524a of the cover layer 524 of the toner passage control device 554 as the toner holder 510 rotates. In such a state, the tension spring 521 is displaced, resisting against the pressing force from the toner holder 510 to the cover layer 524. Thus, the toner passage control device 504, across the entire width thereof, is in close contact with the toner layer on the toner holder 510 in the contact area 524a of the cover layer 524. At this time, the surface of the toner passage control device 554 in the vicinity of the row of toner passage holes is spaced apart from the toner layer 503 by the depth 526a of the depressed portion 526, whereby the head interval is precisely maintained at a value that is greater than 0 μm and less than or equal to 200 μm (10 μm in the present example). The tension on the toner passage control device 554 caused by the tension spring 521 is a value that is appropriately set so as to obtain an appropriate contact pressure of 0.002 to 0.02 MPa (0.2 to 2 gf/mm²) between the toner holder 510 and the toner passage control device 554 as described above.

As described above, in the image forming device according to the present example, the depressed portion 526 is provided in the area of the row of toner passage holes of the toner passage control device 554 so that the cover layer 524 of the toner passage control device 554 contacts the toner layer on the toner holder 510 both on the upstream side and the downstream side in the toner holder moving direction with respect to the depressed portion 526. Therefore, also with the present example, it is possible to maintain the head interval to be constant. Specifically, as in Example 9, it is possible to prevent the head interval from varying when the flexural rigidity of the toner passage control device 554 changes due to the temperature, etc., and to prevent the toner flight characteristics from varying due to the variations in the head interval.

Moreover, even if the toner holder 510 has outer diameter variations, a cylindricity non-uniformity, or a radial runout, the toner passage control device 554 moves along the peripheral surface of the toner holder 510, whereby such variations can be absorbed. In this way, the head interval at the position of the row of toner passage holes is maintained at the depth 526a of the depressed portion 526, thereby preventing the recording characteristics from varying.

Next, while the toner passage control device 554 is formed in the present example by heat-pressing the insulative base member 508, on which the control electrode 515 and the pair of deflection electrodes 517a and 517b have been formed, via the adhesive layer 525 and the cover layer 524, as described above, the thickness of the control electrode 515 and the deflection electrodes 517a and 517b is substantially the same as that of the adhesive layer 525, and the irregularities caused by the control electrode 515 and the deflection electrodes 517a and 517b are absorbed by the adhesive layer 525, which is softened during the heat-pressing process, whereby the irregularities will not be expressed on the surface of the toner passage control device 554. Therefore, on the surface closer to the toner holder 510, the irregularities of the control electrode 515 expressed on the surface of the cover layer 524 are prevented from causing irregularities in the toner layer to cause a minute density non-uniformity in the recorded image.

Next, the present example provides the following advantages by forming the depressed portion 526 in the toner passage control device 554 through a heat-pressing process on the toner passage control device 554 using a die.

That is, the step shape on each wall surface of the depressed portion 526 can be optimally set by the shape of the die used for heat-pressing the toner passage control device 554 in the formation of the depressed portion 526. In this way, when the toner layer enters the downstream side contact area 524a, the toner layer is prevented from being scratched off by the ridge portion of the wall surface step of the depressed portion 526. Therefore, the toner 503, which has been scratched off, will not accumulate in the space between the toner passage control device 504 and the toner holder 510, and a so-called “fogging phenomenon” in which the toner 503 is ejected from the toner passage hole 514 during a non-image forming period will not occur.

Moreover, the step having a height of about 10 μm on each wall surface of the depressed portion 526 can be easily formed on the toner passage control device 554. The shape of such a step is determined by the precision of the die used when heat-pressing the toner passage control device 554. Therefore, the variations in the head interval can be further reduced as compared to a case where the head interval is limited by the spacer portions 522 and 523 formed through a screen printing process as in Example 9.

Moreover, it is possible to eliminate an assembly operation of precisely attaching spacer portions, which are separate pieces, to the toner passage control device without deforming the spacer portions, as in the prior art, thereby preventing the number of assembly steps in mass production from increasing and the cost from increasing due to frequent misoperation. Moreover, at the same time, the positional precision of the depressed portion 526 with respect to the row of toner passage holes can be improved.

Next, in the present example, when heat-pressing the toner passage control device 554, not only the area in which the depressed portion 526 is to be formed, but also the surrounding area, are pressed at once by a die, thereby preventing a crease or corrugation from occurring in the insulative base member 508 and the cover layer 524 in the surrounding area during the formation of the depressed portion 526, while improving the flatness of the insulative base member 508 and the cover layer 524 as compared to that before the heat pressing process.

In addition, the present example provides the following advantages.

That is, the surface of the cover layer 524 is subjected to a surface treatment using an antistatic material, and is electrically grounded. Thus, it is possible to prevent the toner particles 503a from being excessively charged by the sliding movement against the toner layer, whereby it is possible to prevent the toner particles 503a from electrostatically attaching to the surface of the toner passage control device 504 and to prevent such excessive charging from adversely influencing the flight characteristics of the toner 503 through the toner passage hole 564 to cause the image density, the pixel forming position, etc., to vary.

Note that while the depressed portion 526 is formed across the entire width of the toner passage control device 554 in the example above, the depressed portion 526 may not be extended in a non-recording area on the outer side of each end of each row of toner passage holes in the toner passage control device 554, where no row of toner passage holes is present. In such a case, the toner passage control device 554 can be continuously contacted with the toner layer, thereby stably holding the toner passage control device 554.

Moreover, while the depressed portion 526 is formed through a heat press process in the example above, if a step is formed by the heat press process, it is possible to form a step integrated with the toner passage control device 554 on the upstream side or the downstream side of the toner passage hole 564. In such a case, effects as those described above in Example 8 or Example 2 can be obtained.

INDUSTRIAL APPLICABILITY

The present invention provides an image forming device including a toner holder and a toner passage control device including a plurality of toner passage holes for controlling passage of a toner, in which a toner layer on the toner holder is prevented from being scratched, and in which it is possible to form a high-quality image with no nonuniformity or streak across the entire printing area while ensuring a required recording density under a constant voltage application condition, so as to form a high-quality image both in an initial stage of a recording operation and in a long-term use. Thus, the present invention has a high industrial applicability in that it further promotes the commercialization of image forming devices.

1. An image forming device, comprising:
a toner holder for holding a charged toner and moving while forming a toner layer;
a counter electrode which is arranged at a position opposing a toner carrying position of the toner holder and to which a voltage for forming a transfer electrostatic field for sucking the toner of the toner layer formed on the toner holder is applied;
a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal;
an image receiving member which is arranged between the toner passage control device and the counter electrode and to which the toner having passed through the toner passage holes attaches; and
a spacer member having one of its surfaces in a thickness direction in contact with a surface of the toner layer being moved by the toner holder for maintaining a distance between the toner layer surface and a toner holder side opening of the toner passage hole in the toner passage control device to be substantially constant,
wherein the spacer member is configured so that irregularities on a spacer member contacting surface of a contact member that contacts the other one of the surfaces of the spacer member in the thickness direction are not transferred onto the surface of the toner layer.

2. The image forming device of claim 1, wherein the spacer member is configured so that the irregularities on the spacer member contacting surface of the contact member do not influence a smoothness of the toner layer contacting surface of the spacer member.

3. The image forming device of claim 1 or 2, wherein the contact member is the toner passage control device.

4. An image forming device, comprising:
a toner holder for holding a charged toner and moving while forming a toner layer;
a counter electrode which is arranged at a position opposing a toner carrying position of the toner holder and to which a voltage for forming a transfer electrostatic field for sucking the toner of the toner layer formed on the toner holder is applied;
a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal;
an image receiving member which is arranged between the toner passage control device and the counter electrode and to which the toner having passed through the toner passage holes attaches; and
a spacer member in contact with a surface of the toner layer being moved by the toner holder for maintaining a distance between the toner layer surface and a toner holder side opening of the toner passage hole in the toner passage control device to be substantially constant,
wherein the spacer member is configured so that a smoothness of the toner layer surface does not change after the spacer member contacts the toner layer surface.

5. An image forming device, comprising:
a toner holder for holding a charged toner and moving while forming a toner layer;
a counter electrode which is arranged at a position opposing a toner carrying position of the toner holder and to which a voltage for forming a transfer electrostatic field for sucking the toner of the toner layer formed on the toner holder is applied;
a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal;
an image receiving member which is arranged between the toner passage control device and the counter electrode and to which the toner having passed through the toner passage holes attaches; and
a spacer member in contact with a surface of the toner layer being moved by the toner holder for maintaining a distance between the toner layer surface and a toner holder side opening of the toner passage hole in the toner passage control device to be substantially constant,
wherein a surface roughness of a toner layer contacting surface of the spacer member is set to be smaller than a surface roughness of the toner layer surface before being contacted by the spacer member.

6. An image forming device, comprising:
a toner holder for holding a charged toner and moving while forming a toner layer;
a counter electrode which is arranged at a position opposing a toner carrying position of the toner holder and to which a voltage for forming a transfer electrostatic field for sucking the toner of the toner layer formed on the toner holder is applied;
a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal;
an image receiving member which is arranged between the toner passage control device and the counter electrode and to which the toner having passed through the toner passage holes attaches; and
a spacer member in contact with a surface of the toner layer being moved by the toner holder for maintaining a distance between the toner layer surface and a toner holder side opening of the toner passage hole in the toner passage control device to be substantially constant,
wherein a surface roughness Rz of a toner layer contacting surface of the spacer member is set to be smaller than an average particle diameter of the toner.

7. An image forming device, comprising:
a toner holder for holding a charged toner and moving while forming a toner layer;
a counter electrode which is arranged at a position opposing a toner carrying position of the toner holder and to which a voltage for forming a transfer electrostatic field for sucking the toner of the toner layer formed on the toner holder is applied;
a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal;
an image receiving member which is arranged between the toner passage control device and the counter electrode and to which the toner having passed through the toner passage holes attaches; and
a spacer member in contact with a surface of the toner layer being moved by the toner holder for maintaining a distance between the toner layer surface and a toner holder side opening of the toner passage hole in the toner passage control device to be substantially constant,
wherein a surface roughness Rz of a toner layer contacting surface of the spacer member is set to be 2 to 8 μm.

8. The image forming device of any one of claims 4 to 7, wherein a surface roughness Rz of a portion of a toner layer contacting surface of the spacer member where the spacer member contacts the toner layer is set to be 2 to 4 μm.

9. The image forming device of claim 8, wherein the spacer member is provided on an upstream side in a toner holder moving direction with respect to the toner passage hole, and the spacer member is configured so as to contact the toner layer in an area of the toner layer contacting surface of the spacer member that is 5 mm in length from one end thereof on a downstream side in the toner holder moving direction toward an upstream side.

10. The image forming device of any one of claims 4 to 9, wherein:
the spacer member is provided on an upstream side in a toner holder moving direction with respect to the toner passage hole; and
a corner portion of the spacer member between a toner layer contacting surface thereof and an end surface thereof on a downstream side in the toner holder moving direction is chamfered by a size that is equal to or greater than ½ of a thickness of the spacer member.

11. The image forming device of any one of claims 4 to 10, wherein:
the spacer member is provided on an upstream side in a toner holder moving direction with respect to the toner passage hole; and
a protrusion height with respect to a surface roughness average line is set to be 4 μm or less in an area of the toner layer contacting surface of the spacer member that is 1 mm in length from one end thereof on a downstream side in the toner holder moving direction toward an upstream side.

12. An image forming device, comprising:
a toner holder for holding a charged toner and moving while forming a toner layer;
a counter electrode which is arranged at a position opposing a toner carrying position of the toner holder and to which a voltage for forming a transfer electrostatic field for sucking the toner of the toner layer formed on the toner holder is applied;
a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal;
an image receiving member which is arranged between the toner passage control device and the counter electrode and to which the toner having passed through the toner passage holes attaches; and
a spacer member in contact with a surface of the toner layer being moved by the toner holder for maintaining a distance between the toner layer surface and a toner holder side opening of the toner passage hole in the toner passage control device to be substantially constant,
wherein the spacer member is made of a steel strip.

13. An image forming device, comprising:
a toner holder for holding a charged toner and moving while forming a toner layer;
a counter electrode which is arranged at a position opposing a toner carrying position of the toner holder and to which a voltage for forming a transfer electrostatic field for sucking the toner of the toner layer formed on the toner holder is applied;
a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal;
an image receiving member which is arranged between the toner passage control device and the counter electrode and to which the toner having passed through the toner passage holes attaches; and
a spacer member in contact with a surface of the toner layer being moved by the toner holder for maintaining a distance between the toner layer surface and a toner holder side opening of the toner passage hole in the toner passage control device to be substantially constant,
wherein a hardness Hv of a surface of the spacer member is set to be 400 to 600.

14. The image forming device of claim 12 or 13, wherein the spacer member is made of a stainless steel for springs or a carbon tool steel.

15. An image forming device, comprising:
a toner holder for holding a charged toner and moving while forming a toner layer;
a counter electrode which is arranged at a position opposing a toner carrying position of the toner holder and to which a voltage for forming a transfer electrostatic field for sucking the toner of the toner layer formed on the toner holder is applied;
a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal;
an image receiving member which is arranged between the toner passage control device and the counter electrode and to which the toner having passed through the toner passage holes attaches; and
a spacer member in contact with a surface of the toner layer being moved by the toner holder for maintaining a distance between the toner layer surface and a toner holder side opening of the toner passage hole in the toner passage control device to be substantially constant,
wherein the spacer member is made of a sheet obtained by subjecting a resin material to a surface treatment using an antistatic material.

16. The image forming device of claim 15, wherein a surface resistance of the antistatic material is set to be 10¹⁰ Ω or less.

17. The image forming device of claim 15 or 16, wherein the antistatic material is made of a boron-based polymer.

18. The image forming device of any one of claims 1 to 17, wherein a surface of the spacer member is electrically grounded.

19. An image forming device, comprising:
a toner holder for holding a charged toner and moving while forming a toner layer;
a counter electrode which is arranged at a position opposing a toner carrying position of the toner holder and to which a voltage for forming a transfer electrostatic field for sucking the toner of the toner layer formed on the toner holder is applied;
a toner passage control device arranged between the toner holder and the counter electrode, the toner passage control device including an insulative member in which a toner passage hole row including a plurality of toner passage holes for passing the toner therethrough is formed, and a control electrode provided on the insulative member along at least a portion of a periphery of each of the toner passage holes, wherein the toner passage control device controls passage of the toner through the toner passage holes by a voltage applied to the control electrode according to an image signal;
an image receiving member which is arranged between the toner passage control device and the counter electrode and to which the toner having passed through the toner passage holes attaches; and
a spacer member in contact with a surface of the toner layer being moved by the toner holder for maintaining a distance between the toner layer surface and a toner holder side opening of the toner passage hole in the toner passage control device to be substantially constant,
wherein the spacer member is configured so as to contact the toner layer surface on a downstream side in the toner holder moving direction with respect to the toner passage hole.

20. The image forming device of claim 19, wherein the spacer member is configured so as not to contact the toner layer surface on an upstream side in the toner holder moving direction with respect to the toner passage hole.

21. The image forming device of claim 19 or 20, wherein an end portion of the toner layer contacting surface of the spacer member that is on an upstream side in the toner holder moving direction is inclined away from the toner layer in a direction toward the upstream side.

22. The image forming device of claim 21, wherein the spacer member is formed by covering a spacer film formed on the insulative member of the toner passage control device with a protection layer.

23. The image forming device of claim 22, wherein the spacer film is formed by a vapor deposition step.

24. The image forming device of claim 23, wherein the spacer film is made of an insulative material.

25. The image forming device of any one of claims 22 to 24, wherein a surface of the protection layer is subjected to a surface treatment using an antistatic material.

26. The image forming device of claim 25, wherein a surface resistance of the antistatic material is set to be 10¹⁰ Ω or less.

27. The image forming device of claim 26, wherein the antistatic material is made of a boron-based polymer.

28. The image forming device of any one of claims 25 to 27, wherein the surface of the protection layer is electrically grounded.

29. A toner passage control device arranged so as to oppose a toner holder for holding a charged toner and moving while forming a toner layer, the toner passage control device comprising an insulative member and a control electrode, the insulative member including a toner passage hole row formed therein, the toner passage hole row including a plurality of toner passage holes for passing the toner therethrough arranged in a direction perpendicular to a toner holder moving direction, and the control electrode being provided on the insulative member along at least a portion of a periphery of each of the toner passage holes, wherein the toner passage control device controls passage of the toner through the toner passage holes by a voltage applied to the control electrode according to an image signal, wherein:
a spacer member is provided so as to be in contact with a toner layer surface being moved by the toner holder for maintaining a distance between the toner layer surface and a toner holder side opening of the toner passage hole in the toner passage control device to be substantially constant; and
the spacer member is configured so as to contact the toner layer surface on a downstream side in the toner holder moving direction with respect to the toner passage hole.

30. The toner passage control device of claim 29, wherein the spacer member is configured so as not to contact the toner layer surface on an upstream side in the toner holder moving direction with respect to the toner passage hole.

31. The toner passage control device of claim 29 or 30, wherein an end portion of the toner layer contacting surface of the spacer member that is on an upstream side in the toner holder moving direction is inclined away from the toner layer in a direction toward the upstream side.

32. The toner passage control device of claim 31, wherein the spacer member is formed by covering a spacer film formed on the insulative member with a protection layer.

33. The toner passage control device of claim 32, wherein the spacer film is formed by a vapor deposition step.

34. The toner passage control device of claim 33, wherein the spacer film is made of an insulative material.

35. The toner passage control device of any one of claims 32 to 34, wherein a surface of the protection layer is subjected to a surface treatment using an antistatic material.

36. The toner passage control device of claim 35, wherein a surface resistance of the antistatic material is set to be 10¹⁰ Ω or less.

37. The toner passage control device of claim 36, wherein the antistatic material is made of a boron-based polymer.

38. The toner passage control device of any one of claims 35 to 37, wherein the surface of the protection layer is electrically grounded.

39. An image forming device, comprising:
a toner holder for holding a charged toner and moving while forming a toner layer;
a back electrode which is arranged at a position opposing a toner carrying position of the toner holder and to which a voltage for forming a transfer electrostatic field for sucking the toner of the holder is applied;
toner passage control means arranged between the toner holder and the back electrode for controlling passage of the toner through toner passage holes by applying a voltage to a control electrode according to an image signal, the control electrode being provided on an insulative member along at least a portion of a periphery of each of the toner passage holes, the insulative member including a toner passage hole row including a plurality of toner passage holes for passing the toner therethrough; and
image receiving means which is arranged between the toner passage control means and the back electrode and to which the toner having passed through the toner passage holes attaches, wherein:
the toner passage control means is provided with spacer means in contact with the toner layer held on the toner holder for limiting a distance between the toner layer and an opening of the toner passage hole; and
the toner passage control means includes a portion, which has a curvature and is arranged while being spaced apart from the toner layer, in an area other than an area where the spacer means contacts the toner layer held on the toner holder.

40. An image forming device, comprising:
a toner holder for holding a charged toner and moving while forming a toner layer;
a back electrode which is arranged at a position opposing a toner carrying position of the toner holder and to which a voltage for forming a transfer electrostatic field for sucking the toner of the holder is applied;
toner passage control means arranged between the toner holder and the back electrode for controlling passage of the toner through toner passage holes by applying a voltage to a control electrode according to an image signal, the control electrode being provided on an insulative member along at least a portion of a periphery of each of the toner passage holes, the insulative member including a toner passage hole row including a plurality of toner passage holes for passing the toner therethrough; and
image receiving means which is arranged between the toner passage control means and the back electrode and to which the toner having passed through the toner passage holes attaches,
wherein the toner passage control means includes a portion, which has a curvature and is arranged while being spaced apart from the toner layer, in an area other than an area where the toner passage control means contacts the toner layer held on the toner holder.

41. The image forming device of claim 39 or 40, wherein in an area which is other than the area where the toner passage control means or the spacer means contacts the toner layer and in which the toner passage control means is arranged while being spaced apart from the toner layer, the curvature of the toner passage control means gradually decreases in a direction away from the contact area.

42. The image forming device of claim 39 or 40, wherein in an area which is other than the area where the toner passage control means or the spacer means contacts the toner layer and in which the toner passage control means is arranged while being spaced apart from the toner layer, the curvature of the toner passage control means is constant.

43. The image forming device of claim 41 or 42, wherein the curvature of the toner passage control means in the vicinity of the toner passage hole is substantially the same as the curvature of the toner passage control means in the contact area.

44. The image forming device of any one of claims 39 to 43, wherein a bent member contacting the toner passage control means for limiting the curvature of the toner passage control means is provided in an area other than the area where the toner passage control means or the spacer means contacts the toner layer.

45. The image forming device of any one of claims 39 to 42, wherein the area where the toner passage control means or the spacer means contacts the toner layer is in a positional relationship such that it does not cross a straight line that extends between a center of the toner holder and a position at which the toner holder and the image receiving means come closest to each other.

46. The image forming device of any one of claims 39 to 42, wherein the spacer means is substantially parallel to a peripheral portion of the toner holder in the area where the spacer means contacts the toner layer, and an end portion of the spacer means on the toner passage hole side is a terminal portion of the contact area on the toner passage hole side.

47. The image forming device of claim 45 or 46, wherein an end portion of the spacer means on the toner passage hole side is subjected to a chamfer process or an R process.

48. The image forming device of any one of claims 39 to 42, wherein the toner passage control means and the toner holder come closest to each other in the vicinity of the toner passage hole.

49. The image forming device of any one of claims 39 to 42, wherein the toner passage control means is provided with a plurality of toner passage hole rows, and the plurality of toner passage hole rows are arranged on both sides with respect to a straight line that extends between a center of the toner holder and a position at which the toner holder and the image receiving means come closest to each other.

50. The image forming device of any one of claims 39 to 42, wherein one of end portions of the toner passage control means in a toner holder moving direction is fixed while the other one of the end portions is held via an elastic member.

51. An image forming device, comprising:
a toner holder for holding a charged toner and moving while forming a toner layer;
a back electrode which is arranged at a position opposing a toner carrying position of the toner holder and to which a voltage for forming a transfer electrostatic field for sucking the toner on the holder is applied;
toner passage control means arranged between the toner holder and the back electrode, the toner passage control means including an insulative member including a toner passage hole row including a plurality of toner passage holes for passing the toner therethrough, and a control electrode provided on the insulative member along at least a portion of a periphery of each of the toner passage holes, wherein a voltage according to an image signal is applied to the control electrode so as to successively control passage of the toner through the toner passage holes; and
image receiving means which is arranged between the toner passage control means and the back electrode and to which the toner having passed through the toner passage holes attaches, wherein:
the toner passage control means is provided with distance limiting means in contact with the toner layer held on the toner holder for limiting a distance between the toner layer and an opening of the toner passage hole; and
the distance limiting means is fixed to the toner passage control means by fixing means which is located in an area other than an area where the distance limiting means contacts the toner layer on the toner holder.

52. The image forming device of claim 51, wherein the fixing means is located in an area other than the area where the distance limiting means contacts the toner layer on the toner holder in a toner holder moving direction.

53. The image forming device of claim 52, wherein the fixing means is located in an area which is other than the area where the distance limiting means contacts the toner layer on the toner holder in a toner holder moving direction and which is located on an upstream side in the toner holder moving direction with respect to the contact area.

54. The image forming device of any one of claims 51 to 53, wherein the fixing means is arranged at a position where the fixing means does not contact the toner layer on the toner holder.

55. The image forming device of any one of claims 51 to 54, wherein the fixing means is an adhesive layer formed at an interface between the distance limiting means and the toner passage control means.

56. The image forming device of any one of claims 51 to 54, wherein:
the fixing means is adhesive means; and
the distance limiting means is arranged on a side such as to seal an end portion in a toner holder moving direction.

57. The image forming device of any one of claims 51 to 54, wherein:
the fixing means is an adhesive tape; and
the fixing means is attached over the toner passage control means and the distance limiting means so that the distance limiting means covers an end portion in a toner holder moving direction.

58. The image forming device of any one of claims 51 to 57, wherein the fixing means is arranged in a direction parallel to the toner passage hole row and over a larger area than the toner passage hole row.

59. The image forming device of claim 58, wherein the fixing means is arranged while being divided into a plurality of portions in a direction parallel to the toner passage hole row.

60. The image forming device of any one of claims 51 to 59, wherein the distance limiting means is in contact with the toner passage control means with a gap therebetween having a size less than or equal to a toner particle diameter, and the toner is prevented from intruding into the gap.

61. The image forming device of claim 55, wherein:
a thickness of the adhesive layer is less than or equal to a toner particle diameter; and
the toner is prevented from intruding into an interface between the distance limiting means and the toner passage control means.

62. An image forming device, comprising:
a toner holder for holding a charged toner and moving while forming a toner layer;
a back electrode which is arranged at a position opposing a toner carrying position of the toner holder and to which a voltage for forming a transfer electrostatic field for sucking the toner of the toner holder is applied;
toner passage control means arranged between the toner holder and the back electrode, the toner passage control means including an insulative member including a toner passage hole row including a plurality of toner passage holes for passing the toner therethrough, and a control electrode provided on the insulative member along at least a portion of a periphery of each of the toner passage holes, wherein a voltage according to an image signal is applied to the control electrode so as to control passage of the toner through the toner passage holes; and
image receiving means which is arranged between the toner passage control means and the back electrode and to which the toner having passed through the toner passage holes attaches,
wherein spacer means which is in contact with the toner layer held on the toner holder for limiting a distance between the toner layer and an opening of the toner passage hole is provided integrally on the toner passage control means.

63. The image forming device of claim 62, wherein the spacer means is formed by applying, and then curing, a thick film paste on the toner passage control means.

64. The image forming device of claim 63, wherein the thick film paste is cured at a temperature of 220° C. or less.

65. The image forming device of claim 63, wherein the thick film paste is conductive.

66. The image forming device of claim 63, wherein the thick film paste is applied on the toner passage control means through a screen printing process.

67. The image forming device of claim 66, wherein a surface of the spacer means is leveled during and after the screen printing process.

68. The image forming device of claim 62 or 63, wherein a surface of the spacer means is coated with a metal film.

69. The image forming device of any one of claims 62 to 68, wherein a surface roughness Rz of a portion of the spacer means that abuts on the toner layer on the toner holder is set to be 2 μm to 4 μm.

70. The image forming device of claim 62 or 63, wherein the toner passage control means is covered with an insulative film having a thickness of 3 μm or less.

71. The image forming device of claim 69, wherein the insulative film is made of silicon oxide or silicon nitride.

72. A toner passage control device arranged so as to oppose a toner carrying position of a toner holder for holding a charged toner and moving while forming a toner layer, wherein:
the toner passage control device includes, on an insulative member, a toner passage hole row including a plurality of toner passage holes for passing the toner therethrough arranged in a row in a direction perpendicular to a toner holder moving direction, and a control electrode provided along at least a portion of a periphery of each of the toner passage holes, wherein a voltage according to an image signal is applied to the control electrode so as to control passage of the toner through the toner passage holes; and
spacer means which is in contact with the toner layer held on the toner holder for limiting a distance between the toner layer and an opening of the toner passage hole is provided integrally with the toner passage control device.

73. The toner passage control device of claim 72, wherein the spacer means is formed by applying, and then curing, a thick film paste on the toner passage control means.

74. The toner passage control device of claim 73, wherein the thick film paste is cured at a temperature of 220° C. or less.

75. The toner passage control device of claim 73, wherein the thick film paste is conductive.

76. The toner passage control device of claim 73, wherein the thick film paste is applied on the toner passage control means through a screen printing process.

77. The toner passage control device of claim 76, wherein a surface of the spacer means is leveled during and after the screen printing process.

78. The toner passage control device of claim 72 or 73, wherein a surface of the spacer means is coated with a metal film.

79. The toner passage control device of any one of claims 72 to 78, wherein a surface roughness Rz of a portion of the spacer means that abuts on the toner layer on the toner holder is set to be 2 μm to 4 μm.

80. The toner passage control device of claim 72 or 73, wherein the toner passage control means is covered with an insulative film of silicon oxide or silicon nitride having a thickness of 3 μm or less that is deposited through chemical vapor deposition.

81. A method for manufacturing a toner passage control device arranged so as to oppose a toner carrying position of a toner holder for holding a charged toner and moving while forming a toner layer,
wherein the toner passage control device includes, on an insulative member, a toner passage hole row including a plurality of toner passage holes for passing the toner therethrough arranged in a row in a direction perpendicular to a toner holder moving direction, and a control electrode provided along at least a portion of a periphery of each of the toner passage holes, wherein a voltage according to an image signal is applied to the control electrode so as to control passage of the toner through the toner passage holes,
the method comprising the step of forming, integrally on the toner passage control means, spacer means which is in contact with the toner layer held on the toner holder for limiting a distance between the toner layer and an opening of the toner passage hole.

82. The method for manufacturing a toner passage control device of claim 81, wherein the step of forming the spacer means includes a step of applying a thick film paste on the toner passage control means, and a step of curing the thick film paste.

83. The method for manufacturing a toner passage control device of claim 82, wherein the thick film paste is cured at a temperature of 220° C. or less.

84. The method for manufacturing a toner passage control device of claim 82, wherein the thick film paste is applied on the toner passage control means through a screen printing process.

85. The method for manufacturing a toner passage control device of claim 84, wherein a surface of the spacer means is leveled during and after the screen printing process.

86. In an image forming device including a toner holder for holding a supplied toner and moving while forming a toner layer, and a back electrode arranged so as to oppose the toner holder for forming a transfer electric field for sucking the toner on the toner holder,
a toner passage control device, comprising a plurality of toner passage holes for passing the toner therethrough arranged in a row in a direction that crosses a direction in which the toner holder moves, and a control electrode provided along a periphery of an opening of each of the toner passage holes for controlling passage of the toner through a corresponding one of the toner passage holes, wherein the toner passage control device is arranged between the toner holder and the back electrode so as to control flight of the toner on the toner holder toward the back electrode,
wherein a spacer portion is provided on an upstream side and a downstream side in the toner holder moving direction with respect to the toner passage hole row, the spacer portion contacting the toner layer on the toner holder for forming and ensuring a constant gap between the toner layer and a toner entering side of each toner passage hole.

87. The toner passage control device of claim 86, wherein a ridge portion, on a toner passage hole row side, of the spacer portion that is on the downstream side in the toner holder moving direction is formed to have an inclined cross section or a curved cross section that gradually approaches the toner layer on the toner holder in a direction toward the downstream side in the toner holder moving direction.

88. The toner passage control device of claim 86 or 87, wherein:
the control electrode is arranged on a toner holder side surface; and
the spacer portion is formed by applying a thick film paste on a toner passage control device main body and curing the applied thick film paste.

89. The toner passage control device of claim 88, wherein the thick film paste is applied through a screen printing process.

90. The toner passage control device of any one of claims 86 to 89, wherein the spacer portion on an upstream side in the toner holder moving direction and the spacer portion on a downstream side are provided so as to be continuous with each other on an outer side of each end, in a row direction, of the toner passage hole row.

91. The toner passage control device of any one of claims 86 to 90, wherein the spacer portion on an upstream side in the toner holder moving direction and the spacer portion on a downstream side have thicknesses different from each other.

92. A toner passage control device, comprising a toner holder for holding a supplied toner and moving while forming a toner layer, and a back electrode arranged so as to oppose the toner holder for forming a transfer electric field for sucking the toner on the toner holder,
the toner passage control device further comprising a plurality of toner passage holes for passing the toner therethrough arranged in a row in a direction that is substantially perpendicular to a direction in which the toner holder moves, and a control electrode provided along a periphery of an opening of each of the toner passage holes for controlling passage of the toner through a corresponding one of the toner passage holes, wherein the toner passage control device is arranged between the toner holder and the back electrode so as to control flight of the toner on the toner holder toward the back electrode, wherein:
a depressed portion is provided on a toner holder side surface; and
the toner passage holes are arranged in the depressed portion.

93. The toner passage control device of claim 92, wherein the depressed portion is formed by heat-pressing the toner holder side surface.

94. The toner passage control device of claim 93, wherein:
the toner passage control device comprises an insulative base member;
the control electrode is arranged on a toner holder side surface of the insulative base member;
the toner passage control device comprises an adhesive layer which is provided on the same surface of the insulative base member as the control electrode and which can be deformed by being heat-pressed while the depressed portion is formed with heat; and
the toner passage control device comprises a cover layer provided on the control electrode and the adhesive layer.

95. The toner passage control device of claim 94, wherein a surface of the cover layer is formed to be flush.

96. The toner passage control device of claim 94 or 95, wherein a thickness of the adhesive layer is greater than a thickness of the control electrode.

97. The toner passage control device of any one of claims 92 to 96, wherein a ridge portion of the depressed portion that is on a downstream side in the toner holder moving direction is formed to have an inclined cross section or a curved cross section that gradually approaches the toner layer on the toner holder in a direction toward the downstream side in the toner holder moving direction.

98. The toner passage control device of any one of claims 92 to 97, wherein a wall surface of the depressed portion that is on a downstream side in the toner holder moving direction is formed to have an inclined cross section that gradually approaches the toner layer on the toner holder in a direction toward the downstream side in the toner holder moving direction.

99. A method for manufacturing the toner passage control device of claim 86, comprising the step of forming the spacer portion integrally with a toner passage control device main body.

100. A method for manufacturing the toner passage control device of claim 86, wherein a spacer portion forming step includes an application step of applying a thick film paste on a toner passage control device main body, and a curing step of curing the thick film paste applied in the application step.

101. The method for manufacturing a toner passage control device of claim 100, wherein the thick film paste is applied through a screen printing process in the application step.

102. A method for manufacturing the toner passage control device of claim 92, comprising the step of forming the depressed portion in a toner passage control device main body.

103. The method for manufacturing a toner passage control device of claim 102, wherein the depressed portion is formed by heat-pressing the toner passage control device main body.

104. The method for manufacturing a toner passage control device of claim 103, wherein when heat-pressing the toner passage control device main body, not only an area of the toner passage control device main body in which the depressed portion is to be formed is heat-pressed, but also a surrounding area is heat-pressed simultaneously.

105. An image forming device, comprising the toner passage control device of any one of claims 86 to 98.
